(19) United States
(12) Patent Application Publication
(10) Pub. No.: US 2010/0088262 A1
(43) Pub. Date: Apr. 8, 2010

(54) EMULATED BRAIN

(75) Inventors: THOMAS A. VISEL, AUSTIN, TX (US); JONATHAN VORCE, AUSTIN, TX (US)

Correspondence Address: HOWISON & ARNOTT, L.L.P, P.O. BOX 741715, DALLAS, TX, 75374-1715, US

(73) Assignee: NEURIC TECHNOLOGIES, LLC, HOUSTON, TX (US)

(21) Appl. No.: 12/569,695

(22) Filed: Sep. 29, 2009

Related U.S. Application Data
(60) Provisional application No. 61/100,940, filed on Sep. 29, 2008.

(51) Int. Cl. G06N 3/08

(52) U.S. Cl. 706/18

(57) ABSTRACT

An emulated intelligence system includes an input for receiving information in the form of a query and a parsing system for parsing the query into grammatical elements. A database of individual concepts is included, each concept defining relationships between the concept and other concepts in the database. A conceptualizing system defines a list of related concepts associated with each of the parsed elements of the query and the embodied relationships associated therewith and a volition system then determines if additional concepts are associated with an action that may be associated with pre-stored criteria. An action system is then provided for defining an action to be taken based upon the relationships defined by the conceptualizing system.

### CROSS-REFERENCE TO RELATED APPLICATIONS

This application claims priority to U.S. Provisional Application Ser. No. 61/100,940, filed on Sep. 29, 2008 and entitled, “TECHNOLOGY DETAIL OF THE NEURIC BRAIN,” the specification of which is incorporated herein by reference. This application is related to U.S. patent application Ser. No. 12/344,312, filed on Dec. 26, 2008 and entitled, “DISCUSSION PATENT,” which claims benefit of U.S. Provisional Patent Application Ser. No. 61/016,918, also entitled DISCUSSION PATENT, filed Dec. 27, 2007, and U.S. Provisional Patent Application No. 61/140,005, entitled PROCESS OF DIALOGUE AND DISCUSSION, filed Dec. 22, 2008. This application is also related to U.S. patent application Ser. No. 12/136,670, entitled METHOD AND APPARATUS FOR DEFINING AN ARTIFICIAL BRAIN VIA A PLURALITY OF CONCEPT NODES CONNECTED TOGETHER THROUGH PREDETERMINED RELATIONSHIPS, filed on Jun. 10, 2008. All of the above are incorporated herein by reference in their entireties.

### TECHNICAL FIELD

The present invention pertains, in general, to systems for emulating function of the human brain.

### SUMMARY

The present invention disclosed and claimed herein, in on aspect thereof, comprises an emulated intelligence system, which includes an input for receiving information in the form of a query and a parsing system for parsing the query into grammatical elements. A database of individual concepts is included, each concept defining relationships between the concept and other concepts in the database. A conceptualizing system defines a list of related concepts associated with each of the parsed elements of the query and the embodied relationships associated therewith and a volition system then determines if additional concepts are associated with an action that may be associated with pre-stored criteria. An action system is then provided for defining an action to be taken based upon the relationships defined by the conceptualizing system.

### BRIEF DESCRIPTION OF THE DRAWINGS

For a more complete understanding, reference is now made to the following description taken in conjunction with the accompanying Drawings in which:

FIG. 1 illustrates aspects of the emulated brain;

FIG. 1A illustrates the emulated brain;

FIG. 2 illustrates internal neuron timing;

FIG. 3 illustrates a general organization of the emulated brain;

FIG. 4 illustrates the process wherein on receiving an incoming sentence, the Volition subsystem immediately tokenizes the words, converting them into neuron IDs (Nids);

FIG. 5 shows the general placement of knowledge and volition in information flow;

FIG. 6 illustrates the general neuron layout;

FIG. 7 depicts an example of neurons interconnected into a network with relns;

FIG. 8 illustrates the organization of memory areas;

FIG. 9 illustrates sample clump neuron contents;

FIG. 10 illustrates the relationships of normal and identity neurons;

FIG. 11 illustrates the interconnect of complex neurons;

FIG. 12 illustrates the neuref external appearance;

FIG. 13 illustrates the neuref internal integrators;

FIG. 14 illustrates internal neuron timing;

FIG. 15 illustrates an example gamut of feelings for mental clarity;

FIG. 16 illustrates the metrics used to define behavioral patterns;

FIG. 17 illustrates a partial list of derived traits;

FIG. 18 depicts the initiation of a need;

FIG. 19 shows the general decision process flow;

FIG. 20 demonstrates an example of a possible event hierarchy;

FIG. 21 illustrates the parsing system flow;

FIG. 22 depicts the parser flow, i.e., showing the process from tokenized text to the creation of ‘clump’ neurons;

FIG. 23 illustrates the push areas of increasing intersection to top of the union list after sorting;

FIG. 24 illustrates the structure of the requirements pool structure;

FIG. 25 depicts clump structure;

FIG. 26 shows the proportions of each primary color added together to produce the actual tint as specified by the hue property color chart;

FIG. 27 depicts the saturation property color chart;

FIG. 28 depicts the intensity property color chart;

FIG. 29 illustrates a generalized volition-and-discussion thread;

FIG. 30 illustrates a system block diagram;

FIG. 31 depicts flow of parse and contextualization;

FIG. 32 shows the detailed flow of the internal process of monologue;

FIG. 33 illustrates an example outline paragraph;

FIG. 34 depicts an example neural network;

FIG. 35 illustrates Step 1 of the introduction dialogue;

FIG. 36 illustrates the expectations blocks and pool;

FIG. 37 depicts the greet-back response;

FIG. 38 illustrates the prompt to initiate dialogue;

FIG. 39 shows formulating positions in a dialogue;

FIG. 40 depicts the general flow of discussion states, wherein person A is talking to person B, which is referred to as the generalized discussion state pattern;

FIG. 41 illustrates dialogue types and methods;

FIG. 42 depicts showing interest in conversation;

FIG. 43 illustrates the internet neuron space; and

FIG. 44 illustrates various search system differentiators.

### DETAILED DESCRIPTION

Referring now to the drawings, wherein like reference numbers are used herein to designate like elements throughout, the various views and embodiments of the technology detail of the emulated brain are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

### Introduction and Differentiators

The human being is a complex entity. The many aspects of the mind are a formidable challenge to emulate, particularly when one considers the more arcane aspects of it such as culture. This document defines the basic means by which Neuric Technologies, LLC has defined and created an emulation for the human mind.

One cannot hope to have human-like response in a machine if he is not also emulating elements such as emotion, need, personality and temperament. These are key drivers for the outcome of any human-to-human interaction, or for machine-to-human interaction.

In his “Follow the Child” program at IBM, Dr. Samuel Adams correctly identifies emulation of emotions as essential to emulating the human.

### The Emulated Brain Model (“EBM”)

The EBM of the human brain has been implemented in software as a “DLL”. It interacts in text with humans and expresses itself in English. Of necessity, it therefore has a front-end language parser, a “neuron”-based internal memory and systems of volition, emotion and personality. It is capable of being extended to evaluate the personality of the individual, though at present such information is pre-established for the brain.

The present embodiment in software was done with the view towards embedded systems. The brain has the potential to operate on an embedded processor such as an ARM inside an ASIC or FPGA, with suitable parts of internal operations handled in directly in hardware.

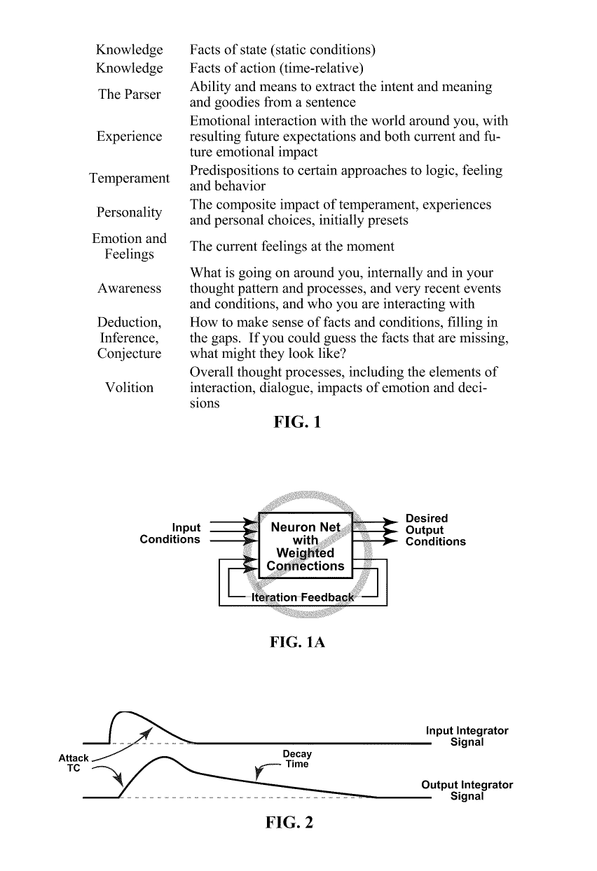

The EBM provides for the aspects as illustrated in FIG. 1. This looks rather daunting. It was. How do you that . . . . Are there tricks? There are tricks. One of them is that a single integrated architecture must handle all the above aspects, and more, in a cohesive system. The remainder of this document attempts to demonstrate how. It is drawn from the partial content of about 30 separate manuals that document the various subsystems.

### The Differentiators

Some questions to be answered here include:
How is the EBM different from Natural Language Parsers and other semantic systems?
How is logic different from thought?
How can emotions possibly be represented in a meaningful way?
Why are emotions important, anyway?
What is (your) meaning of a “neuron”? Of a “brain”?
What makes this system different from the AI of the past 40 years?
Is it different?
Is it bio-mimetic? Does it mimic biological systems?
Is it a physiological model or a psychological/behavioral model?
How is the EBM different from other “Post-AI” systems?

To avoid confusion and to dispel assumptions, the ‘40-year’ question should be addressed.

It must be stated up front that this is a substantive departure from traditional paradigms and thinking in the areas of Artificial Intelligence (AI) and computational psychology. This brain uses a non-classical form of neural network, has feelings and emotion, and a configured temperament and personality.

Each of these areas would be a substantial work in itself, using classical paradigms and techniques. The underlying organization and method of integrating these areas is what makes such a system possible. A key to this is the notion of the neuron used here and how it differs markedly from the classical view.

### Old School Paradigms

A common traditional view of neurons derives from a biological model and attempts to mimic biological neurons—is bio-mimetic. The human body behaves so well, it is a good idea to look to it for indicators of how to organize similar-behaving systems.

Classical “neurons” derive from biologically-suggested structures. They are often organized into the system shown in FIG. 1A, a box with input conditions, desired output conditions and a set of feedback paths.

A common goal of classical systems is to generate a set of desired results when presented with a set of input conditions. Inside the box is typically a set of “neurons” arranged into several layers or sets, often an input layer, a “hidden” layer and an output layer. Each neuron in the system is typically a summing junction with isolation, and the feedback system works to create weighted connections between neurons of the various layers. As many neurons as required to solve the problem are used. The neurons may be implemented through analog or digital means.

Questions to ask:
If not, then what? One concept—One neuron
If no feedback, how does it learn? Rather like you do, by being told information, inquiry, and by finding out what doesn't work.

### One Neuron—One Concept

The disclosed Emulated Brain Model (EBM) uses the paradigm of one neuron-one concept. That is, knowledge in the brain is represented by neurons, one for each possible concept. In the EBM, a “neuron” is simply a place-holder that represents a concept. It takes its meaning from the other neurons it is connected to. Except for the handling of emotions the handling of expectations in experiences, the idea of “firing” a neuron is rarely used in the EBM.

The EBM supports the following aspects of the human brain:
Emotions—Approximately 400 live emotions or feelings predicated on 30 basic emotions Personality (behavior)—Configured by 37 behavioral indicators
Temperament (predispositions)—Gains, weightings and decision threshold points based on the classical 4-temperament definitions, but derived from those indicators
Parser (an English language front-end)
Knowledge “ontology” —A system of storing knowledge rather than just words
Learning based on explanation, deduction and inference
Volition system—A generalized event-driven system using situational awareness, expectation, emotions and knowledge for decisions and interaction with people

The system of neurons embodied by the EBM effectively permit situational-dependent weighting of inter-neuron relational connections. The arrangement of neuron types (6, give-or-take), neuron valuation and aging to determine whether to retain or kill a given neuron, and multiple forms of memory bring great capability with them.

Difference from Parser Systems

How is the EBM different from Natural Language Parsers and other semantic systems? A “parser” is a system that performs evaluations on the text of sentences and extracts intention and relevant information from that sentence. An example of one is found in Microsoft Word®, where it is used to check your grammar and sentence structure. That example teams up with a spell-checker to proof you work.

The parser portion of the brain is not essentially different from other systems. The EBM uses a parser but is not a parser. It takes information extracted by the parser to establish meaning, context, intent and possibly future direction of action. Also subsequent to parsing, the brain integrates the impact of emotion, temperament, inference and other aspects of volition to think and carry out tasks, learning, and other processes.

Computer Logic Differs from Thought

Computer logic is programmed by a human. It is a predictable sequence of steps and decisions. The Logic does not occur without a first intervention by a human to define and create it.

By contrast, thought freely roams, is unconstrained and relatively unpredictable. The EBM operates in an essentially un-programmed manner. It follows heuristics based on temperament and other aspects, but primarily derives its direction from training, needs and the outcomes of personal interaction with it.

As human people, how does the EBM handle such things as small talk, chit-chat with others? It selects our own set of interests and knows the general types of interests others have. We select an area (hopefully with reasonable guidance!) as a topic and ask someone else what they think or feel about it. As they are speaking, it picks up on topical items they expressed interest in. As their conversation ebbs, it takes one of those topics and either discusses it or asks them questions about it.

The EBM has the same capabilities. Just as humans, it has lists of topics in its back pocket for such purposes, the EBM also has them, as a part of the startup training process.

### Can Emotions Possibly be Represented in a Meaningful Way?

Emotions are very useful in the EBM, and in many aspects make decision processes easier. It implements them as an ordinary neuron, not substantively different than others. As with all neurons, emotions derive their conceptual use more from what they represent, their conceptual meaning from what other neurons they are connected to.

Emotion neurons rely on two elements to make them work:
They can be “fired,” expressed as a range of 0.100%, indicating the degree of emotion. (See the following section on bio-mimetics for “firing”.)
The specific emotions are heavily referenced by portions of the volition and experience internal logic as a part of decision-making processes.

That is, many subsystems in the EBM fire/incite the emotions, and many use the current levels of emotion with thresholds or range limits for their process. This permits ready expression of degrees of nuance. For example, if confidence is below norms, a response to some issue or imperative sentence may be prefaced with, “I might not be able to do that,” or if confidence is high, with “Certainly!” or “Sure . . . ”.

Expressions of presently-engaged emotion shows up in a variety of ways:
Use of “modal” words for possibility, obligation, permission and the like
Use of passive voice for sentence reconstruction (rather than active voice)
Use of prefixes or qualifiers on sentences
Use of apologies or deferential terms, statements or phrases
Choices of words or phrases used as adjectives, or intensifiers such as very
Decision paths taken during volition
Willingness or lack of willingness to engage with others, or level of engagement
Level of curiosity and desire to explore a matter further

These are a sampling of indicators of emotion. Many other similar methods are used throughout the brain, particularly for the fonx, Monologue, Dialogue and Volition subsystems.

So, the answer is a clear yes to the question of whether or not can be represented in meaningful ways. Emotions are not only important, but are crucial to human-like expression. This is on of a number of fundamental differences between the EBM and parser-only or parser-plus-logic systems.

Is the EBM Bio-Mimetic? does it Mimic Biological Systems?

Referring now to FIG. 2, the EBM is a functional model, not a physical model. It attempts to faithfully replicate the psychological model of the human brain, though. Mimicking biological designs is very useful and suggestive of approaches to take on various subsystems, but going too far in mimicking can lead the process astray from its goals. Two areas in the EBM enhanced by general knowledge of biological functions are:
Emotions expressed through the endocrine system
Neuron firing

When down-selecting “core” emotions (about 30) from a field of about 400 feelings/emotions, the endocrine system suggests a relatively small number of hormones that initiate or carry out the expression of emotion. As discussed elsewhere, all 400 feelings are used, but as degrees of expression of the core emotions.

Also suggested by biology is the firing of neurons, although this process only used for a tiny percentage of neurons. Any neuron in the system can be fired, or turned on by some incremental amount. This is done internally with a two-stage integrator that is described in more detail in the chapter on Firing of Neurons. Each emotion has separate rates at which they turn on and of.

Typical rise and fall times are 0.15 and 20 seconds, respectively, but any neuron can have its timings custom-configured. Depending on what is happening to drive the emotions, they may be re-fired multiple times before they have yet decayed.

In this manner, a given neuron may be fired many times but never exceeds 100% (saturated) firing. Because of the two-tier integrators, output simply remains saturated longer when multiple inputs would have taken it beyond 100% firing.

How the EBM Differs from Other “Post-AI” Systems

Dr. Ray Kurzweil has a series of books and talks on AI in which he points to a “singularity” to come in the development of AI. He is the Admiral Eddie Rickenbacker of AI. He loosely prophecies that by 2025 we will have “real AI”.

The magic potion for Ray's prediction is based on the development of faster processors and an extrapolation similar to Moore's Law. We believe his underlying premise to be flawed: That AI is and must necessarily be a power-hungry monster satisfied only with faster silicon (or gallium arsenide).

One can conjecture that his premise derives from the fact that Lisp has been an early and useful means of modeling aspects of the brain. It certainly makes the development of an ontology (storage base for knowledge) possible. It is unwieldy in large systems and numbingly slow. Make the support for Lisp faster and you have the potential for a brain. We consider that irrelevant.

Considering speakers and topics at the subsequent “Singularity Conferences on AI,” there is a strong trend: AI of the last 40 years has been application-specific if successful. AI has a bad name and does not deliver. What is needed is an Artificial General Intelligence (AGI).

So, who is out there and doing what? Typical of the systems are:
iRobot—Physical robotics for both commercial and military use, with app-specific traditional AI
IBM—Dr. Samuel Adams (“Follow the Child”) emotion-based program using Lisp Powerset—Dr. Barney Pell—A parser-only system well connected to the Web for search purposes.
Cognition—A parser-only system targeted to intranet search.
Google—Peter Norvig—Statistical word-based search methods
21CSI—An “edge-based” AI system, typically characterized by the need for large databases
Novamente, et al.—Dr. Ben Goertzel—“Edge-based” AI systems, often around medical apps.

Of these types of systems, the “edge-based” systems are regarded as those closest to what the EBM is using, but without emotion and personality, and unknown possibilities for true volition and thought.

Unlike all other (known) systems out there except for the efforts like Dr. Samuel Adams at IBM, no one seems to have an integrated package that includes a parser on the front-end, emotion, feelings and personality and volition that is driven by it. Certainly, emotion-based systems have the potential to look like AGI, if they don't actually achieve it.

### Subsystems of the EBM

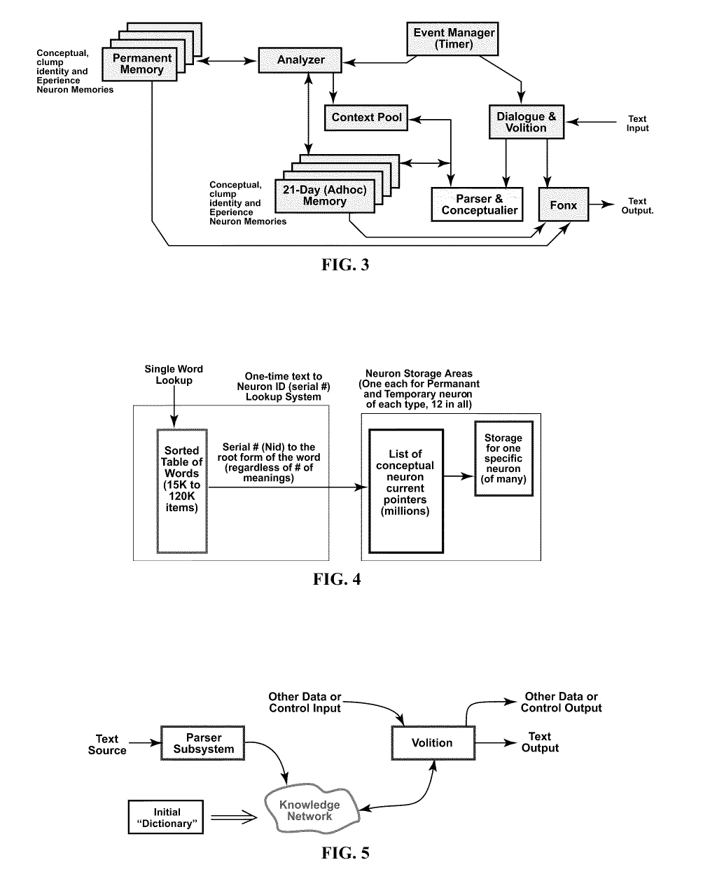

A general organization of the EBM is given in FIG. 3. While it in no way does justice to the system as a whole, it illustrates the general placement of some key elements.

A brief overview of the elements of this is in the sections to follow.

### Memory (Use of “Neurons”)

The unit repository of knowledge is the “neuron”. The Introduction pointed out that the EBM uses one-neuron-one-concept. That means that every neuron in the system is a place-holder for a single concept.

Learning in this system does not come by a feedback system that changes the connection strength between neurons and grows arbitrary paths between neurons. Rather, this system learns by adding un-weighted relational connections between neurons.

The neuron is built from a contiguous block of digital memory and composed of a short header block and an extendable list of connections to other neurons. Each such connection item is called a “relational connection” or “reln” and each such reln has a connection type encoded in it.

Internally, each type has a suite of supporting operations, often similar between the types. Some specialized operations return basic element such as the topic of a clump or of a complex conceptual neuron.

### From Words to Neurons

Insomuch as is possible, one wants to remove themselves as soon as possible from the textual domain and work entirely in the domain of neurons and their serial numbers. On receiving an incoming sentence, the Volition subsystem immediately tokenizes the words, converting them into neuron IDs (Nids). This is shown in FIG. 4, and is the only similarity to a database in the EBM.

A sorted table (the internal organization is not relevant except for speed) holds the language words, with a single entry and output serving as the starting point for all future operations on that word, whether it has multiple meanings or not. If the word can be uses as a noun, verb, adjective or adverb (in different contexts), it still has only one root form kept in that table.

The outcome of the table is a neuron ID—a serial number—whose value never changes regardless of how a neuron may grow. A subsequent operation of various subsystems will determine if this ID has multiple meanings, and isolate the proper one. While the multiple meanings share a single entry in the text table, each has its own entry in the list of neuron pointers, one per meaning (concept). Each such concept therefore has its own unique ID.

### Natural Language Parser

A natural language parser dissects incoming text, extracting goodies from each sentence. The intention of the parser is not to permit us to memorize a sentence, but to permit us to move into a conceptual realm. Without a brain behind it, parsers cannot fully achieve this; they can only analyze parts of speech and grammar, extracting data.

In the big picture, the EBM Natural Language Parser is technically not different from any other good parser such as Powerset's or Cognition's. It performs some form of semantic and grammar analysis on the sentence and retrieves sentence elements in some orderly manner. Obviously, it has very implementation-specific mechanisms it uses and depends upon for operation, but the parser is still the human-interface front end of some larger effort.

Input to the parser is a set of “tokens” previously extracted from a sentence. These are Nids for either words or punctuation elements and provided to it as a tree-like list.

Output from the parser is another tree-like list that represents the most-likely parse option path for this sentence. The conceptualizes subsequently converts the list into one or more clump neurons and zero or more complex conceptual neurons.

A dedicated thread of execution then handles the parse phase from beginning to end:

Pass a sentence to the tokenizes system to convert text into Nid and punctuation tokens.

Parse the token tree into a conceptual output tree.

“Conceptualize” the parser output tree into the needed clumps and neurons, first resolving any open items such as pronouns.

At this point, the Volition system may further act on it (e.g., purposes of inference, deduction or the handling of imperatives or questions raised by the sentence.) Otherwise, the accumulation of knowledge from that sentence is fully complete.

The results of a parse sometimes may last for 20 days or so if they are not re-validated or otherwise affirmed as topical and important. A sleep process ages all such temporary/adhoc neurons to determine if the neurons should die. Those that pass this step are moved from adhoc space over to permanent clump and neuron space.

### Volition, Awareness and Expectations

“Volition” refers to a generally autonomous thought process. It involves decision process, the ability to carry out acts, deduction, inference and related activity. In the EBM, volition is a consumer of emotional content and is also one of the instigators of emotional activity.

The organization of volition is such that it orchestrates:
The fielding of questions
Monologue
Dialogue
Inference
Processes
Awareness and Expectations

Each of these is discussed in subsequent sections and chapters.

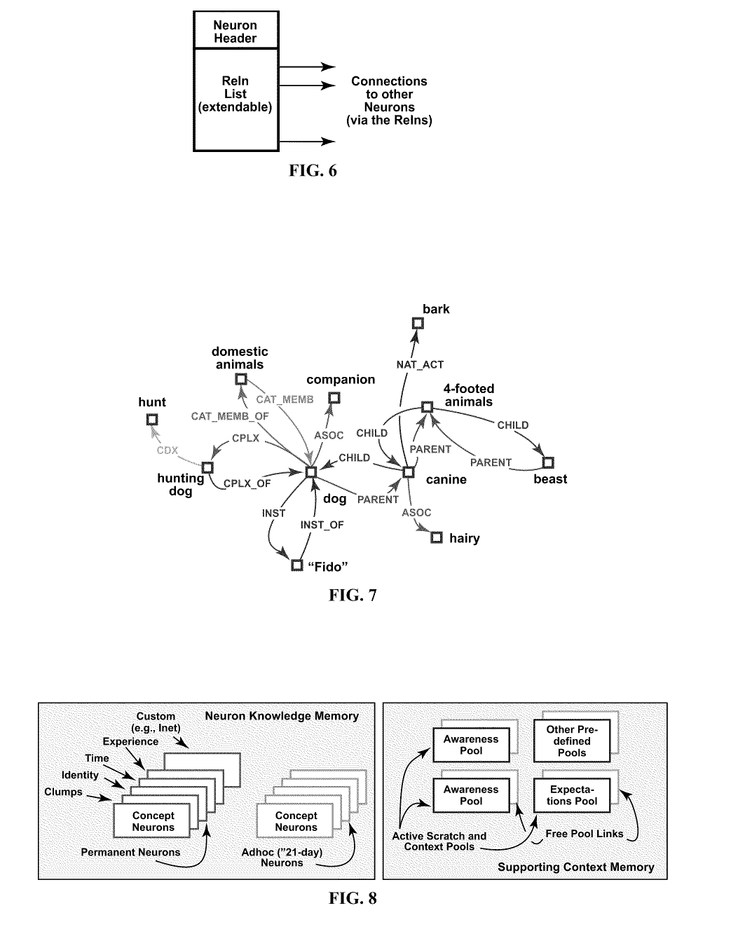

FIG. 5 shows the general placement of knowledge and volition in information flow.

### Inference

“Inference” is a generalize area that includes various forms of deduction and inference. It is applied in a number of places, but specifically following the parsing of a sentence and during the answering of questions (particularly how and why questions).

Deduction acts on known facts, where all the information is present but perhaps not in a convenient form. Inference takes existing facts and attempts to draw a conclusion from them. It may be considered a form of conjecture that says, “I don't have all the facts. But if I did, what would they look like?”

Inference is also necessary for the isolation of intent. If someone says or acts in a certain manner, there is no way to know for certain why he did that, sort of directly asking a question. In the meantime, there is nothing that can be done but to infer information based on what is known.

Inference is a repetitive process controlled by personality and current emotional conditions. It considers many aspects:
Cause-and-Effect—“If you do this then that will happen.”
Emotional Aspects—Encouragement, insult, affirmation and many other emotions or mental states are affected by the outcome of inference, so they are part of the inference process.
Pattern Matching—Clump neurons have a very regular aspect to them that can be matched against other references to the same subject/topic to find likely outcomes.
Role Matching—Certain concept-role pairs across multiple clump neurons exist that imply an outcome that is usually defined in one of the clumps.
Emotional Connotations—Some 3000 words in English have emotional connotations of themselves. When applied to the listener, they can evoke specific emotions or (separately) mental states.

Both heuristic-based and genetic algorithm based methods are used in inference. The outcome of inference is one or more clumps, or new relational connections between existing neurons.

### Fonx—English Sentence Generator

The “Fonx” subsystem is a centralized method for converting clump-base information into sentences. It is capable of expressing the same basic information in one of 7 different sentence styles. These include several forms of active voice, passive voice, confirmation, questions and other styles. There are six basic formats for questions alone.

Fonx is a relatively low-level operation called upon by many other subsystems to regenerate text from concepts. It is emotion-capable and alters word usage based upon emotional nuance. The handling of some forms such as “modal” words of obligation, permission, desire and such is done in “right-time,” such that the most suitable form of expression is used. The same holds true with the use of intensifiers such as “very” or “almost”.

### Monologue

“Monologue” is a sub-system that expounds on a specific concept. It is capable of writing a text on a subject, to the extent that it has enough training and background material to work with.

The overall method used writes an outline on the topic and then expands on the outline. It can perform the outlining on the areas of expansion, too. It follows the general rules of monologue:
Say what you're going to say. (the introduction/outline)
Say it. (the body)
Tell them what you've said. (summary)

The basic tool for directing the above is an analysis of the types of relational connections made between neurons. Certain types of connections are most applicable for each portion of the monologue, making the above sequence readily handled.

### Dialogue

Dialogue is a two-way interaction between people. Dialogue is an aspect of Volition but is not an isolated subsystem of it. It is largely implemented through process neurons, a usage of conceptual neurons.

Overall, the requirements for the “informal logic” of formal refereed debate are provided for. These include such elements of topic of dialogue, the acceptance of premises or assertions, styles of interchange and rules for interchange.

Another aspect of dialogue is the general art of small talk. In the same way that a given person has a bag of tricks he/she uses to move small talk interaction with another person forward, this brain model uses similar techniques. The choices used during interaction are highly dependent upon emotions, personal options for engagement and the personal interests of both parties.

A framework has been implemented to carry out small talk and suitable methods established in the process neurons. The use and extension of both of these aspects of dialogue are ongoing propositions, similar to learning techniques with age.

### Emotion

Emotion is not a subsystem, per se, but a capability. It uses the neuron-firing subsystems to allow it to perform, but it is rather a process integrated into other areas such as Volition and Fonx. Its ultimate output is a level of firing that defines the degree of expression of a particular emotion.

Emotion is supported by specialized tables, lists and cross-connection with other neurons. Noted in the Introduction, emotions fire and fade over time, making them a background process. At many decision points in the brain model, specific emotions are consulted to determine the best course of action. They can be polled via the parser system as an aspect of self-awareness. E.g., “How are you feeling now?”

Emotions have significant but subtle impacts on the interchanges between brain and listener. The nuances of words chosen reflect these, to give a warm sense of interaction.

### Personality (Self, Other)

Like emotion, personality is not a subsystem, but a capability. The Gough/Heilbrun personality test (The ACL) are used to define personality. The ACL results are defined as a set of 37 parameters whose values range from 0-100%, and which define behavior. These cover specific areas such as assertiveness, deference, leadership, adapted-ness and others. The composite is a reasonable definition of behavior and consist of five individual sets of parameters, including the Transactional Analysis results such as Adapted Child.

For every individual known to the agent, an Identity neuron holds relational data that defines personality parameters for him. They default to those typical of a secure Melancholy when unknown. During conversation, when the speaker changes (e.g., a selection in an Instant Messenger input box), the profile for that person is read from his identity neuron and placed into an identity pool record for rapid access.

This readily tracks changes in personal preferences, likes, dislikes and optimal communications style, when quickly flipping between external speaker/listener changes.

### Neurons in the EBM

Referring now to FIG. 6, words are used to communicate a concept or a thought. The predominant memory mechanism of human beings is the storage of the concept or thought, not the words by which it was conveyed. There are memory mechanisms that do store exact text, such as memorizing the Declaration of Independence, but that is not addressed here.

This matter of conceptual memory exists across all cultures, because all languages intend to convey something through their use of words. The EBM uses several mechanisms to represent concepts, going from simplest to more complex means.

In the EBM, every unique concept to be known is embodied as a single neuron. While all neurons are essentially identical, the truly important information is not what is stored within them (or their specific characteristics) but how they are interconnected with other neurons. It is these connections that define a concept for what it is.

The unit repository of knowledge is the “neuron”. The Introduction pointed out that in the EBM system, we use one-neuron-one-concept. That means that every neuron in the system is a place-holder for a single concept.

Learning in this system does not come by a feedback system that changes the connection strength between neurons and grows arbitrary paths between neurons. Rather, this system learns by adding un-weighted relational connections between neurons.

The neuron is built from a contiguous block of digital memory and composed of a short header block and an extendable list of connections to other neurons. Each such connection item is called a “relational connection” or “reln” and each such reln has a connection type encoded in it.

FIG. 7 is an example of such neurons interconnected into a network with relns. Each of the reln types is given a different color. Each type represents a fundamental type of relationship that can exist between concepts within the EBM system.

### Storage of Emotions, Temperament and Personality

Emotions, temperament and personality particulars are integrated with various subsystems, do not explicitly appear in FIG. 7. Emotions are embodied in respective neurons, just ordinary conceptual neurons. However, they have additional processes that work on them to fire and sense their implications. The volition process manages these during conversations that involve emotional content or that refer to previous experiences with emotional content or expectations.

The configuration for both temperament and personality are maintained in a separate bank of identity neurons. On initial awareness of a change of external speaker, personality profile data is extracted from the relational connections in the identity neuron associated with the speaker. As with the “self” identity configuration data for the brain itself, personality parameters are stored in list objects. The current-speaker information can then be instantly swapped in and out during the conversation as it passes between individuals.

### Types of Neurons

There are six basic types of neurons. Each has its separate permanent and adhoc memory spaces. Each type has a 32-bit quick-reference index that contains the neuron ID, the neuron type and other related data. These neuron types and their related quick-reference IDs are:
Conceptual neuron (Nid)—Static facts about a concept
Clump neuron (Cid)—Represents time-variant concept with tense and aspect such as an independent clause
Identity neuron (Idt)—Identity profile information, whether for this brain or for a person interacting with it
Time neuron (Tid)—Expression of time, duration, epoch, whether absolute, relative or conditional (“when the cows come home”)
Experience neuron (Xid)—An experience the brain has with the world around it, which may be multiply nested and has associated expectations or feelings
Internet neuron (Uid)—A repository of internet-specific information such as URLs and other node-related information.

Neurons have the property that they grow in their interconnection set (except for clump neurons), are fixed size at the moment but can be expanded as needed. All such housekeeping is entirely transparent and automatic to the rest of the system.

Internally, each type has a suite of supporting operations, often similar between the types. Some specialized operations return basic element such as the topic of a clump or of a complex conceptual neuron.

Neurons are interconnected with other neurons through Relational Connections (“Relns) attached to their outputs. These may or may not contain weighting factors. Bidirectional connections between two neurons are implemented as two separate Relns attached between them.

There are numerous types of Relns, each applied for a specific purpose. These establish the subtle variances of relationships that may occur between two concepts (neurons).

Most neuron types contain a reln sequence named the BLOCK reln by which a set of n consecutive relns can be used as a block of data for some purpose. An enumeration in the BLOCK reln defines the type and usage of the block, while other fields indicated the length of the block.

Such BLOCK sets are used for handling comparatives, word-specific flags, lists for process neurons and many other uses unique to that neuron.

### Concepts and the Neuron

A human listener is like a parser—a translator of text—trying to get at the greater meaning that words try to convey. Text comes in through various channels and it is broken down and processed. The concepts are remembered in one of four basic types of neurons.

### Simple Neurons

The EBM stores one concept per neuron, wherein the neuron is simply a place-holder for the concept. To it are attached connections to other concepts (or words) that give the neuron meaning. These simple neurons store relationships between concepts in a factual manner.

For example, the word “dog” forms a dog neuron, and that neuron is linked through a relational connection (“reln”) to a quadruped neuron that helps establish the concept of a dog. Neuron IDs for both simple and complex neurons share the same numbering space.

### Complex Neurons

There are occasionally repeated references to nouns that have a qualifying adjective, such as “black dog”. A complex neuron is created to handle such cases. The complex carries all the implications of dog and the qualification of red, but without the overhead of its own copy of all the linkages.

Similarly, when referring to a specific dog (such as that dog) that has particular traits or associations, a complex neuron is created. The complex neuron retains the implications of dog but has its own additional implications. The neuron IDs for both simple and complex neurons share the same numbering space.

### Clump Neurons

Another type of neuron gathers ‘clumps’ of information about an action that took place and garners with it all the history of that event. Such clumps are the repository for actions taken by nouns, and each such clump implies what can be viewed as the content of an independent clause, with a variant handling dependent clauses.

The EBM parses a sentence and outputs a single Conceptual Clump, which stores the parsed “thought”. Conceptual Clumps store the thought, not the words. In doing so, the EBM is capable of capturing a diverse collection of input streams, analyzing different streams as being conceptually equal, and providing a diverse range of sentence regeneration.

Clumps use the Predicate Argument Structure as conceptual building blocks that make up a larger portion of the basic sentence clumps. The PAS assigns “semantic” roles to traditional grammatical phrases and parts of speech. These roles are the most basic element of a conceptual clump.

Clumps, or thoughts, can be utilized at the individual sentence level, multiple sentence level, or they can even be used to represent larger pieces of a discussion or entire story. They immensely aid us in tracking the topic of sentences, paragraphs, papers, and larger medium such as movies or books.

The clump is generally used to hold the verb of the sentence, although it need not be. For convenience, clump neurons have their own numbering space.

### Experience Neurons

All other neurons capture knowledge, relationships and facts, but the Experience neuron captures the emotions, timing and expectations of an experience. In this way, this neuron defines the essential concept of an experience. For convenience, the neurons IDs for experiences have their own numbering space.

### The Memory System

Referring now to FIG. 8, many traditional memory systems are possible for the representation of knowledge. The one developed here was defined and implemented over other systems such as “edge” organizations because of value brought. Regardless of neuron type, cross-relationships are easy to define, manage and track, and there are no supporting databases for the neurons. (A binary-search table is used to correlate word text with its related neuron(s), however.)

Memory falls into two general structures, neural memory and supporting (context, generally) memory. Neurons are stored in digital memory. For sake of speed, no physical memory is freed after use. Rather, a pool-based system uses fixed-sized records that are quickly returned to a free list for later reuse. This offers maximum recycling of memory with lowest overhead possible.

The organization has the following properties:
Organized into neuron classes
Defines both permanent and “21-day” adhoc neurons (for most neural classes)
Supports the aging and elimination of unwanted neurons
Supports (mutually exclusive) alternative representations for some data (e.g., clump replacement by conceptual relationships for an 8:1 reduction in memory needs), where appropriate.
Tight integration of supporting context memory with neurons.

Neurons each have a permanent serial number associated with them, although the body of the neuron may change locations in physical memory. This number serves as an ID for the neuron, and is used throughout the system. Each neuron type (of the six shown below) has its own relational connection types.

For example, the time neuron class has relational connections that support concepts of date or time (e.g., about 1500 BC or 23 nsec), or alternative forms as after lunch. As for any memory class, the relational “connection” sometimes does not reference another neuron, but may contain numeric or other relevant constant information for the neuron containing it. Further, the same neuron is used to represent a given concept. E.g., the same “circa 1500 BC” neuron is reused wherever reference to that concept is later needed.

In another example, the clump neurons may contain a compact conceptual representation equivalent to the idea, She (Virginia) usually has coffee after a leisurely lunch. Such independent clauses are not recorded verbatim, though the conceptual knowledge is preserved. (Note, that phrase requires a single clump neuron. The brain may or may-not be able to reconstruct the sentence in the same manner as originally heard, in the re-quote sense of the word.)

“Pool” memory is a link-organized arrangement of short term scratch memory. Various subsystems have their own pools that grow and shrink with local needs, but otherwise share common pools of not-in-use blocks.

Pools are used extensively as a common alternative to sorting, although they can do support sorting for use when needed.

### Basic Sentence/Clause Clump

At the most basic level, a clump takes the words and phrases of a sentence and converts them to a series of semantic roles. Three types of semantic roles drive the basic sentence clump.

The primary of these three is the PAS verb (SC_VERB). It is the main verb that assigns most of the other roles stored in the clump. It is important to note that different PAS verbs will assign different roles.

Some verbs are not able to assign certain roles, and many times the roles that are assigned are restricted in various ways. These restrictions aid us in scoring a parse, and they will help in accurate sentence reconstruction. In addition to the main verb is the SC_TASPECT. It contains the tense and aspect that the PAS assigning verb used.

The last driving role at the basic sentence level is captured with one or more of the five modal roles: SC_M_INTENT, SC_M_ABILITY, SC_M_OBLIGATION, SC_M_DESIRE and SC_M_POSSIBILITY.

With these three roles (pas, taspect, modal) we can reconstruct the verb, the tense, the aspect and the modality. Something like, “wanted to be jumping” could be captured with three role relns.

The sentence, “the rabbit may quickly jump over the carrot.” breaks down into Clump:2001 as illustrated in FIG. 9:

Many other examples of clumps are given in the chapter on Example Conceptualizer Outputs.

### Process Neurons

The “process” neuron is a conceptual neuron (Nid) that is used for the implementation of a process. It has a text name just as a word neuron would have. Through markers placed in the name and the use of some special relns, it can be used for high-level interpretation of process steps.

The two types of process neurons are:
Alt neurons—Selection between a set of alternatives
Seq neurons—Sequential action steps

The alt process neuron specify indicators enclosed within { } markers to evaluate the merit or worth of the alternative. Predefined keywords, feeling and emotions names can all be evaluated in this way. For example, a way to name (by nuance) your present strongest feeling uses the following process neuron:

| | |
|---|---|
| Strongest_Feeling,alt( | |
| “{admiration}admiration”, | “{amusement}amused”, “{anger}angry”, |
| “{anxiety}anxious”, | “{astonishment}astonished”, |
| “{caring}caring, nurturing”, | “{comfort}comforted”, |
| “{compassion}compassionate”, | “{confidence}confident”, |
| “{confusion}confused”, | “{curiosity}curious”, |
| “{disgust}disgusted”, | “{eagerness}eager”, |
| “{embarrassment}embarrassed”, | “{envy}envious”, |
| “{excitement}excited”, | “{fear}afraid”, |
| “{frustration}frustrated”, | “{gratitude}grateful”, |
| “{hatred}hateful”, | “{hope}hopeful”, |
| “{indignation}indignant”, | “{joy}full of joy”, |
| “{loneliness}lonely”, | “{pride}proud”, |
| “{reverence}reverent”, | “{romance}romantic”, |
| “{sadness}sad”, | “{satisfaction}satisfied”, |
| “{else}okay”) | |

The seq neuron differs in that the name of another neuron can be included inside < > markers. The name inside such markers is treated as an execution of that neuron, which may be another seq or alt neuron. For sequence neurons, all steps in the sequence are carried out in turn. For the alternative neuron, only the step of highest worth is executed.

Volition carries out all the indicated seq steps one after the other unless that is precluded by tests or wait conditions specified in a referenced alt neuron preclude it. The seq neuron one of the means by which Volition can track Dialogue steps in the presence of multiple conversation partners, agendas and the like. Each such simultaneous type of activity has a separate proc-neuron pool that sequences, tracks and controls the steps and any required evaluations.

The process neuron is a great example of the value of the BLOCK neuron; each of the referenced steps is itself a neuron and is contained as an element of the block.

### Identity Neurons

The primary interface between the concept of identity and parsing is the normal (conceptual) text-based neuron. How we use the text-based name(s) during parsing to establish a tentative identity can be handled in several ways:
The search can be via normal neurons and splitters.
The search can be done via utilities in the identity neuron class. The individual words comprising the name are normal neurons, but resolve via the utility in the iutil class.

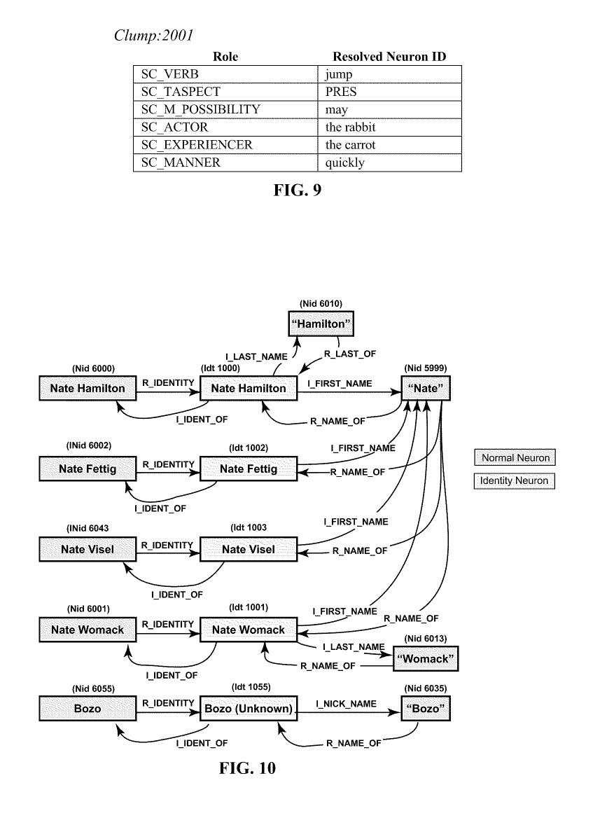

Splitters have value but actually complicate things rather than simplify them. Consider the Nate Nid 5999 given in FIG. 10. It could have multiple splitters that implement the below structure. This has several problems:
What if Nate is the only name known?
What is the mechanism by which the splits are chased to arrive at Nate Hamilton?
How do we get at Nate Hamilton when we're only given Hamilton?

A name regeneration function retrieves the name with the desired content specified by flag bits. Some valid combinations are:
Nickname
Firstname
Lastname
Firstname, Lastname
Nickname, Lastname
Firstname, Middlename, Lastname

### Temperament and Behavioral Parameters

The identity neuron includes among its reln definitions a suitable set of behavioral parameters as defined in the chapter on Personality. Suitable class utilities to retrieve them are also discussed there.

Development of Knowledge from Neurons

The EBM has equivalent capacity to an enormous system of millions of independent relational databases (RDBMs). By comparison, though, it performs relatively little searching for information. The interconnects between neurons enables it to be asked about something with seemingly no possible connection to the correct answer. Results are of the, “How did you do that?” class.

### Relationships of the Complex Neuron

A ‘complex neuron’ is formed from an adjective-noun pair, and derives from the noun's neuron. For example, FIG. 11 shows some relationships about trucks. The base nouns are depicted in blue, and the complexes in orange. Here is the essential meaning of various neuron types.
Simple noun—A class of information, the base type
Complex neuron—A category of a simple noun, but formed by an adjective-noun pair
Adjective—Simple adjective neuron or action-descriptive clump
Instance—A ‘real’ object you personally know (e.g., my dog named Thomas)
Purpose—One of 7 basic neurons defining purpose of existence.

FIG. 11 highlights the root nouns used for examples, truck and show (as in show dog, or to entertain). By way of example, we know “big trucks,” “red trucks,” and “big red trucks,” and some examples of them we happen to personally know or be aware of. Someone may ask, “Give me examples of big red trucks.”

How do we find “the big red truck” we happen to know. The three real trucks we happen to know of are the fire truck (a particular one), a particular “big red” truck, and the nearly irrelevant red truck I saw last week. Oh, there is also ‘the truck’, the one always out front. These are instances of trucks, colored below in pinkish-purple. (You may rightly suspect I cannot spell the color beginning in ‘f’.)

### Searching for Big Trucks

We search for big trucks by first seeing if big truck exists. If none exists, we simply tell the person we do not know of any. If one exists, we remember its' Neuron ID. Resume the search by looking at all instances of trucks (colored pale blue) in FIG. 11.

We look at all R_INSTANCE Relns in the truck and for each one found, we look for a reference back to that big truck neuron. None of them but one (in this case) reference that neuron. We tell the person that it is “the big red truck,” possibly setting the stage by telling other identifying features or actions of it.

### The Firing of Neurons

In some cases it is convenient to use a more bio-mimetic aspect of human brain neurons, the firing of neurons. While any neuron in the EBM can be fired, exceeding few of them use this capability, primarily relegated to emotion and experience neurons. “Firing” can be viewed as a light bulb attached to the neuron. If it is fully firing (100%), the bulb is bright. When not firing, the bulb is dark.

The purpose for firing is a simple means of measuring the collective impact of neural connections over time. For example, when the brain is insulted (and receives the insult!), the neuron representing insult is pulsed to cause it to begin firing. The firing level grows by itself to a level commensurate with the strength of the pulse, but it takes a finite time to grow—and fade—as discussed below.

Once such a neuron is fired, any connected logic or pathways having thresholds is activated or in some similar manner influenced. In this case, decisions and emotional impacts from an insult will be undertaken.

The logic described herein is not permanently connected to any neuron except for a select few such as emotions, needs and other fundamental drivers. When other neurons such as an experience neuron need to fire—and this is all transparent to the neuron and its associated logic—one of the below firing elements gets associated with that neuron. It is released from the neuron when firing stops. (This lets some of the neurons to be implemented in read-only memory.)

Internally, the above firing logic is called the “neuref”. When we discuss firing a neuron we are actually talking about firing the to-be-associated neuref.

### External Perception of a Neuref

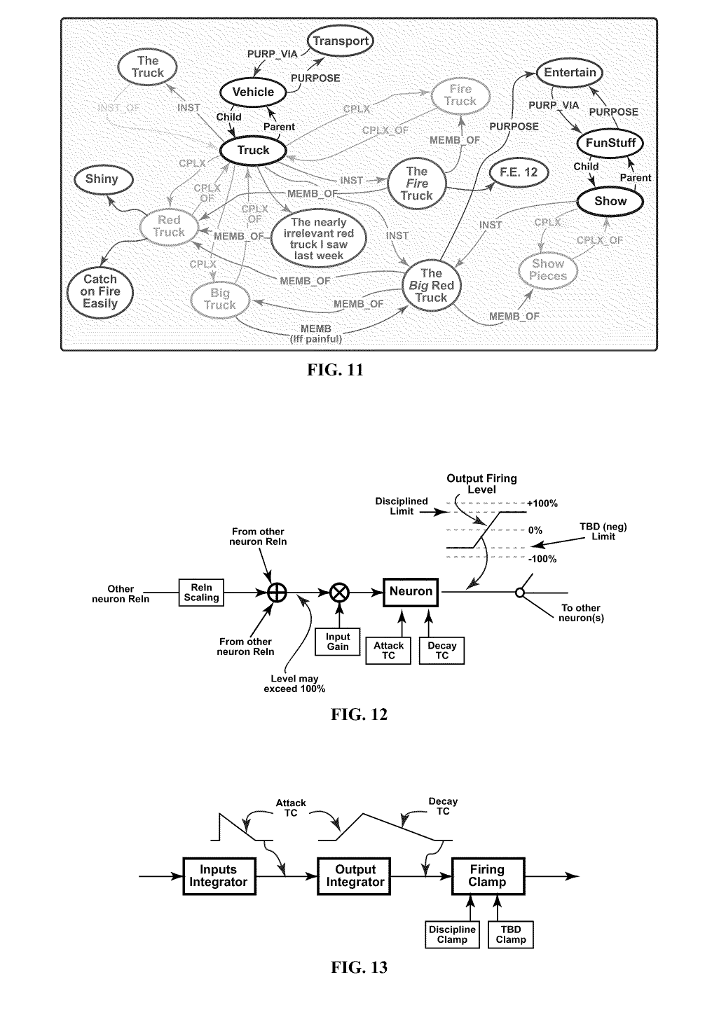

Externally to firing neurons, the neuref ‘system’ generally appears interconnected as shown in FIG. 12. One or more input connections fire the neuron, and the output of a neuron is connected so as to fire other neurons. To mimic the temporal processes of human neurology, the output is not simply the sum of the inputs, but ranges on a scale from 0-100%, regardless of the sum of signals at the input.

FIG. 12 shows a summing junction that receives an (optionally) scaled connection from another neuron. The summer's output may exceed 100%, and is then multiplied by a fractional gain to rescale the value. Finally, the input signal enters the internals of the neuron. At some later time, the neuron begins to fire and produces an output.

While most neurons are identical in this respect, some fire faster or slower than others.

### Neuref Internal Structure

There is therefore an individual attack and decay time for each neuron, as shown in FIG. 12 and in FIG. 13. Internal to each neuron are two signal integrators that yield a signal level-time product, with one integrator for the input signals and one for the output signal.

The input integrator has a signal that is the exact (but scaled) sum of the inputs from other neurons, and it raises instantaneously. This signal is applied to the output integrator that has a relatively fast attach (rise) time and a much longer decay time. Attack times normally range from 10s of milliseconds to 10s of seconds, while decay times may range from 10s of seconds to 10s of hours. In some cases such as for Expectation neurons, these time constants may extend to weeks or even months.

### Neuron Output Range

Non-emotion neurons fire in a range of 0-100%. For sake of convenience and signal flow, all emotion and expectation neurons fire in an output range of −100% to +100%. This permits easier implementation of inhibitory processes.

### Clamping and Discipline

There are many cases in which the output should be artificially clamped so as to limit its full expression. This may take place, for example, in cases where a person has strong emotional reaction to a situation but exercises discipline to restrain himself.

For this reason, both the positive excursions and negative excursions of output may be clamped to some value, and these clamp values are shown in both previous FIGS. 12 and 13. The clamp value derives from a source external to the neuron (e.g., from another neuron) and defaults to 0.100% or −100% to +100% as appropriate.

### Integration Timing

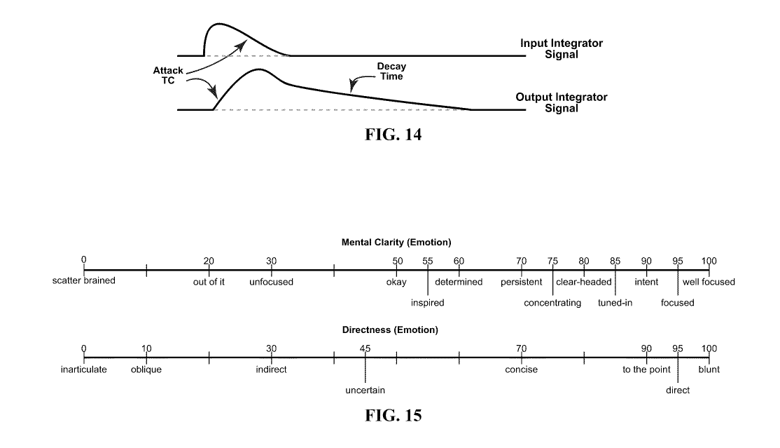

The result of the compounded integrators is illustrated in FIG. 14, giving a general idea of how the two signals overlap. The input integrator's purpose is to enable rapid and complete capture of the source signals, yet retain them intact while the output signal develops in a realistic manner.

The timing for all aspects of the neuron can be defined externally, and can be controlled through dialog with the outside world. (This same picture was shown in the Introduction.)

### Emotion in the EBM

Emotions play an important role in the decision-making and expression process, as given by example in the Introduction chapter.

Some 400 terms that indicate types of emotion have been isolated and identified by the EBM. About 10% of these have been identified as “core” emotions, with the remainder used to indicate degrees of expression of those core emotions.

### Feelings Versus Emotion—EBM Definition and Use

We call the core elements “emotions” and their degrees of expression “feelings”. It may not be a perfect definition but it suits the model well.

Ideally, the core emotions represent the universe of hormones released by the endocrine system to incite the sense of specific emotion, no more and no less. In practice, it appears to the EBM that the exact set chosen as “core” is not as critical as internal consistency of definition and use. If the selection of any is not optimal, inconsistency or inability to express the emotions properly becomes obvious quite soon.

Some 400 or more separate emotions can be readily identified, some of which are mutually exclusive and some of which describe markers along a range of values (i.e., a gamut of emotions). That set of emotions has been divided into some 30+ specific emotions, each having its independent gamut for which certain values are named.

Other groupings or divisions of emotions could also be used without altering the concept being described here. Additionally, other emotions exist that are not reasonably described using a gamut-based enumerated set of names.

The value of the gamut approach is simplification of emotions into closely-related categories that the brain model can describe to an interested party. Rather than stating the percentage of emotion it feels (i.e., 0-100%, which would be silly and stilted), it can now use the conventional terminology that describes its present feeling. This also permits the use of idioms (well being or scatter-brained to succinctly communicate nuances of emotion.

Finally, the gamut concept is fully compatible with the system of weighted relationals used with individual neurons in the EBM behavioral brain model. Each root emotion can be configured to reserve 32 consecutive (preferably the first 32) relational slots to depict the name of a variant of emotion. While 32 slots is a matter of convenience, variable-length lists or other fixed-length list sizes can be used. The assignment of weight-codes for the gamut table is described in the previous section.

Such a gamut of feelings might look something like the following, an example of what a mental clarity emotion's mapping might look like. Like other gamuts illustrated in FIG. 15, the choice of underlying emotion name and the terms used to describe its intensity are subject to change, tweaking and additions. The examples are intended to be illustrative and not precise, and actual values used may reasonably be quite different.

The ideal choices for nomenclature and would be mutually exclusive within a given emotion. The challenge is to properly identify what names are simply enumerations of an underlying emotion, and what that underlying emotion might properly be.

Obviously, the intensity of a given emotion could vary from 0-100%, or even −100% to +100%. While either can be preferably used, we use and illustrate the range of 0-100%, with 50% being a nominal emotion with “nothing happening”.

### Table of Example Gamuts (of Emotion)

The following table shows example gamuts of emotion. The percentage assignments happen to be loosely based on 3% increments, such that the gamut can be expressed over a range of 32 unique values. (This way, a range of 0-100% can be expressed as a value from 0-31.)

The nomenclature in the table names the representative emotions as ‘E_emotion-name’, where emotion-name is the root emotion being assigned a gamut of values. The suffix “,g,e” is a syntax of convenience that happens to be used in an implementation of the EBM, although other means can be used to depict the type of value being described. The numeric values given are values (in percent) that approximate the value of the root emotion for which the name applies.

```
E_acceptance,g,e(bitterness/bitter=0, rejected=10, disapproved=15, distant=20,
  separated=25, suspicion=30,
  negative=35, lonely=40, alone=45, indifferent/indifference=50, tolerance=55,
  accepted/acceptance=65,
  friendship=70, closeness/close=75, connected=80, delighted/delight=85,
  approval=90, amazement=100)
E_alertness,g,e(“deep sleep”=0, sleepy/sleep=5, inattentive=10, “out of it”=20,
  boredom/bored/bore=30, weary=35, relaxed/relaxation/relax=40, docile=50,
  warn/warning=55, concerned=60, , apprehension/apprehensive=65,
  fearful=68, trepidation=72, attentive=76, alert/alertness=80, energetic/”emotional
  energy”=85, urgency=90,
  fright=95, horror=100)
E_amusement,g,e(dazed=0, grief=10, shocked/shock=20, “un-amused”=30,
  serious=35, “not funny”=40,
  indifferent=50, warmed=60, humored/humor=75, amused=85, mirthful/mirth=100)
E_anticipation,g,e(trauma=0, dread=10, frightened/fright=15, warned=20,
  suspicious/suspicion=25, negative=30,
  nervous=35, constrained=39, trepidation/trepid=42, boredom/bored=45, ennui=48,
  commonplace/”common
  place”/”common-place”=50, intrepid=55, expectation=60, desirous/desire=65,
  optimistic=70,
  persistence/persistent=75, seeking/seek=80, anticipation=85, “strong
  anticipation”=90, antsy=100)
E_composure,g,e(hysterical/hysteria=0, terror=5, shock=9, suffering=12, “torn
  up”/”torn-up”=15, frightened/fright=19,
  worried/worry=22, alarmed=26, anxiety=29, agitated/agitation=32, suspicious=35,
  troubled=38, confused=41, cautious/caution=44, sensitive=47, okay/Ok=50,
  calm=55, reconciled/reconcile=60, peace=65,
  competence/competent=70, cheer/cheerful=75, composed/composure=80,
  collected=85, optimistic/optimism=90,
  cool=100)
```

In this manner, what are commonly regarded as separate emotions or states of emotion can be readily depicted with reasonableness and surety using the gamut system. Note: Actual emotions presently embodied in the brain—and their naming conventions—differ from the above examples, although the functional behavior is essentially the same.

### Background Levels of Emotion

In the current system, emotions fire positively only. As seen in the chapter on Firing of Neurons, after firing any neuron, it decays back to a base value. For most neurons, this is zero, but need not be. For example, the base value of confidence is about 40%, and it may be fired positively or negatively from that point.

This means that the agent has a normal base level of confidence, something established in his personality profile (i.e., in his Identity neuron). The brain can then lose confidence—for many causes—but it will ultimately return to the base value unless re-fired. The base level, attack and decay times can be altered dynamically where needed.

Also, the current firing of any neuron can be suppressed because of interaction with other emotions. For example: If the agent's confidence is high and some event or statement with emotional content occurs, the volition subsystem may elect to drain any existing confidence away—rapidly.

### Initiating and Triggering Emotions

Emotions can be fired from many causes or sources. Non-inclusive examples include:
Neurons, words, or experiences with explicit emotional connection, typically from the past.
Words of emotional impact (about 3000), such as ugly.
Achievement or failure of a current goal.
Statements of explicit encouragement, discouragement or affirmation, rejection, and the like.
Cross-interaction with other emotions, particularly at a saturation level. (You may not be able to have too much fun, but you may have exceeded you need for social interaction.)
Needs drivers (e.g., achievement, communication, going potty)
Anticipation (e.g., a sub-part of a future experience)

When the requisite conditions are met, the neuron is fired.

### Example

In the Inference chapter, an example is given of the person who says, “I think blue shirts are ugly.” Ugly is a word with negative connotations. The statement of itself doesn't fire anything because it is not directed at men. However, five minutes later, the same person observes, “I see you're wearing a blue shirt.” Inference immediately arrives with the sequence: “Your shirt is ugly,” and the fact, “I've just been insulted.”
Depending on my personality configuration, I may not be insulted by the statement pair, or may only be insulted to a low degree. If the insult is permitted (received), the insult neuron—or its equivalent—is fired.
In the meanwhile, Inference proceeds forward to ascertain, “Why did Luke seem to insult me?” If a reasonable cause (he's poking fun) is found, the insult neuron is immediately drained.

The process neurons (a specific usage for a normal conceptual neuron) make significant use of the polling and thresholding of emotions. They are responsible for process steps (baking a cake, conducting a conversation) and are intimately connected with what is happening with both emotions and the resolution of needs, which also are frequently fired).

### Emotion-to-Feeling Translation

In the EBM, the 400-some words we use to define our feelings and emotion are categorized into approximately 30 base emotions. The remaining words define degrees of those emotions (and may be applied to more than one emotion, in some cases.

In this system, there are then some 30 “real” emotions and some 370 “feelings” that describe those base emotions. These feeling-words are then assigned to specific degrees of expression of specific base emotions. Several examples of these assignments are given below:

### Astonishment: Center=50

surprise(emotion),n,adj(agam(predict=7, expect=20, anticipate=30, ready=40, unexpect=50, surprise(emotion)=55, wonder(admiration)=60, awe=65, astonish=70, amaze=75, shock=80, “mind-blown”=85, stupify=90, overwhelm=95)), adv(agam(predict=7, expect=20, anticipate=30, ready=40, unexpect=50, surprise(emotion)=55, wonder(admiration)=60, awe=65, astonish=70, amaze=75, shock=80, “mind-blown”=85, stupify=90, overwhelm=95))

### Excitement: Center=50

excitement,n,adj(agam(disinterest=0, lethargy=5, tedium=10, deflate=15, ennui=25, mediocre=30, boredom=38, dull=45, excite=50, enjoy=55, glee=65, delight=70, exhilarate=80, thrill=85, electrify=90, elate=95)), adv(agam(disinterest=0, lethargy=5, tedium=10, deflate=15, ennui=25, mediocre=30, boredom=38, dull=45, excite=50, enjoy=55, glee=65, delight=70, exhilarate=80, thrill=85, electrify=90, elate=95))

The examples illustrate some internal conventions used by the startup dictionary to define the feelings. In all cases, only the root form of the words is show. When later expressed, the proper adjectival or adverbial form of the feeling words are used.

The above examples show both adjective and adverbial forms of the feeling gamuts.

### Summary of Emotions

The emotion subsystem is essential an overlay onto the top of the rest of the EBM system. The brain can operate without them and without them ever being fired. However, it makes the decision process more accurate, realistic and easier to perform, particularly where nuance is involved.

They are certainly not the mysterious gray unknown they are commonly perceived to be, and are an asset to the process of volition rather than a necessary (optional?) evil.

### Personality in the EBM

Many tests and metrics for determining both temperament (predispositions) and behavior (personality), but most deal with fixing faulty behavior, such as Dr. Taby Kahler's Transaction Analysis system. The system that garners favorable agreement among psychologists for assessment of current behavior was originally defined by Gough-Heilbrun in 1983, and is used here.

The advantage of its use is that is generally understood, such that any competent psychologist should be able to perform testing on an individual to determine these fairly basic behavioral metrics.

### Behavioral Parameters

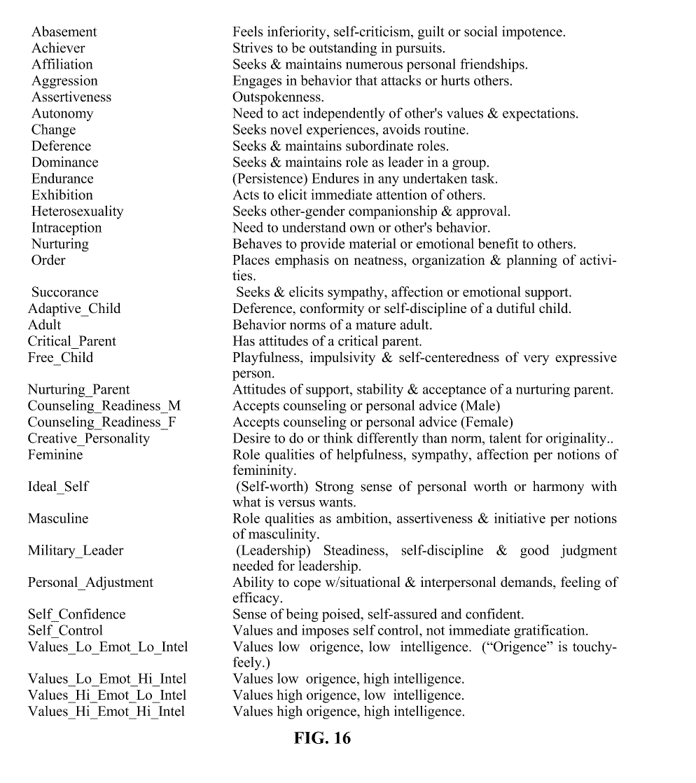

The metrics used to define behavior are illustrated in FIG. 16. Collectively, these are part of the personality profile that defines a person in the EBM, and kept in the person's identity neuron.

The above metrics are stored in the identity neurons but are extracted to a linked-list pool for rapid profile-swapping as the conversation switches between various speakers.

### Derived Traits

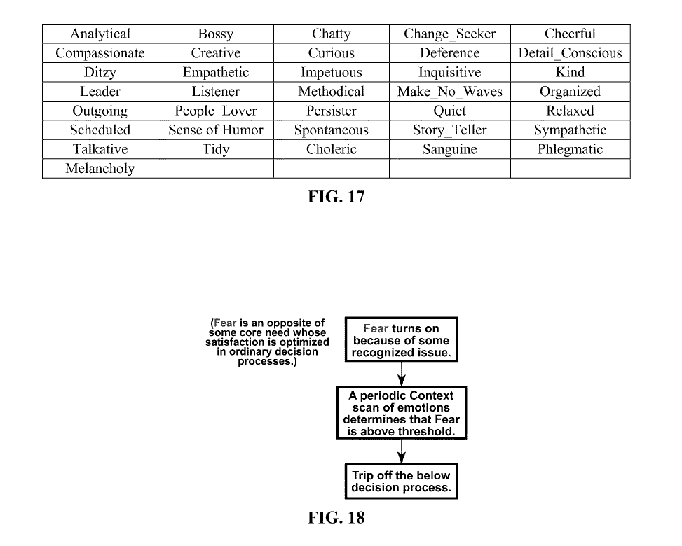

A number of traits are not specified directly in the personality behavioral but are useful to know about the person and use. These are useful in the decision processes and are derived from the profile. (They are called as functions from the Identity profile pool class.) A partial list of these is illustrated in FIG. 17.

### Internal Personality (Inclusion of Personality)

For every individual known to the brain model, there exists an identity neuron. This holds the behavioral and personal-data information for that individual. Similarly, an identical neuron (called self) exists as an identity neuron, and the self neuron defines the personality for the agent/brain itself.

The personality settings for the brain are defaulted internally to that of a secure Melancholy . . . so that it is relatively analytical about things. Throughout the brain, and particularly in the areas of Volition, experience handling, and Fonx, references are made to the current personality record and its behavioral settings. Similar references are made to specific emotions and mental states.

These references determine decision thresholds such as for depth of analysis, depth of recursive searches into the connections made to a specific neuron, and the like. Any internal decision that could be considered to be of the nature impacted by personality is a candidate for scaling it by a personality parameter. For example, the firing of emotion neurons is affected by personality, with the highest gains going to the Sanguine and lowest to the Choleric. These are not absolute scalings, but derive from the behavioral settings.

Other examples of behavior-based tweaks and scalings:
Hi origence==>Interest in personal factors and issues.
Curiosity==>Greater depth of search, longer knowledge retention
Phlegmatic==>Greater knowledge retention (greater 21-day worth)
Choleric (leadership)==>Less “gain” on emotions.
Phlegmatic (easy-going)==>Less “gain” on emotions
Sanguine (hi origence)==>Higher gain on emotions
Melancholy==>More analytical iterations during Inference, more critical of answers

There are scores of locations in the EBM where behavioral parameters can be applied. This is an ongoing process to identify and incorporate them, although the incorporation is remarkably easy to do.

### Profiling and Use of Other-Person Personality

Profiles for other people are prepared using an external tool and uploaded as a part of training sets. It is possible to have the same (word-analysis) tool incorporated into the brain and drive testing of an individual by asking questions.

Better is to have volition incrementally ask the most telling questions of the other person, accumulating the configuration data over time.

### Needs-Based Decision Processes

An implementation of a “needs-based” decision process is described here. This process colors the outcome of decisions based upon a finite set of absolute (fundamental) human needs. The list of these needs is described subsequently, and in it, we do not quibble over the nuances of needs versus desires. Rather, recognition is given to absolute needs, and provision is made to additionally include person-specific desires perceived by that person as needs.

The implementation of many processes in the EBM is done in such a manner that activity effectively happens in parallel. The Context Pool holds of pools of information held in common between these processes. These include pools specific to current emotion, experiences and other (‘ordinary’) neurons, and others.

### Background Scanning

As a part of the Volition subsystem, context pool items are rescanned for relevance. Part of that activity identifies the firing (or re-firing) of emotions. Like all firing neurons, their firing levels rise and decay following specific time constants, causing them to rise and fall below certain established thresholds.

One of these thresholds defines the initial awareness of emotion. For example, without describing how fear was caused, its firing above a threshold causes the initiation of a need that requires resolution. FIG. 18 depicts that initiation of a process.

The overall process looks something like this and happens on a periodic basis:
1. Identify a need.
2. Weigh and fire the need on the basis of the product of need and perceived relevance or importance.
3. Link the need into the Needs pool.
4. Process the Needs pool periodically to see those still firing.
5. Run a decision process to find the best action (or combination of actions) to take.

### List of Basic Needs

Following is a list of some basic needs. Each of these is implemented similarly to an emotion neuron (and is a conceptual neuron) that is fired by some specified condition or classes of conditions. This list is representative, and their exact number and names may vary from this document.

| | | |
|---|---|---|
| Security | Adventure | Freedom |
| Exchange | Power | Expansion |
| Acceptance | Community | Expression |

During the course of periodic scans of the Context Pool, some of these emotion-based neurons may get fired. The firing of any of these above a temperament-specific threshold causes a special process to take place that evaluates what is happening and what to do about it.

### Optimizing Basic Needs—a Fundamental Process

When a basic need exists—i.e., it is firing above some threshold—the decision process is defined to resolve these needs. For each, there are many factors (neurons) that may initiate or contribute to the need. The decision process acts to minimize the need by taking action to optimize the cause(s) of that need.

### Decision Process Flow

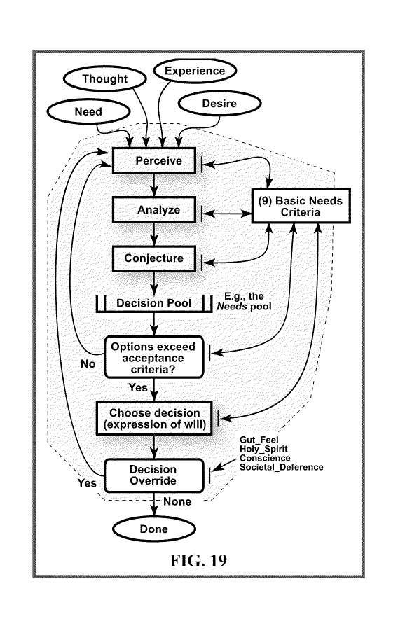

The general decision process flow is shown in FIG. 19. The decision pool (of needs, in this case) is loaded by external means described earlier. Similar decision pools also exist and are loaded by the other causes shown at the top of FIG. 19.

This flow diagram does not imply any specific decisions, but the process of making the decisions. Most parts of the flow have the ability to alter the outcome of the decision flow by altering the needs criteria.

Some of the process boxes may be skipped based on experience-related conditions, all of which are available as inputs to the process areas.

The decision loop is run until we are satisfied with the solution or course of action. There are many separate conditions to satisfy.

Regardless of temperament and personality effects such as experience, the process is repeated until there is sufficient confidence in the outcome. Some have so little expectation that they will settle for almost any outcome.

### Decision Override

There is an additional area consideration shown in the FIG. 19. After a decision has been made, one in keeping with desires, needs and will, it is subject to being trumped. The decision option may then become discarded (such that we have no action taken) or it may be altered, predicated upon external conditions.

For example, if an Army private who decides to do something may discard the decision out of deference for a sergeant in his chain of command. Other influences such as the Holy Spirit may so dictate that the choice was not the proper one, even for reasons not shared. The decision is therefore altered or is discarded completely.

Experiences and their Memory

Everyone's life experience can be structured on a timeline of events. From the moment we were conceived until the moment we die, our life is a series of nested events. By their very nature, events are structured in a hierarchical fashion.

### The Experience Neuron

Experiences are maintained in their own class of neurons, the exper neuron. They have their own set of relational connection types and similar or identical underlying utility operations as normal conceptual neurons do.
Emotional Content
Setting of Future Expectations
Measuring Outcomes Against Expectations
Roll-Up and Closing of Expectations

For convenience and to track events in a current context, they have their own linked-list pool, part of the context pool. Volition functions decide experiences worthy of storage in the pool and/or neurons.

Every experience has the following characteristics:
A beginning and an end, with either absolute or fuzzy times
Expectations
Assessments of expectations met or not
Emotional impact from the events of the experience
Optionally nested sub-events that make up the larger event space
A name or conceptual identification for the event

Each of the above elements (and more) are stored in the exper neurons and may optionally be retrieved into an experience context pool.

### Experience Information

All experiences have event Type, Status, Open Date, Close Date, Place, Emot Stamp and Name elements.
Type—There are several classes of events, and the class types are defined as:
   enum event_type {EVENT_TEMP, EVENT_SHORT, EVENT_FROM_GOD};

Event types include:
Temp events are nominal events like walking and eating. These are event list thingies set up by Thomas' event list stuff.
Short events are all other events we run into during non-training. These include events such as a “Vacation in Hawaii”.
Events From God are acquired in static mode and would include things such as our “Geography Training” or even our “Identity Setup”.

All events are passed an Event_Type parameter and are critical to later analyzer functions.
Status—The status or disposition of an event is recorded in this item. Status values may be:

enum event_status {EVENT_STATUS_UNDECIDED,
EVENT_STATUS_PERMANENT_MAX,
EVENT_STATUS_PERMANENT_MIN};

Undecided is the initial status of an event. The analyzer determines when to review the events based on their type discussed above. A temp event will be forgotten much more quickly than a short-term event. The analyzer will change the Event_Status from undecided to either Permanent_Max or Permanent Min, or he will delete the entry completely.
Permanent_Max keeps all the data.
Permanent Min will stores the minimum amount of information. (We've been here before but we can't remember exactly when. We could conjecture on the when and depending on our conjecture abilities we could either get it right or we could be off.
Open Date—All events are defaulted with an Open Date integer. If one is not supplied, a date will be generated from the system clock.
Close_Date—An event is closed (no longer active) when the Close Date is populated. It is an integer. It must be supplied if you intend to close the Event. Events can be altered without closing them.
Place—The Place given upon creation, or generated from a higher Experience via the Exper_Get_Parent function.
Emot_Stamp—The Emot Stamp is the Neuron Id of the Emot Neuron containing the R_EMOT relns to all extremely fired emotions. For static training there is be no Emot Stamp unless we synthesize one for the purpose of installed memories. For live mode, the stamp is generated at creation of the experience. These stamps can be later altered. Emot Stamps for nested experiences are used to re-calculate the stamp for the parent event. A trip to Hawaii will carry an emotional stamp with it that reflects the collective whole of its child events.
Name—Name is a text string name representing the event. There is a function Event_Lookup_By_Name that will utilize this text string in the case we only know the event by text name.

### Examples of Usage

Upon startup, the agent gets default experiences opened. The first is one entitled “life”. It remains open during the course of the agent's existence. The second event is titled “static training”. This event remains open while in static training mode. (Essentially the agent “boots up” in static mode.)

Nested events are determined by querying the Event table and seeing which events were opened within other open events that were not closed.

An example of a possible Event structure post-analyzer clean-up could be:

```
Event Name: Vacation in Hawaii
  Event Name: Shopping at mall.
    Event Name: Dropped Ice Cream Cone
Event Name: Diamond Head Scenic Hike
  Event Name: Heat Stroke
  Event Name: Observed a solar eclipse.
```

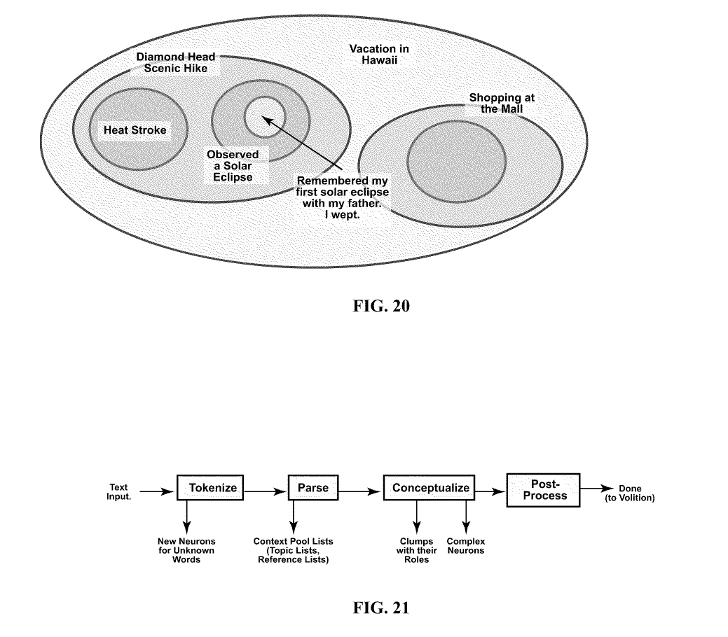

These can be demonstrated in FIG. 20.

If we calculate the final Emot stamp of a “parent” event at first glance it would appear we would lose some information.

Let's say our trip to Hawaii was OK in hindsight. At first I thought we would lose the initial Emot stamp that was replaced by the total, but we do not.
“How was your trip to Hawaii?” “It was Ok.”

We can look at each success nested event and determine how it affected the average. If certain emotions were higher or lower than the average on nested events we would know what direction the parent Exper's Emots were before the nested event occurred.
“I was so excited to go to Hawaii, but after I went it wasn't what I thought. In particular, the food was terrible and my fishing trip was a disaster.”
   Experiences within the Experience

On the whole, the vacation might have been awesome, except that there was a terrible argument with your wife for a half hour on the 3^{rd} day. Given that it was a two-week vacation, it was a great time on the whole, because the two of you readily kissed and made up. The blow-up was a less-than-memorable experience within the overall two-week experience of the vacation. It will likely play some small part in deciding your answer to the question of how was your vacation.

The EBM therefore must handle the ‘nested’ experiences, and must ensure that memory of the blow-up is properly closed out by the time the vacation experience is closed out.

In fact, any such vacation is made up of many smaller experiences, some of which are worth remembering and some which are not. Each such experience is started and closed out in its sequence. Some are larger or longer lasting than others, leading to yet deeper nesting of experiences. The three days spent flying to the smaller island was a total blast with its own memories, especially when the monkey dropped to coconut shard on your head from high up in the tree. The couple sharing your dinner table thought it funny, anyway!

If some form of recursive provision is made for nesting, then all these experiences will be captured and assessed, each in their proper turn. That multiple experiences are occurring simultaneously is then not a problem.

Obviously, the outermost vacation experiences closes after the experience with monkey closes, notwithstanding the slight sensitive spot left on the top of your head where the coconut fell. In other words, the hierarchy of experiences are closed out each in their turn such that the composite experience can later be evaluated.

### Close of the Experience

Just as in starting an experience, there is some definable end to the experience, even if it the gradual dawning of the idea that it is all over. Emotionally, the Hawaiian vacation may have been over when you checked out of your hotel, or it may have been when you turned on the lights in the kitchen as you subsequently arrived at home.

Whenever the threshold of realization that the experience is over has been reached, some explicit actions are taken to close out the experience. These involve the recording of the date (or time), determining the overall emotional assessment of the experience, and finally in comparing the experience assessment against any preceding expectations. Expectations are then readjusted in this light for future experiences.

### Recapping the Experience and its Expectations

When the experience is closed out, emotions are summarized with weighting towards those later in the experience. A smoothed average off each emotion is calculated from all recordings of the same emotion. For example, the first reference to an emotion is taken to be the new ‘previous’ value. Each subsequent reference to the same emotion is added to it, but using (for example) 45% of the previous value and 55% of the new value. This simulates a ‘FIR’(Finite Impulse Response) filter in its behavior. The actual multiplier constants used can be tuned, but must add up to 100%.

The smoothed value is compared against the initial value of the emotion existent at the experience start and a delta is formed. From this delta, the equivalent delta from the incoming emotional expectation is subtracted, yielding a final value of that emotion for the experience. It will be a net positive or a net negative emotional value and represents the ongoing expectation for such an experience in the future.

When the final has been computed, it is stored into the Experience neuron, and is also stored with the noun that defines the experience, such as Hawaiian vacation. If the delta was zero (or below some absolute threshold value), it is not stored, and all references to that emotion are removed from the experience.

All emotions but the updated expectations (and any non-expected emotions encountered during the experience) are removed from the experience.

### Expectations

Experiences are often (but not always) preceded by a set of expectations. For example, we expect to feel good about the anticipated experience yet feel uncertainty about how things will play out. Perhaps we are anticipating an upcoming vacation in Hawaii but have misgivings about the 301 details that are yet to be worked out. At the end of the experience, expectations may be compared with our assessment of the experience as a whole making it a memorable (or unmemorable!) experience.

### The Action of the Experience

Whatever the experience, it is associated with an action (verb), although some aspects of it are associated with a topic or subject (noun). For example, Hawaiian vacation is a complex noun, yet vacation(ing) in Hawaii is the verb. Experiences are considered actions and are therefore recorded with a noun.

### Emotions During the Experience

Emotions are a leading instigator of memories in human beings. If asked what for your five most vivid memories, they will each be likely (yet not always) linked to significant emotion, either positive or negative. The implementation of emotional memory in the EBM dually records the significant emotions in both the noun (Hawaiian vacation) and in a specialized neuron defined specifically for experiences.

This dual recording of emotion allows someone to ask us either question such as:
How did you feel about your Hawaiian vacation? or,
What was the most fun you had in the past 3 years?

That is, we can be asked of our feelings from multiple perspectives and still be able to come up with a realistic answer.

### Summary of Experiences

The above system is created both in advance for anticipated experiences to be had and when unanticipated experiences are encountered and opened. Actual “start” and “end” of experiences are determined by the firing of elements of the experience, when they exceed or fall below a threshold. Like many other situations within the brain, all experiences have “back-relationals” that point to their constituent elements, and forward relns to the experience. Therefore, just referencing the elements (e.g., the ticket purchase) has the potential to indicate that an experience has started.

This is to account for the fact that one cannot explicitly state where the gray edges of an experience are. Did the vacation start when you bought the ticket, when you locked your house, when you got on the plane, checked into your hotel? This gives us an explicit means to ascertain the begin/end of an experience.

### Learning Methods in the EBM

An “ontology” is simply a repository of knowledge. We do not consider a simple dictionary an ontology, per se. However, an ontology is formed starting from a base dictionary, storing it in the form of cross-connected neurons. Various processes add to the knowledge, such as reading of text.

### From Startup Dictionary to Ontology

This section gives a glimpse of the (text-based) format for the startup dictionary/grammar files. Overall, the files are loosely organized as follows:
Structural and grammar words: These include irregular forms (such as verbs), some specialized verbs and words not in the set {nouns, adjectives, verbs, adverbs}. What is left are the “structural words” that do not change much over a 200-year window, about 2,000 words.
Verbs: This may include Predicate Argument Structure (PAS) or Parental Restrictions (PPR) information, about 4,000
Nouns: A multi-organizational collection of nouns (about 10,000)
Miscellaneous forms: about 3,500
Emotional forms and definitions

After these are loaded, information that depends upon these (e.g., process neurons) are then loaded

Finally, some text to define basic common sense is loaded. Following this, any other training text can be loaded.

### Irregular Verb Tenses

“Gamut” is used internally to specify emotions, adjectives and adverbs. This is simply a block of information stored within a neuron body, often in some specific order. A variant of it is also used in the grammar file to specify irregular verbs. The difference is that with verbs, the gamut value specifies the tense flags for the verb.

Within the verb definitions, we choose to implement both British and American forms of the verb tenses, with the American (or more common) form first. As with all gamuts, the primary version to be used for sentence reconstruction is placed first. As with other gamut specifications, gamut is specified in a truncated field, of five bits in this case. That means that reconstructed numeric gamut values are rounded up or down to the nearest 5-bit value. This is demonstrated in the below example.

### Example Parse of Gamut-Based Irregular Verb Tenses

The following lines of text are typical of those used to describe verbs. Gamut positions correspond to the tense flags for Present, Past and Past Perfect.
bid,v(itv,tv,irr(bid,bade/bid,bidden/bid))
arise,v(itv,irr(arise,arose,arisen))
awake,v(itv,irr(awake,awoke,awakened/awoken))
be,v(irr(be,was/were,been))

If enabled, validation of the obtained values is shown in the diagnostic outputs. (The above lines were manually inserted into the text for comparison purposes.) We get:
bid,v(itv,tv,irr(bid,bade/bid,bidden/bid))
   256 ‘bid’,v of bid (256), pres, past, ppart
   257 ‘bade’,v of bid (256), past
   258 ‘bidden’,v of bid (256), ppart
arise,v(itv,irr(arise,arose,arisen))
   259 ‘arise’,v of arise (259), pres
   260 ‘arose’,v of arise (259), past
   261 ‘arisen’,v of arise (259), ppart

The concept of gamut offers a way to systematically define nuances of expression that are commonplace and in daily usage. It simplifies the organization and cross-linking of information, facts and relationships. Gamut is also a perspective and way of approaching the problem of nuance in human interaction.

### Ontology Support

Each class of neurons (5-7, typically) has similar tools to support it, such as:
Neuron Creation
Addition of connections
Cross-referencing
Lookup
Extraction of information
General support

The support operations for normal (conceptual/fact) neurons is the largest, followed by that for clump (verb/phrase/temporal) neurons. Any neuron class may potentially have connections to any other class, although there are explicit connections that are permitted or not.

These neuron type-specific support operations range from low-level primitives to big-picture support, such as “what is the topic of this phrase?”

Each neuron has its own explicit set of relational connection types, and these are fully supported by appropriate utility operations. Each connection is unidirectional, and support functions synthesize bidirectional operations when appropriate.

### Summary

Learning in the EBM is not the feedback system of classical neural nets, but does include feedback. It is primarily by training the brain with text, in which the parser results ultimately form neuron place-holders for concepts and then form relational connections between those neurons.

The brain can also learn just as people do by feedback in the form of sentences, whether they be replies to questions or clarification of knowledge given by feedback from another person. This new knowledge supplements the growing ontology that originated with the initial word dictionary on start-up.

### The Tokenizer

The Parser first uses a “tokenizer” to pre-process sentences. A tokenizing process breaks text into basic components, words or punctuation. These words need not be known, but could be a collection of letters or a sequence of symbols. These “tokens” are the input that drives the parsing process.

The input to the tokenizer is a text string and the output is a tree of “tokens” for consumption by the natural-language parser. The basic steps involved include:
Separate sentence into individual words and punctuation.
Look up the words in a binary-search table to find their (permanent) neuron ID serial number.
Build an option tree for multi-meaning words.
Identify unknown words and assign a neuron to them with its neuron ID serial number.
Resolve ambiguity between two word meanings if data is known at this time.
Obtain any needed word type information where available.
Return a tree of tokens to the parser for its use.

The tokenizer is a rather conventional process that operates in a manner similar the equivalent steps for an ordinary computer language compiler. It performs relatively few exceptional steps (such as ambiguity resolution).

### Information Sources for the Tokenizer

The mainstay source of “data” for the tokenizer is the textual search table that provides a mapping of English (or profession-specific) words onto associated neuron IDs.

The initial source for this table is a dictionary-like collection of words and their semantic (and/or PAS/PPR) information. During start-up, the words are placed in the text table while all remaining information about them is stored directly as connection information in their associated neurons.

The combination of the text table and neural interconnect information comprise an “ontology,” a representation of human-like knowledge, but one that is fully digested and concept- rather than word-based.

### Organizational Flow

An independent execution thread is assigned to handle these operations in sequence for each sentence:
Tokenize sentence text into a token tree.
Parse token tree into a parse-option tree.
Conceptualize: Convert the winning parse-option tree into neurons and inter-neuron connections.

The above steps may cause system events to be sent to the Volition thread for investigation, completion of post-parse operations (e.g., inference, topic summary, et. al.) and other reasons.

After each pass through the parse thread, thread execution is suspended.

### The Natural Language Parser

Referring now to FIG. 21, the parsing of natural language text is one of the most difficult challenges in computing. The subtleties, nuances, innuendos, idioms, dynamic nature and ambiguities are but a portion of the quest to accurately break down natural text into its relevant and intended meaning. Behind every text is a conceptual thought. The EBM Natural Language Parser discerns the thought.

Through breaking down sentences into their conceptual parts, analyzing, topic tracking, and an awareness of context, previously daunting sentence are handled.

In parsing any language we are faced with multi-tiered layers of complexity. The grammatical side of the parse—difficult of a task as it is to do accurately—is only a part of the task whole. Grammatically speaking, a sentence has a format and syntax it adheres to. Generally, any given language will have a rule set that is for the most part followed.

In English, sentences flow from subject to verb to object. However, rules are constantly broken and improper grammar is frequently used. Yoda says, “Grave danger you are in. Impatient you are.” His first sentence is object, subject, verb. Translated in common English he is saying, “you are in grave danger”.

Likewise, “Impatient you are.” is object, subject, verb, and would be translated as, “You are impatient”. These variances must be accounted for. As readers, we are able in many cases to discern the meaning of a text passage even if it was poorly or craftily crafted. A computer has yet to demonstrate this ability.

Aside from all of this, even after a grammatical parse is discerned some process needs to actually understand it. It is one thing to say you know the main verb and subject. It is another to say you know and understand exactly what is happening, where it is happening, how it happening and how it relates to the greater context of the moment.

### Ambiguity Challenges

The ambiguity issue is far greater than just a cursory contextual understanding. There are two major types of ambiguity: lexical and structural.

Lexical ambiguity occurs when one word can mean different things. Technically, the homograph head can be interpreted differently. Words like bank, jump, chair, or cup all have multiple meanings and uses. An example of such is:
“American chair seeks arms.”

There are actually two lexical ambiguities here.
1. Is chair of the American variety or is chair of something that is American (e.g., leader, head-of-state)?
2. Are these arms parts of a body or parts of a chair?

In general, lexical ambiguities arise when words can function as two or more parts of speech.

Structural ambiguity occurs when a phrases owner can be misapplied.
“He painted the actors in the nude.”

Was the man painting while nude or were the actors he painted nude? Generally, context can resolve structural ambiguity. Was this man known for painting nudes? Was he known to be an eccentric or radical artist? Is this statement being tied to another that may help our understanding?

Various ambiguity ambiguous combinations, bad punctuation, complex sentences and unknown words can lead to a wide variety of grammatical parses. Take the following for example:
Chocko recognized zools fly in the night.

There are over 15 unique meanings this sentence could have. A few of the major examples (with the verb bolded) are:
In the night, Chocko recognized a certain type of fly.
Chocko recognized zools [THAT] fly. (flying zools)
Chocko recognized (not at any specified time) zools that flew in the night.
In the night, the chocko recognized zools fly. (zools is the main noun)
Chocko recognized zool[']s fly. (zool is an identity that possesses the fly)

These are just a subset of actual possibilities.

Better punctuation aids in part of the puzzle. A broader understanding of more words helps with another part. Context can help too. However, no single answer can calculate at parse time what the answer actually is. Another method must be followed to get to the solution.

The EBM Natural Language Parser approaches the problem on multiple planes and is recursive at more than one of those planes.

### The Predicate Argument Structure (Pas)

Central to any sentence or thought is the main verb. It is the driver of the sentence car. As seen in the above examples, for any given sentence, selecting a different main verb leads to a drastically different meaning

The main verb assigns semantic “roles” or “responsibilities” to the various grammatical constituents and when that verb changes the entire sentence changes. The unique verb can occur in a certain manner, at a particular time, it can carry a theme, and there can be a main agents or something that experiences the verbs action.

Modifiers such as roles, experiences and locations enable the transfer of words to concepts. The words are not stored, the concepts behind the words are.

The PAS consists of some 24 different semantic roles that can be assigned by any given verb. An example of some these roles are:
agent: Georgio painted the actors in the nude.
experiencer: The dog caught the Frisbee.
time: In the night, the creatures come out to play.
manner: The chicken quickly crossed the road.
place: I like to eat hotdogs at the ballpark.
topic: Snakes claim that Chinese cooks are dangerous.

With the PAS information for verbs, the EBM Parser is able to understand the unique relationships that can occur between verbs and the roles, or responsibilities, they assign.

### Sentence Roles

In addition to Semantic Roles assigned by the verb, there are also roles assigned at the sentence level. These are frequently used to connect thoughts. Correlative pairs, such as “if—then” will establish a unique relationship between sentence. Adverbial Conjunctions such as “however” denote contrast to a previous statement. These play a critical role in understanding the relationships between thoughts.

### The Parsing Process

The EBM Natural Language Parser is recursive by nature. Its primary assignment is to find all grammatical possibilities for a sentence. Choosing to accept any given possible output is fallacious because it is entirely possible that a less likely and more obscure meaning was intended. Future decision processes decides which of these is the correct grammatical parse, therefore the most accurate way to handle the innumerable possibilities is to accept all possibilities.

The following is a basic flow of the EBM Natural Language Parser:
1. Tokenization
2. Pre-Rules Layer
3. PAS Verb Selection
4. Post-Rules Layer
5. Grammatical Parse
6. Role Resolution
7. Scoring
8. Conceptual ‘Clumping’

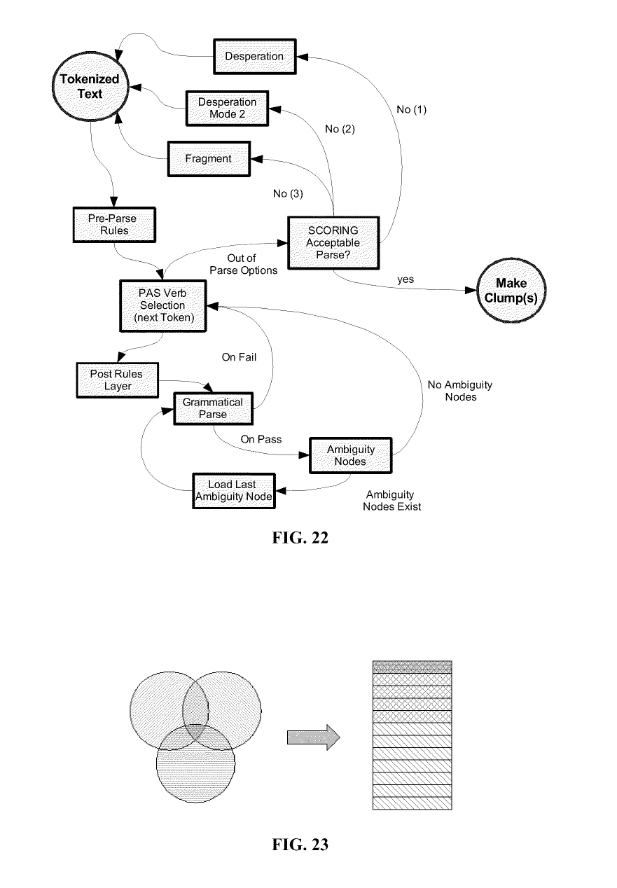

The flow is depicted in FIG. 22, showing the process from tokenized text to the creation of ‘clump’ neurons.

English has unique structural keywords that give clues to possible ambiguities. The pre-parse layer marks all the relevant tokens with flags that clue the later grammatical parser. For each sentence the Pre-Rules need only be ran once. They are not changed due to different verb attempts because they hold true no matter what the main verb ends up being.

### Tokenization

The target text must be prepped prior to attempting to parse it. A tokenizing process breaks the text into basic groupings which may be words or punctuation. These words do not have to be official words, as they could be an unknown collection of letters or a sequence of symbols. These “tokens” are the input that drives the parsing process.

### PAS Verb Selection

The Predicate Argument Structure verb, or the main verb, is selected through a scoring system. The scoring system determines which possible verbs to try. Regardless of success, other options will also be selected and tried due to the recursive nature of the parser. For any given parse attempt, the PAS Verb selected is the main verb. Going forward, the parser assumes this to be true and proceeds as if it were so. This enables the EBM Natural Language Parser to avoid the complexities of constantly attempting to resolve the issue during the grammatical parse.

Further information is provided on the PAS Verb Selection process in the EBM PAS Verb document

### Post-Rules Layer

Post rules are applied to the input tokens according to the assumed selected PAS Verb. In English, there are rules that can be applied once the verb is discerned. Since the EBM Natural Language Parser assumes the main verb, in any given parse the main verb has been discerned.

### Grammatical Parse

The grammatical parse is also a recursive process. When parsing text there are many “decisions” that have to be made. Many words can operate at multiple word types. Improper grammar and punctuation is often used, and that cannot prevent the parser from its task. “Decision Nodes” have been implemented that track these decision points throughout the course of a parse. An example of a decision node is the following:
The cops claimed that criminal.

A decision point occurs after the main verb “claimed”. The PAS data for the verb claim says that claim assigns a role of “theme”. This theme represents the “claim”. As a theme, the entire role itself can be a nested clause with its own PAS verb. At the point the “that” is encountered, the grammatical parser cannot be certain if a nested clause exits, if that is a relative pronoun, if is an irrelevant keyword, or if that is a determiner. A nested clause is referred to by linguists as a “CP,” or complementizer phrase. Complementizers can have heads, or words that lead them off, or they can be assumed. These cases would look like this:
The cops claimed that: Relative Pronoun Theme
The cops claimed that criminals are dangerous: Nested Theme CP w/ CP head.
The cops claimed that criminal is dangerous: Nested Determined Theme CP w/no CP head.
The cops claimed that criminal.—Determined Target.

A decision node is needed at: The cops claimed that . . . .

The decision node stores an enumerated set of information regarding the decision. Nodes are coded with their realm of possibility. Decision logic determines which possibility to choose and it records that choice in a log. Some nodes lead to ambiguity, while others do not. Upon failure, or success of any given parse, all ambiguous nodes will be chased. Essentially, the other choices are made and the parser attempts to parse that particular version.

In handling decisions in this manner, the EBM Natural Language Parser's hands are clean. There is really no decision because all decisions that lead to a valid parse are valid and acceptable at this stage.

### Role Resolution

At role resolution the grammatical roles are converted to their PAS Role counterparts. A subject may become an actor, an experiencer etc. The PAS verbs have an extensive rule set that is documented in the EBM PAS document.

### Scoring

Scoring can be viewed as a competition. The valid grammatical parse options are the competitors vying for the parse. There are multiple layers upon which the competitors are judged.
1. PAS Layer
2. Roles Layer
3. Context Layer

A score is calculated and the players compete. The highest score wins, for now.

If there in no viable options we will fall into a series of desperate modes. These modes change the way the pre-rules work and gradually get less restrictive. A sentence like, “the is my favorite determiner.” would parse once certain grammatical restrictions were loosened. The final attempt if all else fails is to parse the sentence as a fragment.

### Conceptual Clumps

Words are used to convey concepts, and clumps are a collection of those concepts that come together to form a thought. The output of the parser is a single clump that is neatly stored in its conceptual form. See EBM Conceptual Clumps.doc for detailed documentation.

### Organization

An independent execution thread is assigned to handle these operations in sequence for each sentence:
Tokenize sentence text into a token tree.
Parse token tree into a parse-option tree.
Conceptualize: Convert the winning parse-option tree into neurons and inter-neuron connections.

The above steps may cause system events to be sent to the Volition thread for investigation, completion of post-parse operations (e.g., inference, topic summary, et. al.) and other reasons.

After each pass through the parse thread, thread execution is suspended.

### Conclusion

The EBM Natural Language Parser is a multi-layered recursive parser that is not restrictive like parsers of the past. With our approach to verb selection, ambiguity, unknown word handling and decision nodes, we are capable of parsing virtually any text.

### Word Ambiguity Resolution

A typical sentence parse may encounter multiple areas of ambiguity in the intended use of a word. These include the following example cases case types:
Which (of 7) meanings of jump—or some other word—is involved here? Is it jump the action, to be jumped in a dark alley, a ski jump, to jump a battery . . . ?
What does it or they or area refer to? What is the antecedent word, concept or action that is referred to? This is especially true for inter-sentence pronouns.
Intra-sentence pronouns often have ambiguity that differ in meaning by shades between two concepts.

These and other types of resolution that occur are resolved in different ways, separate resolution logic serves both the parser and the “conceptualizer” that closes out the parse sequence.

### Tools of Resolution

A number of tools are used in neuron (Nid) and pronoun resolution. Among others, these include:
“cull_pool” objects with set-based operators
Nearest-common-parent logic
Most-recently-used topics, weighted for age
Context history
Current most-likely topics and support that points to them (part of
Volition, and based on recently-parsed sentence results.

While this chapter gives implementation-specific names (it is a part of internal documentation), it considered to be of help in understanding overall processes involved.

### Procedural Flow

The following pseudocode outlines the procedural flow of the contextual phrase resolution heuristics. In the code, the use of the term link and pool refer to the links of a linked list, managed under the guise of a single pool of common information. (Links and pools of this type are constituent parts of the Context Pool, a catch-all title for short-term memory.)

The This_Ph_In_Context item is called after parsing a phrase, but before conceptualization and context-culling.

```
english_new::Res_This_Ph_In_Context ( )
  Resolve_Ph_In_Cxt (ph_link *Ph_Link)
    At each Mod/Root tok_link (leaf), handle the Mod (1a), then the Root (1b).
      For Mod tok_link's, Resolve_Mod:
        If a root sub-tree is present, recursively resolve it with Resolve_Ph_In_Cxt
        Otherwise, Build_Nid_Res_List for the root leaf token.
        Handle the Mod:
          For Poss PNs:
            Build_PN_Res_List
            Resolve_Possession
          For ADJs/NOUNs:
            Build_Nid_Res_List and add to Res_Rqmts list
            analyzer::Correlate_Pools_By_Nid (Res_Rqmts)
          Update_Ph_Res_Options for the Ph_Link
          Return final res nid list for the Ph_Link
      For Root tok_link's:
        1) For PNs: Build_PN_Res_List
        2) For ADJs/NOUNs: Build_Nid_Res_List
        3) Update_Ph_Res_Options for the Ph_Link
        4) Return final res nid list for the Ph_Link
  Walk Ph_Link's Mod and Root subtrees, recursively calling Resolve_Ph_In_Cxt
```

### Process Overview

Imagine that we enter the following two input sentences in sequence:
“The red dog exists.”
“The colored animal barks.”

The system should be able to resolve the latter phrase (“colored animal”) to the earlier referent (“the red dog”). To do this, the system should first place “the red dog” in its own neuron, which will happen normally during parsing of the first sentence. When the second sentence is encountered, “the colored animal” will be placed in its own ph_link, but if we attempt to conceptualize at this point, we'll just get a semantic clump of “The colored animal barks,” which, although a true statement, is not really the clump we want to create.

If we perform some contextual processing on the ph_link first, we can tie “the colored animal” back to the earlier-mentioned “red dog”. So that is where conceptual context-resolution should occur in the parsing process—after a phrase has been “closed,” but before the ph_link is handed off to Conceptualizer.

### Definition of ‘Cullprit’

The ‘cullprit’ of cull_link A is defined as the cull_link B which was responsible for cull_link A's insertion into the context cull_pool. This is found by starting at cull_link A and following each successive link's ‘From_Link’ pointer until no more From_Link pointers exists in the chain. At that point, we have cull_link B, the cullprit of A. For example, if we input the statement, “The red dog exists,” and “animal” gets placed into the context cull_pool because of its parental relationship to “dog,” then the cullprit of “animal” is “dog”.

### Scanning the Context Cull_Pool

The overall goal is to resolve a phrase (ph_link) to some existing concept (nid or cid) in memory. The ph_link will likely have several words in it, and we want to walk its parse tree (exploring Roots and Mods) and repeatedly run a cull_pool search operation (cull_pool::Find Cullprit) on each of those words. Each word that we run cull_pool::Find Cullprit on is a “Resolution Requirement”.

We continue the search after each successful find, because a word may have been entered into the context cull_pool several times by different cullprits/sources, and we want all the results. All this work is done by the function Build_Nid_Res_List, and the final output for each Resolution Requirement's cullprit search is a list of nids (nid_pool), called the “Cullprit_List”.

### Building the Resolution Requirements List

When we have each Resolution Requirement Nid's res list built up, we want to assemble all those Cullprit_List's into one data structure (Res_Rqmts). The ptr_pool class allows us to create just such a linked list of linked lists. Once this object is assembled, its pointer can be passed to analyzer::Correlate_Nid_Pools for processing.

### Comparing NID Lists

Once all the cullprit nid_pool's have been attached to the ptr_pool, we can start performing correlation operations on the nid_pool's. This is done by the function analyzer::Correlate_Nid_Pools, by successively performing set-comparison operations (nid_pool::Union) on each of the cullprit nid_pool's.

For example, we compare the Cullprit_List for “colored” with the Cullprit_List for “animal,” and the resulting set intersection reveals an associative correlation between the two words.

Although we are essentially looking for the set-intersection of the nid_pool's in Res_Rqmts, we do not use nid_pool::Intersection here. Instead, we use nid_pool::Union. This allows us to score the common (intersected) elements between two sets while joining them together into a larger set, so we can order the final unioned set by the elements' intersection frequency.

For example, if we are correlating three sets, A, B, and C, we just perform successive unions on them, then sort by Worth:
A∪B∪C, where the ∪ (Union) operation also automatically increments the Worth of all intersecting elements in the unioned set.

Then, those elements common to all sets get bumped up to the top of the list after sorting by Worth, which is illustrated in FIG. 23.

### Summary

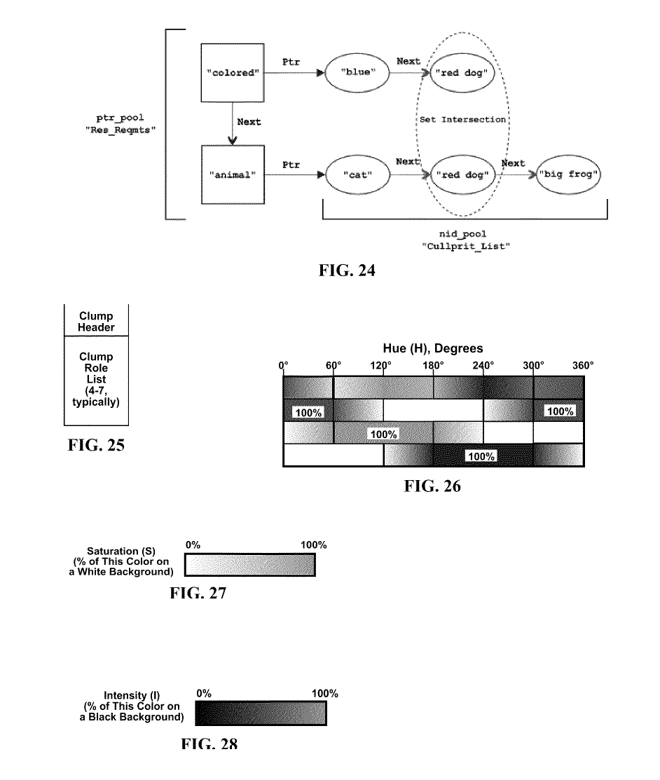

FIG. 24 illustrates the structure of the Res_Rqmts ptr_pool, its cullprit nid_pool's, and a simple correlation between two of those nid_pool's.

### Pronoun Resolution

Imagine that we enter the following input sentences in sequence:
“The red dog hates cats.”
“He chases them.”
“They fear his teeth.”

The system should be able to resolve the ambiguous pronouns (he/them/they/his) to the correct referent in context, taking into account relevant information about gender, plurality, and possession. The resulting clumps for the last two statements should be “The red dog chases cats” and “Cats fear the red dog's teeth.” As several other interpretations may be possible, the system should make a best-effort attempt to resolve the ambiguous pronouns or noun phrases down to a single instance, class, or group.

### Building the Pronoun Res List

As with Build_Nid_Res_List (used during conceptual context resolution), Build_PN_Res_List scans the context cull_pool for potential referents of the given Nid, and builds up a list of them. The candidate lists are built slightly differently for first, second, and third person pronouns. Still, follow the same overall approach: Look for Nids placed into the context cull_pool from a previous parse, and which match the pronoun's gender, plurality, and possessiveness.

First and second person are relatively simple cases (since “I” and “you,” by definition, imply very specific referents) whereas the third person pronouns warrant a more complex scoring algorithm to build up and manage the larger sets of res candidates. In the case of a plural pronoun (we/they), we also might need to resolve to a group of Nids, so special processing is needed there, as well.

### Selecting the Best Candidate

The res candidates for a third person pronoun are scored for Worth in Build_PN_Res_List_{—}3rd_Pers (as the list is built up). While scanning through the context cull_pool, this function scores each new nid added to the res list by considering the age of the current cull_link and whether it was the subject of the sentence. Other considerations can be added to the scoring algorithm to further refine it. The actual selection of the top candidate(s) is done later in Update_Ph_Res_Options. There, a Confidence score is calculated from each nid's Worth; the main ph_link's Res_Wi_Pool is updated with the new candidate nid.

If a very high-confidence resolution decision is made on a gendered pronoun (he/she), the nid that we resolved to is automatically updated with a new reln indicating the gender relationship. In the above example, “He chases them” implies that “the red dog” is a male, which was a previously unknown fact. Since new information has been introduced during the process of context resolution, we make that new knowledge permanent by attaching the new gender reln to the “the red dog” neuron.

No relevance-scoring is really performed for first and second person pronouns. They are degenerately resolved to the Speaker_Nid and Self_Nid, respectively. If a plural form of either of those personages is encountered (we/us/our, you (all)/your), then Resolve_Nid_To_Group (described below) is called to add other candidates to the res list. The resulting group will contain the Speaker/Self Nid, as well as some additional nid(s) drawn from the context cull_pool.

### Handling Plural Pronouns

For all personages, plural pronouns need to be resolved to class or group nids, which both have implicit plurality. Resolve_Nid_To_Group accepts a list (nid_pool*) of group elements and resolves it to one GRP_OF neuron which contains all elements in that list. If no such group is found, one is created in adhoc neuro_space.

### Handling Possessive Pronouns

If a possessive pronoun is encountered, we attempt to resolve it together with its possession to some unique nid. So in the above example, res candidate lists are built up separately for the mod (“his”) and the root (“teeth”), and then those lists are correlated/intersected to produce a res option list for the whole noun phrase (“his teeth”). This way we attempt to limit the final res options for the noun phrase to only those possessors X which are known to have a possession (R_POSSN) Y. If only “his” could be resolved, and not “teeth,” then only the mod (“his”) gets its Res_Wi_Pool updated with the resolved-to nid. During conceptualization in this case, a new instance nid of “teeth” will be created, with an R_POSSN_OF “the red dog”. If such an instance of the red dog's teeth already existed in neuro_space, however, then the whole noun phrase (“his teeth”) would have been resolved to that object and the top-level Res_Wi_Pool updated accordingly.

### Fonx Clarification Requests

If, after building up a resolution candidate list and attempting to select the best candidate, the pronoun is still left unresolved, we need to prompt the user for a clarification of the ambiguous pronoun. This is done by calling Fonx::Clarify, which outputs a pre-formatted clarification request to the chat dialog, e.g., “Which person is meant by ‘he’?”

### Test Cases

Tsunamis occur when large volumes of water are rapidly displaced by seismic events.
These giant waves are often caused by undersea earthquakes.
Some can be caused by volcanic eruptions or even by asteroid impacts.
The largest recorded tsunami in history occurred in 2004 in the Indian Ocean.
The earthquake which caused it was one of the most powerful ever recorded.
The waves reached 30 meters high in some places and caused extensive damage.
The destructive and unexpected event is considered one of the deadliest natural disasters in history.

### The Conceptualizer

The function of the conceptualizes is to process the parser output tree, creating new neurons when necessary and storing conceptual associations derived from the incoming text.

In this model, this is a two stage process. The first stage is organizational, in which the parser stack output deposited into a structure that facilitates creation of relational linkages. From this structure, the information is processed to create relational linkages between concepts.

Outputs of the conceptualizer are:
A clump (verb-based) neuron that captures the essence of an independent clause
A set of normal (conceptual) neurons created for and referenced by the clump neuron.

The methodology uses:

### Basic Operation

The object and basic output of the conceptualizer is creation of a clump neuron (referenced via a “Cid” index). From the parser, the conceptualizer receives a set of linked-list records that define the content for the clump.

Operational steps then include:
Resolve pronouns and other possibly arcane references back to their antecedent.
Create the clump.
Create any side-neurons referenced by the clump. These are usually “complex neurons” built from references to other neurons, e.g., “that snow-capped peak”. Ensure that previous such neurons are re-used if they exist, so we are referring to the same exact topic as before even if it was expressed differently.
Install cross-links between neurons referenced by the clump back to the clump (“back relns”). These provide a basis for later deduction and inference that will follow during subsequent Volition processes.

The outcome of the process, then, is a clump neuron and an optional set of ordinary conceptual neurons.

### What is in a Clump?

A “clump” is one of the 6 classes of neurons. As for the other types, it has its own serial number space and is referenced by cid (“clump ID”), a 32-bit structure that contains the neuron type, serial number and several other pieces of useful data. As with all neurons, clumps can be created in permanent neural space or in the (21-day) adhoc space. All neurons created during conceptualization are in the temporary adhoc space.

A clump consists of some basic header information and then a series of references to other neurons. For all other neuron types, these are referred to as “relationals,” “relational connections,” or simply “relns”. In the clump case, though, the references are called roles. This derives both from in-house linguist preferences and from their more exclusive nature.

All other neuron types gradually gain more relns over time, increasing the options for definition, awareness and inter-conceptual relationships. In the case of the clump, its contents are defined by the conceptualizer and they then never grow.

Referring now to FIG. 25, the general layout of a clump is identical to other neurons, though its neuron header contents vary slightly from other neuron types. (They all vary slightly from each other.)

All neuron headers contain two fields telling current reln/role area allocation length, and how many relns are actually present. For the clump, both of these can be known by the conceptualizer prior to clump creation. (A background process automatically reallocates a neuron that needs to grow because too many relns were added relative to its current size.)

Like relns, each role word—32 bits in the current system—contains a pair of fields at a minimum. These are an 8-bit Cmd field that indicates the role type (of which there are about 40) and a 24-bit field containing the neuron/clump serial number, of which one bit indicates if the item referenced is in adhoc (temporary) space or is in permanent space.

The first element of a clump is always a verb reference. If there is a tense-and-aspect specifier, that will follow the verb. The next chapter gives a set of example clumps produced by the conceptualizer.

### Flow Organization

An independent execution thread is assigned to handle parse-related operations in sequence for each sentence:
Tokenize sentence text into a token tree.
Parse token tree into a parse-option tree.
Conceptualize: Convert winning parse-option tree to neurons and inter-neuron connections.

The above steps may cause system events to be sent to the Volition thread for investigation, completion of post-parse operations (e.g., inference, topic summary, et. al.) and other reasons.

After each pass through the parse thread, thread execution is suspended.

### Example Conceptualizer Results

This chapter gives examples of parser outputs. In some cases, the complex neurons generated to capture the essence of a concept are also included. This a collection of items clipped from other internal documentation on conceptualizer matters.

The material in blue on the right side is regenerated equivalencies to a concept. Where a specific instance is implied (rather than a general conceptual class), the diagnostic dump usually inserts some form of determiner (e.g., “the”) to indicate a specific instance. The references in green are sentences or phrase reconstructed from the clump.

The mess oozed, from kitchen to stairwell.

The actor and location bounds are all specific instances. The location bounds circumscribe the area or region. They are not temporal (describing verbish action) and does not imply a from-to concept.

| Semantic (*5): The mess oozed between kitchen and stairwell. | | |
|---|---|---|
| 0 | VERB | ooze (1167) |
| 1 | ACTOR | the mess (1913) |
| 3 | LOC_BOUND | the kitchen (7348) |
| 4 | LOC_BOUND | the stairwell (7349) |
| 5 | PARENT_CID | The mess oozed between |
| | | the kitchen and stairwell. (3 cc) |

The mess oozed from the kitchen to the stairwell.

The action takes place from some starting point and moves towards a goal (locale, here). The action is temporal, a verbish action, and implies a from-to concept. (Taspect was ignored here.)

| Semantic (*5): The mess oozed from the kitchen to the stairwell. | | |
|---|---|---|
| 0 | VERB | ooze (1167) |
| 1 | EXPERIENCER | mess (1913) |
| 3 | SOURCE | kitchen (7348) |
| 4 | GOAL | the stairwell (7349) |
| 5 | PARENT_CID | mess oozed from the |
| | | kitchen to the stairwell. (3 cc) |

Johnny walked from the kitchen.

The source defines the beginning of the action. (Taspect was ignored here.) Source defines where the action started from.

| Semantic (*5): Johnny walked from the kitchen. | | |
|---|---|---|
| 0 | VERB | walk (1167) |
| 1 | ACTOR | John (1913) |
| 2 | SOURCE | the kitchen (7348) |
| 3 | PARENT_CID | Johnny walked from the kitchen. (3 cc) |

I gave pencils to the teacher.

The goal is recipient of the action or is the target destination. (Taspect was ignored here.)

| Semantic (*5): I gave pencils to the teacher. | | |
|---|---|---|
| 0 | VERB | give (1167) |
| 1 | ACTOR | (self) (1913) |
| 2 | EXPERIENCER | pencils (1517) |
| 3 | GOAL | the teacher (7348) |
| 4 | PARENT_CID | I gave pencils to the teachers. (3 cc) |

We walked (for) fifteen kilometers.

The for is optional and produces same result. Distance is encoded by TBD means, but preferably in its own spatial neuron. (We may be back to considering the Tid as a space-time neuron, not time alone. The taspect was ignored here.)

| Semantic (*5): We walked fifteen kilometers. | | |
|---|---|---|
| 0 | VERB | walk (1167) |
| 1 | ACTOR | we (1913) |
| 2 | DISTANCE | fifteen kilometers (1517) |
| 3 | PARENT_CID | We walked for fifteen kilometers. (3 cc) |

You are crazy, else I am a horny toad.

This is a special case of English. There is no explicit word to indicate if or other conditional. The else is discarded and the test condition is “inverted”. That is, an SC_IF_NOT is used instead of an SC_IF.

Semantic (*15): You are crazy, else I am a horny toad.

| | | |
|---|---|---|
| 0 | VERB | be (1167) |
| 1 | IF_NOT_CID | “you are crazy” (*2) |

| | | |
|---|---|---|
| 2 | EXPERIENCER | <self> (1517) |

| | | |
|---|---|---|
| 3 | DEFINING | horny toad (2527) |
| 4 | PARENT_CID | You are crazy, else I am a horny toad. (3 cc) |

If the bananas are not green, I will eat one, else you will eat one.
(tentative)

This is a ‘standard’ if-then-else situation, but in English. The test condition is the fact that bananas are not green, something that has to be tested for in real time. If the assertion is true, then There is no explicit word to indicate if or other conditional. The else is discarded and the test condition is “inverted”. That is, an SC_IF_NOT is used instead of an SC_IF. The taspect was ignored here.)

Semantic (*15): If the bananas are not green, I will eat one, else yo . . .

| | | |
|---|---|---|
| 0 | VERB | eat (1167) |
| 1 | IF_CID | “the bananas are not green.” (*2) |
| 2 | ACTOR | <self> (1517) |

| | | |
|---|---|---|
| 3 | EXPERIENCER | banana (2527) |

| | | |
|---|---|---|
| 4 | ELSE | “you will eat one.” (*6) |
| 5 | PARENT_CID | If the bananas are not green, I will eat one, |
| | | else yo . . . (3 cc) |

Hannah is a friend.

Generic definition case; see next similar example for comments. (The taspect was ignored here.)

| Semantic (*2): Hannah is a friend. | | |
|---|---|---|
| 0 | VERB | be (3) |

| | | |
|---|---|---|
| 1 | EXPERIENCER | Hannah (11820) |

| | | |
|---|---|---|
| 2 | DEFINING | friend (2012) |
| 3 | PARENT_CID | (7 cc) |

Is an elephant an animal?

This is a question of confirmation, and is either true or false. Note the use of a non-be verb.

Depending on what subsystem poses the question, the answer may come back qualified, or the question may be objected to as being illogical for some reason. The QUESTION WD role contains a word defining the type of question.

| Semantic (*120): Is an elephant an animal? | | |
|---|---|---|
| 0 | VERB | be (3) |

| | | |
|---|---|---|
| 1 | EXPERIENCER | elephant (5443) |

| | | |
|---|---|---|
| 2 | DEFINING | animal (3069) |

| | | |
|---|---|---|
| 3 | QUESTION_WD | confirm (71) |

| | | |
|---|---|---|
| 4 | PARENT_CID | (4 cc) |

Do elephants fly?

This is a question of confirmation, and is either true or false. Note the use of a non-be verb. This is a suitable case for seeking the NATACT relationship using the verb as a reference.

| Semantic (*8): Do elephants fly? | | |
|---|---|---|
| 0 | VERB | fly (685) |
| 1 | ACTOR | elephant (5443) |

| | | |
|---|---|---|
| 2 | QUESTION_WD | confirm (71) |

| | | |
|---|---|---|
| 3 | PARENT_CID | (4 cc) |

Where do you go from here?

This is a where question with a prep phrase. Note that it does not have a be verb.

| Semantic (*28): Where I go? | | |
|---|---|---|
| 0 | VERB | go (711) |
| 1 | TASPECT | PRESENT SIMPLE ACTIVE (UNKNOWN |
| | | HABITUATION) |

| | | |
|---|---|---|
| 2 | QUESTION_WD | where (70), querying LOCATION |

| | | |
|---|---|---|
| 3 | ACTOR | (self) (1934) |
| 4 | SOURCE | here (1135) |
| 5 | PARENT_CID | (11 cc) |

How do cows make milk from green grass?

This is a how question with a prep phrase. It can be argued that this is a question of what manner. Further, use of INSTRUMENT is in question. As noted, this is a tentative interpretation.

| Semantic (*20): How do cows make milk from green grass? | | |
|---|---|---|
| 0 | VERB | make (12456) |
| 1 | ACTOR | cows (3996) |

| | | |
|---|---|---|
| 2 | EXPERIENCER | milk (6969) |
| 3 | INSTRUMENT | green grass (3716) |
| 3 | QUESTION_WD | how (71) |

| | | |
|---|---|---|
| 4 | PARENT_CID | (4 cc) |

Imperatives are commands to the agent. They are set into the context of the current speaker, currently determined primarily by the present setting in the IM's Speaker ID drop-down box.

Imperatives that include such commands as “tell me about,” “explore” and related words imply that a specific topic is concerned. (NOTE: Any subsystem can discover this by seeing if the word, e.g., “tell” has an ASOC to the “_tell_of” neuron.)

Tell me (Mystery Guest) about Bananas?

This sample assumes that “Mystery Guest” had previously been entered into the IM's Speaker-ID dropdown box.

| Semantic (*2): Tell me about bananas. | | |
|---|---|---|
| 0 | VERB | tell (961) |
| 1 | TASPECT | PRESENT SIMPLE ACTIVE (UNKNOWN |
| | | HABITUATION) |
| 2 | ACTOR | (self) (1967) |
| 3 | GOAL | Mystery Guest (14005) |
| 4 | TOPIC | banana (4316) |
| 5 | PARENT_CID | (4 cc) |

There may be broadleaf trees, evergreen trees, cacti, or grasses.

Remarks: This defines variant examples of the same concept (tree), establishing content for the above area or region. The information is state-like (static) facts and must be properly tied to them.

The brain's curiosity about what the variation . . . of plants looks like is partially satisfied.

Semantic (*218): Broadleaf trees, evergreen trees, cactus or grass may
exist.

| | | |
|---|---|---|
| 0 | VERB | be (3) |

| | | |
|---|---|---|
| 1 | EXPERIENCER | broadleaf tree, evergreen tree, |
| | | cactus or grass (47*) |

| | | |
|---|---|---|
| 2 | MODAL | intention (40%) |
| 3 | MODAL | possibility (20%) |
| 54 | PARENT_CID | (3 cc) |

Your shirt is white.

This is an example of STATE, usually associated with a simple adjective.

| Semantic (*2): My shirt is white. | | |
|---|---|---|
| 0 | VERB | be (3) |

| | | |
|---|---|---|
| 1 | EXPERIENCER | my shirt (1*) |

| | | |
|---|---|---|
| 2 | STATE | white (10178) |
| 3 | PARENT_CID | My shirt is white. (3 cc) |

White shirts are ugly.

This is another example of STATE, usually associated with a simple adjective. Notice that the PARENT_CID role points to a CC that has now been expanded from the previous example.

Semantic (*11): White shirts are ugly.

| | | |
|---|---|---|
| 0 | VERB | be (3) |

| | | |
|---|---|---|
| 1 | EXPERIENCER | white shirt (2*) |

| | | |
|---|---|---|
| 2 | STATE | ugly (2278) |
| 3 | PARENT_CID | My shirt is white. White shirts are ugly. (3 cc) |

The Coke is located in the fridge. (tentative)

Both actor and location are specific instances.

| Semantic (*5): The Coke is located in the fridge. | | |
|---|---|---|
| 0 | VERB | locate (1167) |

| | | |
|---|---|---|
| 1 | EXPERIENCER | the Coke (1913) |

| | | |
|---|---|---|
| 2 | LOCATION | the fridge (7348) |
| 3 | PARENT_CID | The coke is found in the fridge. (3 cc) |

Some regions are flat while others are mountainous; some are rocky
while others have deep soil or sand.

Remarks: Contrasting concepts are being presented (see some and others). The juxtaposed concepts must maintain their relationship in the knowledge realm.

This is treated as two separate sentences (separated by the semicolon). Each occurrence of “while” triggers a CONTRAST controller clump to be created. Each INST of “region” (all EXPERIENCERs) is made a POSSN of “the earth”.

The brain marks that flat, mountainous, rocky, and deep soil or sand are some of the variations suggested in the previous sentence and that they all pertain to geography.

| | | |
|---|---|---|
| Neuron (no Wp) (*1): | “region” | |
| | CPLX_OF | region (2773) |
| | CNT_REL | some (55) |
| | END_DEFN | |

Controller (*5): Some regions are flat while other regions are
mountainous.

| 0 | SEQ | (sc 5*) | |
|---|---|---|---|
| 1 | CONTRAST | (sc 10*) | |
| 2 | PARENT_CID | (cc 3*) | |
| | Semantic (*5): Some regions are flat. | | |
| | 0 | VERB | be (3) |
| | 1 | EXPERIENCER | region (1*) |
| | 2 | STATE | flat (5688) |
| | 3 | PARENT_CID | (cc 5*) |
| | Semantic (*10): Other regions are mountainous. | | |
| | 0 | VERB | be (3) |
| | 1 | EXPERIENCER | region (2*) |
| | 2 | STATE | mountainous (3*) |
| | 3 | PARENT_CID | (cc 5*) |

Controller (*6): Some regions are rocky while other regions have deep
soil or sand.

| 0 | SEQ | (sc 15*) | |
|---|---|---|---|
| 1 | CONTRAST | (sc 20*) | |
| 2 | PARENT_CID | (cc 3*) | |
| | Semantic (*15): Some regions are rocky. | | |
| | 0 | VERB | be (3) |
| | 1 | EXPERIENCER | region (4*) |
| | 2 | STATE | rocky (5123) |
| | 3 | PARENT_CID | (cc 6*) |
| | Semantic (*20): Other regions have deep soil. | | |
| | 0 | VERB | have (541) |
| | 1 | EXPERIENCER | region (5*) |
| | 2 | CONTENT | deep soil (6*) |
| | 3 | PARENT_CID | (cc 6*) |

This is a very incomplete set of examples, but illustrates the general technique of conceptualization and the goals behind its processes.

### Neuron Relational Connectors (“Relns”)

The connections between normal neurons in the EBM are made though “relationals,” relns for short. Relns for other types of neurons (e.g., clump or ident neurons) have their special relns and are given other names such as roles for clump neurons. Each type of neuron has its own numbering sequence or (number space) for enumerating their relational connections.

This chapter focuses on a system of fundamental definitions that enable us to create concepts from relationships. To that end, we focus on getting the noun classes—basic “non-instance”—nouns in the system. Instances of nouns (see the sidebar) are not normally defined by the pre-training files. Rather, they are defined using normal training text files.

With suitable ending changes, many of the nouns can be used as adjectives, verbs and adverbs.

For example, information about “Gonzer” (my pet boa) is included as written English text, not as a noun entry in the pre-training files. That is, instances are not trained via words.txt, but via natural language text files.

In a similar way, the verbs share many of the same relationals but are augmented with usage information derived from “Predicate Argument Structure” (PAS).

Finally, the many structural words such as prepositions, conjunctions and the like are defined. The many word-type related specifics are kept in blocks of relational words (See “R_BLOCK,” below), recorded as a set of flag bits appropriate to the word type. In this way, space reserved in neurons for relational connections is supplanted at times to hold non-interconnection data.

### Background

The focus of the following subsections is on nouns, but the same general techniques apply to most other word forms.

At the most basic level, nouns are either abstract or concrete (non-abstract). That is, they are either generic or very specific. Instances of a generic concept are by definition concrete.

An instance of the “thought” class (which is abstract) would be “a thought”. In particular, it was Luke's thought at 5:01 AM in regards to a pesky mosquito that wouldn't stop buzzing in his ear.

Let us call that thought, Neuron ID: 4001. This neuron 4001, the “mosquito thought,” has an R_PARENT of “thought”. “Thought” would have a R_INSTANCE of 4001. “Thought” is likely have other R_CHILDREN, with these children likely have other R_CHILDREN. “A thought,” this particular instantiation of “thought” will have no R_CHILDREN.

Implicitly, this means this implies that a true instance cannot be itself instantiated. If there is an attempt to do so, it is a clear sign that a new class has been derived (e.g., via observation), and the pertinent information has to be moved from the former instance (what is now a new class) down to a lower instance! This dance will also occur with exceptions. Exceptions lead to new class observations, which will lead to cleaning up your tree and moving things around a bit.

So, an instance is always the lowest generation (ground) on any given tree branch, the bottom of the hierarchy. There could be multiple instances at the same ground level, but never instances of instances. All others generations are classes of information that help describe and categorize.

### Basic Noun Information

When we speak about defining nouns in words.txt, we are strictly speaking about better defining classes of nouns (concepts that are tied together with Parent-Child relationships). Aside from “noun-place-where” (NPWs), there does not appear to be any reference in our base noun definitions to any relationship except for hierarchical class. (I.e., they are non-instances.)

In defining noun classes, there are four major parental types:
Location (concrete)
Living (concrete)
Non-Living (concrete)
Abstract

These can be collapsed into two lineages:
Abstract
Concrete (non-abstract)

We will imply to their type of lineage when we refer to their ‘root’ or top.

Based on this simple break-down, we have a targeted and very select set of ways to define nouns. At issue is the implied relationships established by the ‘Reln’ connections. The intent is to consolidate these connections into categories that are readily understood.

One might say that all Reln types go into defining the concept. That is true, but the aim of this chapter is to find the minimum set of relationals needed for the pre-training word-info files. We seek the base categories for the generic/abstract word concepts which later “instances” of those concepts will tap into.

Relns for Nouns with Concrete Root: (Location, Living, Non-Living)

Relns needed in Words.txt to define concrete nouns include those from the following list:
R_PARENT, R_CHILD—Parental lineage
R_MADEOF—Composition (“car” made of “hood,” “engine,” “chassis”);
R_PARTOF—Next higher order grouping (“hood” as part of a “car”);
R_IDENTITY—Where applicable
R_PPROP—Physical properties and property restrictions
R_FUNC—Primary function (“transport)
R_NAT_ACT—Native action (“bark”)

Some of these may contain back-relns.

For Nouns with an Abstract Root
R_PARENT, R_CHILD—Parental lineage
R_PPROP_ORG—Back-reln to highest parent that owns the property.

Abstract nouns include physical properties such as wavelength, viscosity, intensity, etc.

Assigning something as an abstract or concrete root has significant philosophical connotation. Consider the Self, the Mind or Spirit, for example. Labeling them as not abstract, generic, indicates a belief that one can possess or have them. For many children, Santa Clause is not a concept or an idea, but is actually real flesh and blood; haven't you too seen him at the mall? Labeling these nouns with an abstract root therefore has considerable implications.

Back relns are not needed to define abstract nouns, and no special syntax needed in words.txt. They are created whenever a property is assigned.

For “viscosity,” the back reln helps to understand what the property applies to. Whether or not to update the current R_PPROP_ORG is based on its placement in a parent-child tree. If a more basic class where it is assigned, the R_PPROP_ORG reln gets updated.

For normal (conceptual) neurons, the relns are divided into two categories, those with weighted connections and those without weights. Each reln has an 8-bit field in its most significant bits (MSBs) that specifies the type of the reln; this is the Cmd field.

The fields of the neuron relation are as below:

| 8 bits | 1 | 23 bits |
|---|---|---|
| Cmd | A | Remainder of Reln |

The 24 non-command bits are normally composed of a neuron NID or clump CID, but may be allocated to other uses in some cases. If the lower 24 bits is a neuron or clump ID, it is split into an Adhoc flag and 23-bit neuron or clump serial number.

### Example Reln Types

Example relns are listed below. The entire 8-bit Cmd field is used in the enumeration. The enumeration value itself is not given because it changes from time to time.

| Reln Cmd Code | Usage | Usage of 24 LSBs |
|---|---|---|
| R_ASSOC | Association | NID is a neuron associated with this one.. For |
| | | example, the mud neuron may have an R_ASSOC |
| | | pointing to earth, and earth has an identical one |
| | | pointing back to mud. This reln is fully symmetric. It |
| | | acts as an alternative to actively-firing neurons. |
| | | See R_SPLIT for further information and usage. |
| R_BLOCK | Gamut (or | This reln indicates that a block of data will follow that |
| | other list) | is to be processed or ignored as a whole. (This |
| | follows as a | replaces the former R_GAMUT reln.) The bits 0 . . . 7 |
| | block of relns | are # elements; bits 8 . . . 15 are block type. For |
| | | example, the irregular verbs have a present tense, past |
| | | tense and past participle tense, and the three are laid |
| | | out as 3 elements of a block of type R_IRR. Each has |
| | | an R_IRR reln pointing back to the present-tense |
| | | form. |
| R_CAT | Category or | NID is the category name. Example, bird may have 3 |
| | grouping | R_CATs, one each to flying, non-flying and predatory. |
| | | Each of these categories is a complex derived from the |
| | | name, and can have attributes associated with it. The |
| | | back-rein of R_CAT_OF points from flying back to |
| | | bird, allowing bidirectional associations. |
| R_CAT_MEMB | Member of a | NID is child-member of the category, e.g., human is a |
| | category | member of the biped category. The NID of an |
| | | R_CAT_MEMB inside biped points to human, which |
| | | itself has an R_CAT_MEMB_OF pointing back to |
| | | biped. |
| R_CAT_MEMB_OF | Parental | NID is parent-like category I'm member of. See |
| | category | R_CAT_MEMB for an example. |
| R_CAT_OF | Back-reln to | NID is the item I'm a category of, e.g., biped has an |
| | R_CAT | R_CAT to animal, and animal has an R_CAT_OF |
| | | back to biped. |
| R_CPLX_NOUN | Back Reln for | NID is peanut of peanut butter. Normally, an |
| | Complex | adjective-noun pair creates a complex neuron with an |
| | | R_CDX pointing back to the adjective, such as in |
| | | “orange cat”. For noun-noun pairs such as “seat belt,” |
| | | the R_CDX_NOUN is used to indicate the noun seat |
| | | that is behaving as an adjective. |
| R_CHILD | Child | NID of my child (class). This sets the NID as a child |
| | | concept to the present (parent) neuron. For example, |
| | | if solar~system is the parent neuron, earth would be |
| | | the NID for an R_CHILD. |
| R_CLUMP | Action (from | CID links to a clump neuron. For “The cow jumped |
| | noun) | over the moon,” the cow neuron (the noun actor) |
| | | would contain an R_CLUMP pointing off to a clump |
| | | that describes the action. |
| | | This differs from R_VCLUMP in that an identical |
| | | clump CID would be pointed to by the jump (verb) |
| | | neuron to the same clump. That allows access to the |
| | | information either from the actor or the action side. |
| R_CNT_FLT | Absolute | This reln is used to specify large numbers as |
| | quantity | adjectives, e.g., “4.5 billion light-years away”. The |
| | | LSBs comprise a special 24-bit floating-point number |
| | | that permits very large numbers with 5 digits of |
| | | accuracy (precision). This permit memory of very |
| | | large numbers (e.g., billions), although it may not be |
| | | accurate to the digit. If the number is less than 8.3 |
| | | million, use the R_CNT_INT command instead. |

The preceding Table is a sampling of the 100-odd relns that comprise those for conceptual neurons (Nids) in the EBM.

### Reln Detail Example: Parental Inheritance (Lineage)—R_Parent

Nouns have a parental lineage to one of the following concepts:
Location (concrete)
Living (concrete)
Non-Living (concrete)
Abstract

Examples: “Psychology” would tie back to abstract through its parental lineage. The generations it takes to tie it back is not the issue. Somewhere along the parental lineage, we will run into one of the 4 main noun categories. Mt. Rushmore would tie back to location, a human or a virus would tie back to living and a lamp would tie back to non-living.

### Reln Detail Example: Composition—R_MADEOF

Nouns are composed of other things. A #2 pencil is made of lead, wood, metal and rubber. This provides additional information on the noun. It is wise to use the next level of complexity when defining what something is made of. These “made ofs” can be broken down into the things they are made of in their neuron. A human is best defined as being made of a Spirit, Mind, and a human body. These are the next lower order of grouping. The human body would be broken down into its “made ofs”.

Note: Possession is a translation of the MADE_OFS of a neuron that has an identity or life parental lineage. A chair is made of an arm(s) and leg(s), but a human body is not said to be made of 2 arms, it is said to “have” 2 arms. This is merely an identity translation issue. If the noun has an identity or a living parental lineage, we generally change our “made ofs” to “possesses”. It should be stored the same.

### Reln Detail Example: Color—R_HSI

### Format: “hsi (<0-360>, <0-100>, <0-100>)

This is the property of color is defined as Hue, Saturation and Intensity (Intensity sometimes called brightness, for reflective surfaces). It is actually used only inside a properties R_BLOCK. FIG. 26 depicts the definitions for each of the three parameters. HSI has been selected over RGB expression of color so that tint can be changed without effecting brightness, and visa-versa.

Hue is expressed in degrees of ‘rotation’ and is defined in such a way that incrementing past 360° simply wraps the color around smoothly. For example, at both 0° and 360°, the only RGB color showing is red.

FIG. 26 shows the proportions of each primary color added together to produce the actual tint specified by Hue. In the regions marked 100%, the indicated color (red, blue or green) is turned on at 100%. At each side of the 100% region, intensity falls off uniformly to zero over a 60° range. Adding up the three-color contributions specified for each color ‘angle’ produces the hue given in the top row.

Saturation is a measure of how much of the overall color tint is diluted by white light (illustrated in FIG. 27). A ‘fully saturated’ (100%) tint is undiluted by white light. White light is added simply by adding equal intensities of all 3 primary colors to the overall color mix. Adding equal amounts does not affect the tint at all, but only the ‘saturation’ of the color. (Adding white color to any tint produces a ‘pastel’ color.)

Intensity is a measure of the total amount of light being produced at the given tint and saturation (FIG. 28). If Intensity is zero, no light is being emitted and the object in question is simply black.

Example: hsi (309, 38, 97) produces a color of a purple-like hue.

This tint shows the purple-like hue of 309°, has 62% white light added (saturation=39%), and has an overall intensity of the 97% of full intensity. This shows that a little color goes a long way when added to pure white, when you compare the color with that in FIG. 27.

### Reln Detail Example: Primary Function—R_FUNC

Primary function is a critical tie in to a verb on the existing hierarchy. All nouns that have a primary function that tie into one, or more, of the following verb-related lineage:
Transport
Contain
Communicate
Cover
Destroy
Create
Increase
Decrease

All nouns fall into one or more of these boxes. The labels may differ in the literature, but the categorization system is generally similar.

### Summary

Each reln connection type is a member of a bounded set defined to be fundamental information. Representations of other connection types not so defined can be specified by a “double reln,” a connection requiring two associated reln slots. Using this system, the reln types can be viewed in a hierarchical fashion or by sibling or non-structural relationships. It is a very flexible system.

### Clump Relational Connectors (“Roles”)

The relational connection in the verb-based semantic clump neurons are internally called “roles” rather than “relns” for reasons of clarity for the linguists. They function in an essentially identical manner to the connection relns of all other neuron types; that is, they form a connection between the clump neuron and other neurons in the system. In a similar manner, the lower 24 bits are sometimes preempted to hold suitable non-ID binary data for certain purposes.

The fields of the clump roles are as below:

| 8 bits | 1 | 23 bits |
|---|---|---|
| Role Type | A | Remainder of Role |

The 24 non-command bits are normally composed of a neuron NID or clump CID, but may be allocated to other uses in some cases. If the lower 24 bits is a neuron or clump ID, it is split into an Adhoc flag and 23-bit neuron or clump serial number.

The role types include the following sample (and others). The subset of roles includes:
Addition
Degree
Duration
Exception
Goal
Manner
Reason
Theme
Time
World View
Accompaniment
Actor
Behalf
Compare
Counteragent
Degree
Duration
Effect
Experiencer
Goal
Habituation
Instrument
Locate
Manner
Path
Proximity
Reason
State
Source
Theme
Time

Separate role sets similar to this one are given for each of the clump sub-types described in the next section.

### Other Clump Sub-Types

Other types of clumps are defined and used besides the normal “semantic” clump (SC). The whole list includes:
Semantic Clumps (SC)—Semantic clump built around a verb
Controller Clumps (CC)—Paragraph-level coordination clump. Maintains connections to semantic clumps that constitute parts of a paragraph, as well as a SC summary sentence for the paragraph. Hierarchical in their usage, they are also used to coordinate pairs of semantic statements such as “A but not B.”
Outline Clumps (OC)—Integrates controller clumps and experiences for the tracking of an outline for a text, topic or experience. They hold roll-up summaries of lower-level information at every level, such that the lower-level clumps can be safely deleted if they have relatively little long-term value.

Each of these clump types has its own enumeration of relns that apply to it.

### Volition in the EBM

Volition is a subsystem that orchestrates most of the thought-like processes. It operates under its own thread of execution and handles (or uses) the following general areas of operation:
Post-Conceptualization Steps—Big-picture cleanup of created clumps and neurons
Fonx—Mid-level subsystem that expresses clumps in sentences of the proper voice
Monologue—A system to explore and describe a single concept (a “book-writer”)

Dialogue—Handling of two-way agent-user dialogue or discussion
Clump Summary—The roll-up of sentences into topic-based summarized paragraphs
Fielding Questions—Answering who/what/when/where/why/how/what manner/confirm questions
Asking Questions—Feedback to the user to clarify missing information or satisfy curiosity
Deduction, inference and conjecture processes, expressed as musings
Firing of Emotion—Inciting emotions based on outcome of interactive experience
Explicit emotional content—Interception of emotional content and implications
Emotional word connotations—Handling emotion-specific words applied personally
Awareness and Expectation—Handling next-step anticipations and emotional expectation

Volition also handles a number of other sub-processes that relate directly or indirectly to though and experience and their emotional consequences. (Each of the above areas is discussed in detail elsewhere, often with a whole dedicated chapter.)

### Post-Conceptualization Processes

The Volition processes that follow conceptualization generally have a bigger picture of context than parsing and conceptualization does. Therefore, upon exit from conceptualization, Volition takes some of the following steps:
Based on contextual information available to Volition, it is in a position to simplify many of the clumps and neurons resulting from the Conceptualizer. Certain optimization steps are therefore performed on them to better represent the knowledge. In some cases, this involves the elimination of just-created neuron complexes.
Some information is static in nature and has no time (verb) dependencies, e.g., “This yard is certainly cluttered!” This is particularly true for definitive or descriptive information. For these cases, a 7-word clump can be replaced by a single-word relational connection judiciously placed in an existing neuron. Again, the original clump neuron can be eliminated (following the roll-up processes of Step 0 below.
The clump is effectively the embodiment of an independent clause or sentence, but is part of a paragraph. Therefore, upon a topic change, the current paragraph will be summarized and the summary attached to the controller clump that manages the paragraph. That controller clump (CC) will then be closed and another one opened. Some time later (e.g., 21 days or so), the above (semantic) clumps will be reviewed for their usefulness and will be deleted from the system. The summary clumps will be retained in the controller, however. The controller may subsequently be down-sized when it is later reviewed, and those (paragraph) summaries merged into a higher controller.
Inference is applied to the clump(s) just generated to possibly infer new information—as yet new clumps—from the just-parsed sentence.
Where temperament and behavioral settings permit, Step 0 is repeated until behavior-dependent iterations have been performed or nothing new can be inferred.

In this way, the clumps and neurons created here may well disappear after they have served their usefulness to the brain. Only the topical and content summaries will remain but the low-level detail of low worth will be discarded and forgotten.

### The Management of Volition

Volition is managed as a separate thread of execution that fields “events” initiated both by other process threads and during portions of its own operation. These events are pending interruptions of the current process flow and are handled on a first-come, first-serve basis.

Example events include:
Completion of a parse operation
Recognition of context or related juxtaposition of concepts in the source sentence
Timeout of expectations—E.g., A question was asked of the speaker and an answer hasn't been received within 2.5 seconds.
Expectations—E.g., My friend returned from his Dallas trip and I expect him to tell me about it.
Internal Inconsistencies—Something occurred during interaction that was inconsistent with expectations

Volition is a reasonably complex set of processes that cannot be defined in a simplistic “We do it this way” manner. Even so, as a reentrant process, it is able to handle these in an understandable manner. The sections that follow attempt to convey overall processes, many of which are under the control of process neurons, a specific application/usage of ordinary conceptual neurons as described elsewhere

### Operational Flow

Volition is an implemented as a separate thread of execution. It is a repetitive loop that operates as long as there are unprocessed events to work on and (and then goes idle).

### Volition—the Handling of Monologue

“Monologue” is a sub-system that expounds on a specific concept. It is capable of writing a text on a subject, to the extent that it has enough training and background material to work with.

The overall method used writes an outline on the topic and then expands on the outline. It can perform the outlining on the areas of expansion, too. It follows the general rules of monologue:
Say what you're going to say. (the introduction/outline)
Say it. (the body)
Tell them what you've said. (summary)

The basic tool for directing the above is an analysis of the types of relational connections made between neurons. Certain types of connections are most applicable for each portion of the monologue, making the above sequence readily handled.

When a user asks the EBM to explore a subject, the EBM sets the subject as the Topic Nid. From that Nid it gathers a wealth of knowledge and describes it to the reader in a systematic manner.

### Capturing Meaningful Relns

Use the context to capture appropriate Nids immediately within the topic Nid. Then cull through them to find more Nids. Consider doing this for seemingly irrelevant Nids in Topic Nid because they might lead to relevant ones further down the line.

Any direct match (between context and within Topic Nid) gets a score of 1.0, whereas the score decreases depending on how far you have to go to find relevant Nids. Each time an Nid is put into a link, the relationship between it and the previous word are also recorded.

For example, we want to remember that “Earth” is R_MADEOF “core.” After putting all of these into a content list, sort them by relns. We should then have groups of R_MADEOFs, R_CHILD, R_CAT_MEMB_OF, etc. They will be in order of their score (already established through a search). (We might want these groups of relns to be within separate links)

Scan through each reln type and look for two things: amount of content and score. If the score is 1.0, the nid on the end of that reln has just become a sub-topic. If the score is lower than 1.0, but this pool has a considerable amount of content, we will want to talk about it anyway—because we can.

### Automation of the Reln Capture

The meaning of a neuron is defined by its relational connections. For each facet of monologue, a different set of relns is appropriate, some of them overlapping. For example, relns drawn from for the topical introduction paragraph and summary paragraphs differ from those used in the body of text developed to describe the topic. It is desirable to therefore have a means of prioritizing which relns are most useful and which should not be drawn on at all.

It turns out that the topic (introduction) paragraph needs to draw on several sets of desirable reln types, one to produce the overall outline to follow and one to develop the introductory statements from.

To implement the above process in a reasonably automated manner, a two-dimensional table of relns was created. Along the left axis is a list of all reln types (i.e., their enumerations). Along the top axis is a set of columns according to purpose. Each column includes a list of weights to ascribe to each enumerated type.

For example, for topical purposes we may value category membership over instance references. In the body text, the instances may get more weight. Only those relns over a specific threshold are included as the basis for textual output.

The text is formed in sequence for the introductory paragraph, in which we tell what we are going to say. The content is determined entirely by relns selected from the topic Nid—and its synonyms in some cases. The body is then formed from other relns selected from Nids by worth defined in the above table. Finally, the summary paragraph is formed from yet other reln types.

### Sentence Formation

Based on the above table, relns are “culled” into holding pools so they can be evaluated for merit. Some reln types are capable of defining hierarchical relationships (e.g., PARENT, CHILD, CAT, CAT OF), and these are used to advantage.

“Culling” is an internal process wherein parental-like relational connections (only) are followed up the hierarchy for some defined distance, often 2-20 generations. The worth of the neuron found at each successive generation is scaled to be less and less, giving a net worth to each neuron that is based on generational distance an on connection type as derived from the above table.

After culling for related concepts this way, those below a certain worth are not used to generate text. (They are often used, though, when the human wants to know more on the same topic.) All of this culling and worth-setting is done in Nid context pool.

Finally, sentences are formed on the basis of reln type. Two methods have been tried for this with different results: Formation of clump neurons expressed via Fonx, and intelligent fragment creation. The latter produces better results, where sentences are formed from lexical fragments driven by relational content.

For example, different relns yield different types of information, shown in the very partial list shown here:

```
R_IMPLIES
        “, which implies %s”
        “, implying %s”
R_NAME_OF/ R_IDENTITY
        “- %s -“
        “, or %s”
        “, %s that is,”
R_GRP_MEMB /R_CHILD
        “, %s for instance,”
        “, like %s”
R_GRP
        “- some of which are %s -“
R_GRP_OF
    a. “ (a %s)”
R_CAT_OF
        “, a type of which is %s”
        “, %s for example”
        “, which can be grouped into %s, “
R_CAT_MEMB
        “, which includes %s ”
R_NAT_ACT
        “, which %s”
R_POSSN_OF
        “ - owned by %s -“
R_CHILD
        “, such as %s ”
        “ - like %s ”
R_VAR_OF
        “ - which affects %s”
R_VAR
        “ - affected by %s - “
R_UNITS_OF
        “, which is a unit of %s”
R_CAUSES
        “, which causes %s,”
```

The same methods are applied to both noun and verb concepts. With these are an appropriately mixed set of clump (action) neuron references, defining non-static knowledge derived from previously parsed text. In the same way that neurons are culled and weighted, the clumps are similarly weighted by content before their inclusion as a part of the displayed knowledge set.

### Volition—the Handling of Dialogue

In the EBM, dialogue and volition (free will) are intertwined, together serving to control overall operations within the brain. They are implemented as an independent thread and use the parser, analyzer, speech construction (“Fonx”) and other constituent blocks of the brain as tools and systems that are subservient to volition.

Communications with other people has many facets, several of which are:
Monologue—One-sided conversation with another person, generally to inform or educate. It us used to relate knowledge, opinion and feelings to another person.
Dialogue—Two-sided conversation with one or more people. It involves making assertions or statements, and asking or answering questions. The nature of questions is that the may both be asked and may be fielded (answered).

In this document, both monologue and dialog are included under the general heading of discussion, and presume underlying volition, free will. In actual fact perhaps 8 separate types of dialogue are initially defined and supported, including formalized debate.

### Some Drivers of Discussion

Were there nothing to drive discussion, the brain would largely sit silently. Things such as physical or emotional needs, expectations, experience, external events and the occurrence of timing-driven events serve as drivers for discussion.

Discussion is handled by an independent thread of control within the computer or brain. It largely sits idle, waiting for something to do. In the EBM, the idle condition is interrupted by certain events or conditions internal or external to the brain. The thread then conducts activity that carries out some aspect of volition and then returns idle.

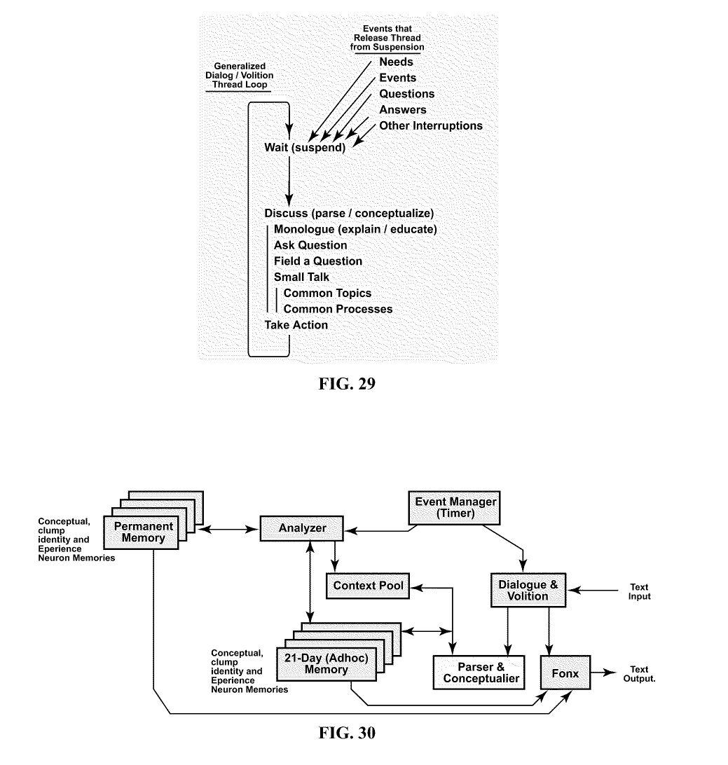

FIG. 29 illustrates a generalized volition-and-discussion thread. It does not consider all possibilities, but gives an idea of the general flow of control.

FIG. 29 shows a repeated loop in which there is a wait point, at which the process stops to await the external condition, event or other interruption. Once so released, the thread handles the issues it is presented with, then returning idle.

### The Place of Discussion in the Larger System Picture

It is helpful to place the discussion operational block into the context of the larger systems picture of the brain. FIG. 29 shows general layout of the EBM system, and the position of the Dialogue and Volition block within it.

Referring now to FIG. 30, all text input and output travels through the volition handler in some manner. When incoming text or words need to be parsed, they are sent off to the Parser/Conceptualizer block for handling. Similarly, most of the sentence text to be generated is passed off to the Fonx block for the formation of the sentences.

### Flow of Parse and Conceptualization

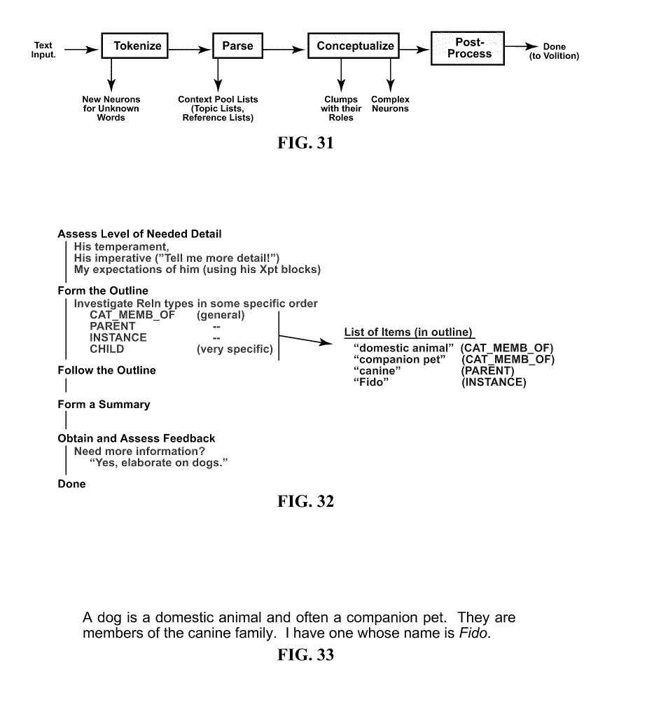

The parser/conceptualizer is treated as a controllable subsystem by the discussion logic. The general flow of parsing and conceptualization is shown in FIG. 31. It takes text in as words or sentences and produces various outputs along the way.

Some of the more important intermediate outputs of blocks in FIG. 31 are the new neurons created for presently-unknown words. The same neurons will be referenced when those words are again encountered later. The context pool lists partially establish current history while the clump(s) are the main output.

### Creation of Monologue (Educational Content)

The monologue form of discussion is one-sided conversation for the purpose of describing an object, a position or to convey other knowledge.

The general form of monologue includes the following traditional steps:
Outline what you are going to say.
Say it.
Summarize what you just said.

The same process is applied whether we are speaking a paragraph, a short paper or a treatise or book. At each level, whether it be upper synopsis, chapters, sections, pages or paragraphs, the same general mechanism is applied.

The above process is therefore suitable for recursively refining and detailing the content of the monologue. Regardless of the topic of discussion, it is possible to start anywhere within the neural memory structure and effectively write a treatise on any topic.

Methods are given in the next section to establish how much information we will create. We are limited in our ability to discuss a subject only by the amount of material we have available. FIG. 32 shows the detailed flow of the internal process of monologue.

The level of detail to be given is based upon intent and other factors, some of which are given above in red. Generally speaking, the level of detail and quantity of information are readily controlled by restricting how far we go in our search for related neurons, such as how far up the parental lineage chain we go (if there is one!)

Topical content for the initial outline of what to speak about is obtained by looking at relns that connect to the base topic. It is known that certain relns connect to very general information, while others point to either generic or very specific types. Top-level outlines pull neuron IDs (NIDs) from relns on the topic neuron by order of type and save them in a list. This list is then used as the outline.

At each stage of the monologue, lists can be used with the Fonx subsystem to create sentences on the topic items. These sentences communicate specific types of information about the NIDs based upon the type of the reln used to connect them.

Consider the outline paragraph illustrated in FIG. 33 produced from the dog neuron. Using the above monologue technique, the above example is very easy to obtain.

Noted in FIG. 32, some items appearing in the paragraph were obtained in the following ways:
“domestic animal” came from a CAT_MEMB_OF reln.
“companion pet” came from a CAT_MEMB_OF reln.
“canine” came from a PARENT reln.
“Fido” came from an INSTANCE reln.

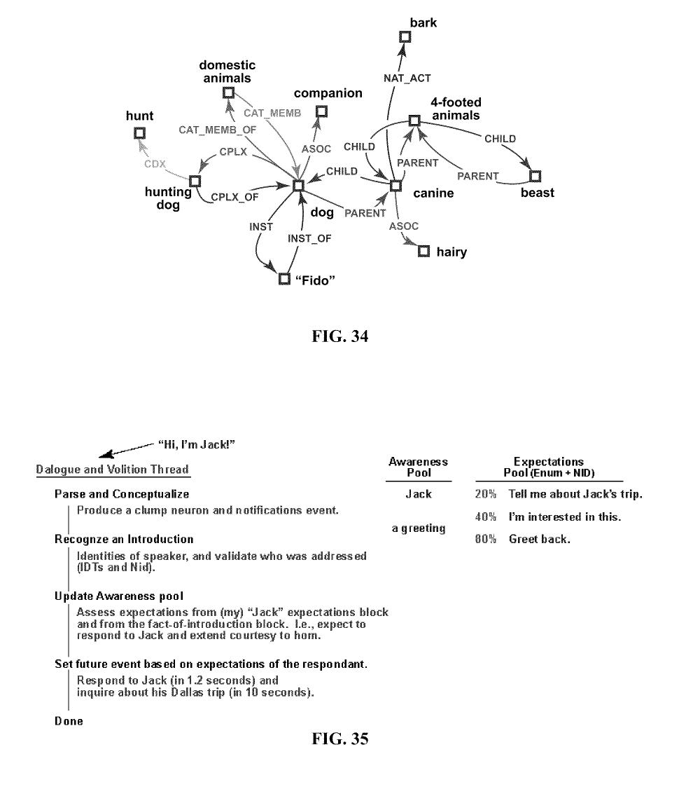

The neuron data used to obtain the above paragraph is given in FIG. 34. It shows the relationships between the various neurons that could be referenced during the above culls, showing that not all were included.

Extended scans for other reln types yield different (or additional) neurons for inclusion in the summary.

### The Dialogue of Personal Introduction

The general content of the volition and dialogue thread was illustrated in FIG. 29. The thread is normally suspended, awaiting an interruption by some external condition or event. When released to operate, what s performed is a function of those external conditions or events. One such event is the awareness of a personal introduction just given, such as, “Hi, I'm Jack!”

The fact that an introduction was just volunteered by the other speaker (the “respondent”) is discovered by the parser, and an event is issued for the situation. This process is shown in FIG. 35.

Some of the above expectation pool entries would not occur unless (I) had known that Jack was going to Dallas. (I) think he's cool and is up-building to me as a friend.

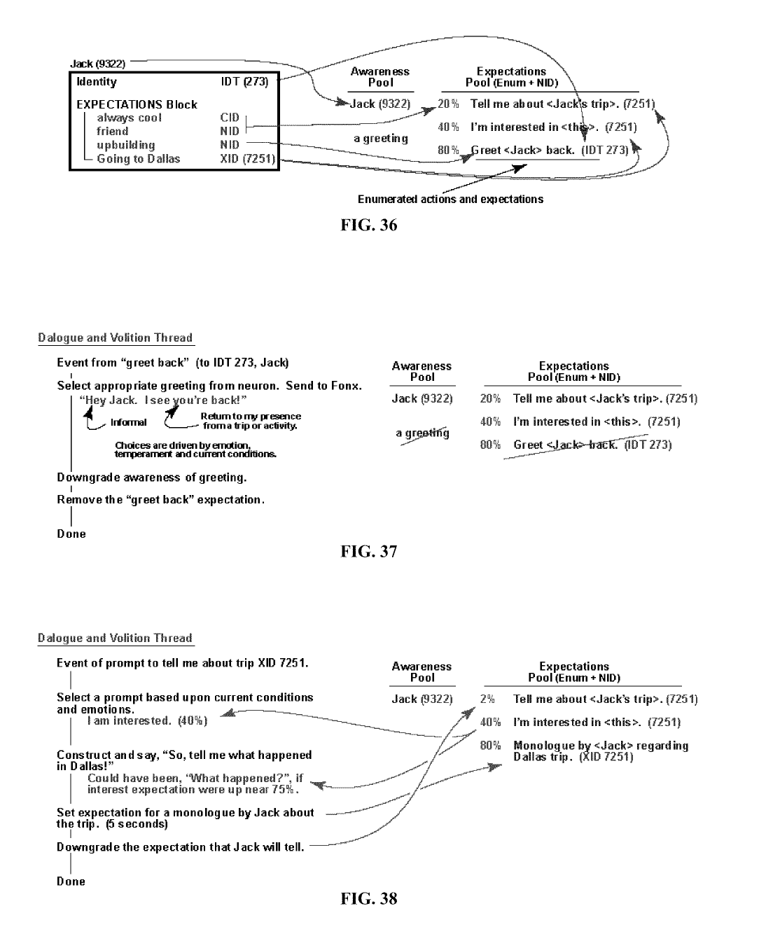

For me (as the brain), this sets certain expectations of Jack, and they come into play when I become aware of Jack's greeting. FIG. 36 shows the Jack neuron and fact that it contains an expectations block presently consisting of 4 relns. From this block is derived the some of the information inserted into the Expectations pool.

The primary content of both the Awareness and Expectations pools are an enumeration that indicates an activity or indicator primitive and some form of a neuron ID, regardless of the type of neuron referenced. One other item in each pool entry is a worth indicator.

### Text Generation

When the Fonx subsystem is invoked to generate an appropriate sentence, it uses the enumeration and neuron IDs as the basis for the process, as well as its recent history of the conversation. It chooses the appropriate words to convey the intended concepts and action.

### Selection of Greeting

The second phase of the above greeting process is to select a method of greeting and the content of the interchange. This is initiated in the volition thread by the “greet-back” event triggered previously (above). This event type selects an appropriate method and text of greeting, based what (this) brain is familiar and comfortable with. Alternative forms of expression are selected from a my-greeting-response neuron. The flow, action and choices for this are depicted in FIG. 37.

This process includes down-grading or removing items from both the Awareness and Expectations pools, as indicated in FIG. 37.

### Prompt to Initiate Monologue

An event was previously issued to have Jack tell about the trip. When the specified time has elapsed, the event will prompt the volition loop to have Jack explore what happened on the trip. FIG. 38 illustrates this portion of the interchange.

The selection of prompt method is dependent upon present conditions and emotion, including our interest in hearing the details. The particular sequence of the interaction is based upon the enumerated expectations in the Expectations pool.

The state of the Awareness and Expectations pools has been updated based on flow given in FIG. 37. The arrows depict factors that entered into the decision flow of this particular case.

A similar process to this is used for almost any form of dialogue. The process is initiated by external events or conditions, many/most of which were initiated at the same time the Awareness pool entry was made. The enumerations of the two pools define the task to be accomplished in the volition loop, and the choices made while carrying them out are affected by current conditions, emotions and temperament.

### Volition—Inference

“Inference” is a generalized area that includes various forms of deduction and inference. It is applied in a number of places, but specifically following the parsing of a sentence and during the answering of questions (particularly how and why questions).

Deduction acts on known facts, where all the information is present but perhaps not in a convenient form. Inference takes existing facts and attempts to draw a conclusion from them. It may be considered a form of conjecture that says, “I don't have all the facts. But if I did, what would they look like?”

Inference is also necessary for the isolation of intent. If someone says or acts in a certain manner, there is no way to know for certain why he did that, sort of directly asking a question. In the meantime, there is nothing that can be done but to infer information based on what is known.

Inference is a repetitive process controlled by personality and current emotional conditions. It considers many aspects:
Cause-and-Effect—“If you do this then that will happen.”
Emotional Aspects—Encouragement, insult, affirmation and many other emotions or mental states are effected by the outcome of inference, so they are part of the inference process.
Pattern Matching—Clump neurons have a very regular aspect to them that can be matched against other references to the same subject/topic to find likely outcomes.
Role Matching—Certain concept-role pairs across multiple clump neurons exist that imply an outcome that is usually defined in one of the clumps.
Emotional Connotations—Some 3000 words in English have emotional connotations of themselves. When applied to the listener, they can evoke specific emotions or (separately) mental states.

Both heuristic-based and genetic algorithm based methods are used in inference. The outcome of inference is one or more clumps, or new relational connections between existing neurons.

### Deduction

At many points in the system, deduction is required. For example, antecedents for certain words as this, other, area and location need to be fully resolved, disambiguated. In the EBM, this is called “context resolution.” This uses deduction and topic-tracking Deduction uses currently-known information to directly derive new information.

### Inference

Inference is similar to an educated conjecture and is often based on distantly-removed information. Several systems of inference are used, and it is use at several key places in the system. Inference is applied after each sentence is taken in, parsed and “conceptualized” into neurons. It also take place when questions are being asked, whether the questions are asked by the user or by some part of volition such as curiosity handling.

Three basic types of inference are involved.
Conditional statements such as, “I'll consider taking my umbrella if it's raining,” indicates an action (“I'll take my umbrella”) that may occur under an explicit condition. One may reasonably then infer that it is raining if I have my umbrella, but that is really conjecture. You cannot possibly know why I brought my umbrella unless you read my mind or directly ask me, though confidence may be high in any conjecture that it is raining. This direct form of inference is readily performed on cause-effect relationships using the EBM system layout.
Another form of inference used in this brain is close to deduction. Statements of state or opinion are conceptualized into a specific form of relational inter-connects. Some types of inferred information can be expressed in another specific form. Hard logic matches the form of the knowledge in both cases and can trigger creation of new information. This is used, for example, when you tell me, “I think blue shirts are ugly,” and later observe, “I see you are wearing a blue shirt.” Successively applied inference, tells me the following: “My (blue) shirt is ugly,” and, “I was just insulted.” (The insult is inferred from the “my shirt” possessive and from the negative connotations of ugly.) Left unanswered is the inference of why did my friend just insult me. That takes another step that correlates between the topics of inference and knowledge from my friend's profile. (Is he a clothing salesman, a jerk, gregarious, or just in a bad mood? All of these bear on the strongest inference solution.)
Finally, in a derivative of the knowledge-form matching (for input and inference results), a set of heuristics driven by an off-line Genetic Algorithm (GA) are run. These GA heuristics are embodied by a set of byte codes run on a machine-within-the-machine, much like Java programs run on a Java interpreter. The outputs of the GA runtime are zero or more new neural-like constructs equivalent to parsed sentences. These add to the existing knowledge base and may include a confidence level in the inference.

It should be noted that each external speaker has a veracity indicator as a part of his personality profile. When his veracity is relatively low—or when the brain is in a cranky mood—connection-based “knowledge” derived from parsing his sentences is flagged as being his world view. Statements derived from his world view can later be discarded or weighted lower during subsequent inference. Normal training text is assumed to come “from God”; being wholly believable it is not so marked.

### Volition—the Fielding of Questions

The overall purpose of asking questions is to either obtain information or to confirm the truth of a statement. The commentary on field of questions applies in reverse to obtaining information from the human (or other EBM/agent), so as to properly elucidate the outbound question to be posed.

Questions fall into one of the general categories of who, what, what, when, where, why, how, what manner and confirmation. The methods to field these differs, with the questions falling into three basic categories:
who, what, what, when, where and what manner
confirmation
why and how, and some variants of where and when

The basic responses for the first set can readily be determined by the relational connections between neurons. Most of these deal with state of existence—cold facts—and the basic issue is simply how to organize their expression to the listener.

The confirmation question demands a validation of facts and is accomplished by matching certain types of relational connections between neurons and by the matching of roles in related clump neurons.

The third class of question has seven sub-divisions of type, organized into two basic groups:
Inspection and cross-matching between cause-effect relationships in clump neurons. This may come from neurons and clumps previously created by inference at post-conceptualization time in the Volition system.
Use of explicit inference that infers from relational material in the question itself and between clumps or neurons related to the content of the question.

Handling the question involves first isolating the relevant information and then forming it into cohesive clumps for expression by the fonx or Monologue subsystems.

### Purposes for a Question

Questions may be of the variety expecting a yes/no response, or are seeking some type of information.

### The Yes/No Questions

These generally begin with a verb (to be, have, do or a modal verb) and require a single word or a very brief response. Example: “Are you coming tomorrow?” A direct answer (yes or no) indicates a commitment to the question's premises and propositions.

These questions start with any of the following: do, can, has, did, is, was

They also have a subject and a main verb. Examples:
Do you want dinner?
An you drive to the store?
Has she finished her work?
Did they drive home?
Is Romney presidential material?
Was Jim at home?

In each case, the expected (direct) answer is yes or no, but may be followed by a confirmation.

### The WH Questions

The WH questions begin with an interrogative word (who, what, were, why, when, how). They can be viewed to be information questions, because they ask the responder to provide particulars.

The purpose for questions of the W-H type are as follows:
Data-Recall Question—Requires the respondent to remember facts. For example, “What are the four rules about numbers?” The expected answer does include anything about how to use the information.
Naming Question—Asks the respondent simply to name an event, process, phenomenon etc. Example, “What do we call the set of bones which cover the lungs?” The expected answer is brief and should not show insight into how the event is linked to other factors.
Observation Question—Asks respondents to describe what they see. Example, “What happened when we added salt to boiling water?” The expected answer does not attempt to explain it.
Control Question—Involves the use of questions to modify respondent's behavior rather than their knowledge. Example, “Will you sit down, Sam?”
The Pseudo-Question—The question is constructed to appear that the speaker will accept more than one response, but in fact he has clearly made up his mind that this is not so. Example, “Do you feel involving in violence was a good thing, then?” The expected answer may be lengthy general information.
Speculative or Hypothesis-Generating Question—Asks respondents to speculate about the outcome of a hypothetical situation. “Imagine that global warming actually exists. What could be the cause of it?” The expected answer may be lengthy information.
Reason or Analysis Question—Ask respondents to give reason(s) why certain things do or do not happen. Example, “What motivates some young people to get involved in drug abuse?” The expected answer may be lengthy information.
Evaluation Question—Is one that makes a respondent weigh out the pros and cons of a situation or argument. Example, “How much evidence is there for the existence of an after-life?” The expected answer may be either a list or a lengthy discussion.
Problem-Solving Question—Asks respondents to construct ways of finding out answers to questions. Example, “Suppose we wanted to discover what prompts birds to migrate. How could we go about it?” The expected answer may be lengthy information.

The analysis of the above alternatives can often be based upon the structure of the question, but may require additional information, such as present context and mood of the discussion.

### Alternative Styles of Questions

Indirect Question—May be given as an imperative, or imply a question. It may also be couched in a modal. Examples:
“I wonder where he is.”
“Would you please tell me how to fly to the moon?”
The Tag Question—Makes a statement and asks for confirmation. Examples:
“You crave dog food, don't you?”
“Chicago is located in Paraguay, isn't it?”

This has been a brief summary of the handling of questions. It is controlled overall by the Volition process. These processes are often initiated indirectly from the parser system, wherein it sends an event to Volition indicating the question being asked.

### Volition—Analysis of Dialogue Processes

Some of the information in this document was gleaned from: “Informal Logic, by Douglas Walton (9-78052137925-0). Walton can reasonably be considered authoritative in the area of dialogue and debate, and many of the approaches to dialogue used by the EBM derive from his publications.

### General Remarks on Dialogue

In dialogue, both parties have an obligation to work towards fulfilling their own goals, and to cooperate with the other party's fulfillment of his goals. A “bad argument” is a failure of either party to meet one of these obligations.

In a discussion, dialogue or monologue, the speaker makes assertions or asks questions. Knowledge or assertions may be contained in either type of statement. The assertions made may be accurate or false; the speaker may be trusted or not. The listener internally accepts or rejects each such assertion, generally on a case-by-case basis. This happens whether the parties are engaged in formal (forensic) debate or a friendly discussion.

Internally, the speaker's brain must track each assertion he has made and each underlying premise he has used, and whether or not each was accepted or rejected by the other party. This acceptance or rejection plays a large role in the flow of the discussion or debate. Several rules of thumb in dialogue are:
He who asserts something must prove it.
In casual conversation, if a premise does not have direct bearing on the issue, perhaps let it slide.

These are more strictly required in informal logic (referred debate) but are a rule of thumb to be observed in any discussion. Structures in the “dialog pool” (associated with process neuron usage) are defined to track these items.

### Threads of Content

Some general considerations for the content of dialogue include:
Sympathetic appreciation of context (context list)
Sorted-out main line of argument from the verbiage (argument topic list)
Weighting of strong and weak points of an argument (argument points list)
Evidence behind the claim(s) (Evidence list)
Identification of conclusion (Conclusions list)
Questioning of claims based on expert knowledge (a list)
Items of vagueness and ambiguity (Ambiguity list)
The unstated parts of the argument, for probing (Probe list)
Arguer's position and commitments stated by the evidence (Commitment list)
Argument's thesis (a list)
Assessment of argument: Weak, erroneous, fallacious
If assessment is not strong, evidence needed to justify the positions (a list)

The items in parenthesis are specific elements tracked in the dialogue process pools.

### Context

All dialogue happens within a given context, which one normally accepts with little thought. The context contains information such as “Who the audience is,” “Where and when the dialogue takes place,” and “What the dialogue is about.” This information provides necessary clues about how the dialogue will ensue. It is necessary to refine the context throughout a dialogue, as its elements may change over time. The speakers might move to another location, or another person may join the conversation, and the topic will evolve as the discussion progresses. Subsequent chapters will explain how context is formed, as well as how context affects dialogue, personality, and strategy.

### Creation of Premises and Propositions

Premises are underlying assumptions that are implicit in any assertion made; it may be implied but not directly stated. Premises exist for both questions and general statements.

On the other hand, propositions are assertions that the speaker makes to the other party, and these are normally an explicit part of a question or statement. Like the underlying premises, propositions (which may be about—or be—the premises) are either accepted or rejected by the listener.

For example, the listener is asked a question on an issue. If he gives a “direct” answer (rather than objecting to the content or format of the question, he is assumed to have accepted both the premises and propositions involved. He may reject either by objecting to some element of the question rather than by giving a direct answer. Accepting the proposition or premise is called a commitment in this document.

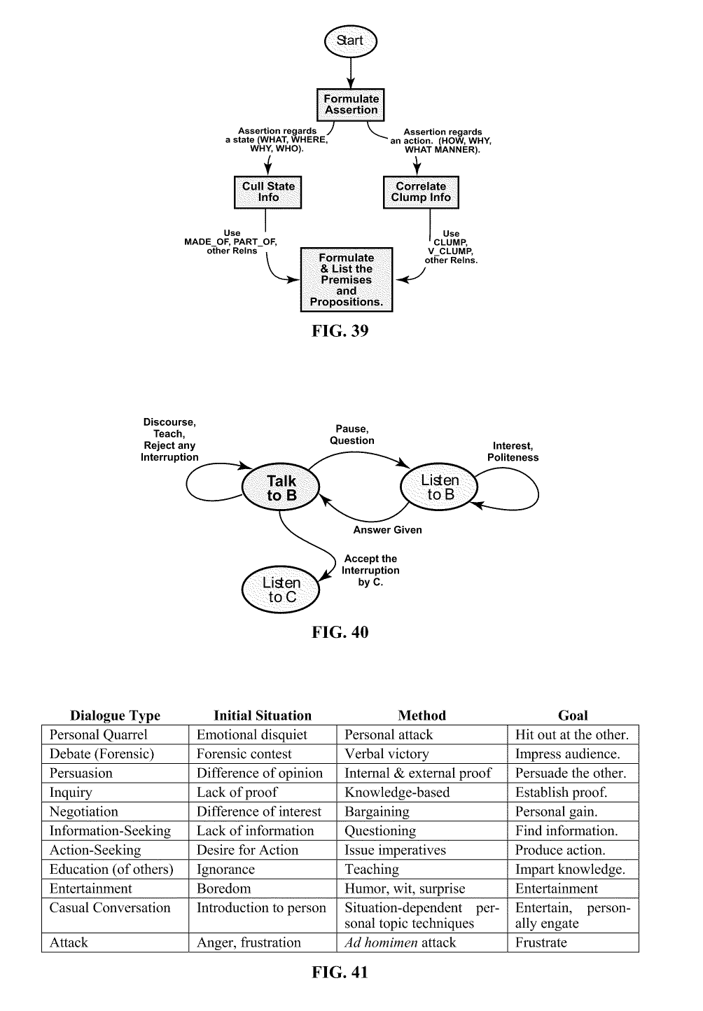

FIG. 39 shows recovery of information contained in the premises and propositions (assertions). The process may be iterative and usually starts from topic or sub-topic items emerging during the process.

The dialogue or monologue may be in response to a question or observation on a topic, or may be for purposes of educating the other person (often called respondent, here). It may also derive from personal need, i.e., by the needs-based areas of the brain.

### Generalized Flow of Discussion

Before the premises are examined, the context must be formed (or refined if the premise is embedded).
Form or refine dialogue context
Form or refine strategy
Anticipate or refine rules

Once these steps are accomplished, proceed to examine the premise or proposition.

A general flow to set up the premises and proposition is:
Accept or otherwise determine the topic or sub-topic
Discover whether the premise is allowed (check rules and topic)
Accept a relevant condition or action relating to the topic.
For actions, lookup is usually based on clumps
For state, lookup is usually based on neurons and relns
Cull the above sources for information
Form the premise or proposition list(s)

Both the premises and propositions are formed as linked lists, and each has a status flag that defines whether or not the respondent has accepted it.

### Assessment of Feedback Information

Much of the flow of discussion (whether dialogue or monologue) is controlled by feedback. The speaker's brain must assess the following types of information about the discussion.
Assess the Speaker's Dialogue Data
Topic or Interest
Goal or Purpose
Premises and commitments made
Propositions and commitments made
Question types (who, what, what manner, why, how . . . )
Assess the Respondent's Dialogue Data
Topic or Interest
Goal or Purpose
Premises and commitments
Propositions and commitments
Question types (who, what, what manner, why, how . . . )
Assess Respondent Positions, developing and tracking a Worth for each
Intention (debate, quest for knowledge, teaching, picking a bone, attack . . . )
Assess Topic Repetition that may indicate strong feelings about the topic, or may indicate argument or picking a bone.
Of Question Type (WH or Y/N Types0
Of Assertions
Of Topic Items
Negativity or Derogatory Terms that may indicate strong feelings, picking a bone, or personal attack.
Other Contention Indicators that may redirect the flow of discussion, change of topic or method of debate/discussion
Change of topic because of decreased worth in former topic indicators

There are many indicators that arise during the course of discussion that must be identified and recorded as they occur. At that same time, it must be assessed whether the flow of discussion should be altered because of new indicators.

### Discussion States

Not covered in detail here, FIG. 40 depicts the general flow of discussion states, wherein person A is talking to person B. They are involved in two-way dialogue when interrupted by a third person C. The interruption may be ignored or responded to. FIG. 40 is a depiction of typical states, not a complete state diagram of discussion.

### Volition—Dialogue Context Formulation

### Discussion Drivers

Discussion can be initiated for diverse reasons, which may partially determine the type of dialogue method(s) used during the discussion. Some of these reasons include:
Human Needs (See 9 basic needs)
Responding to a Third-Party Request for Information
Responding to a Question by Another Person
Curiosity About a Topic
Teaching or Training Someone Else
Events that occur

Each of these drivers influences context. They might form a bias (e.g., toward a particular need) or they might set the dialogue type as Educational, etc.

### Who is the Audience?

Information about the audience (whoever is on the receiving end of a premise) affects the context of dialogue. If I have a quarrel with an acquaintance or a neighbor, I will handle it differently than if I had a quarrel with the President (assuming I could get an appointment to speak with him). However, if I am the President's mother, it does not matter who he is, he is still my son and I will speak with him how I wish.

### What is the Topic?

Controversial topics demand delicate handling. When discussing whether abortion should be legal, the involved parties should be aware that talks about this controversial issue could escalate into a quarrel if it is not handled correctly. Also, if at least two parties do not agree on the topic, the discussion

Where and when does the Dialogue Happen?

The speaker must be aware of the time and place, to know what types of speech are acceptable. A courtroom has formal rules of procedure. During a trial, all parties are expected to follow those rules, and failure to do so can result in expulsion from the room. However, after the trial is finished, the rules of procedure are different. If the lawyers are friends (and have remained so through the trial) they can joke around and use familiar language they could not have used in the trial.

How does the Dialogue Proceed?

The rules of the dialogue can be predicted by answering the preceding questions. The types of dialogue I might have with the President are severely limited, especially if the where and when are at a press conference after a terrorist attack on the United States. Should I try to have a discussion about the implications of outlawing sugar in public school cafeterias, I would likely be asked to leave.

The information listed above forms the context of a dialogue. These data are then used to anticipate the dialogue type and form the rules of discussion. The following chapters discuss dialogue stages and types, as well as the dialogue rules (locution, commitment, etc.).

### Volition—Dialogue Stages and Types

### Stages of Dialogue

Dialogue is dynamic and progress through a series of stages. There are individual criteria for moving from one stage to the next, or for even abandoning the current dialogue (or portions of it). The primary stages are:
Opening
Choose dialogue type.
Define arguments.
Define presuppositions.
Confrontation
Define and elicit agreement on the issues to discuss.
Argumentation
Engage in iterative debate.
Exit when commitments have been satisfied and all implied needs have been met.
Move to closing when indicators such as, “In conclusion” are encountered.
Closing

For argumentation stage, expect and analyze the answer. (See P19 of Walton of this document for question types and analyses.) Upon hearing a question, perform type and meaning analysis.

The basic types of dialog are each driven by a different purpose. Each has its own characteristic, purpose, flow profiles, methods and requirements.

These dialogue types, as illustrated in FIG. 41 are elaborated on in the sections to follow.

### Personal Quarrel

The quarrel represents the lowest level of argument. It contains:
Aggressive personal attack
Heightened appeal to emotion
A desire to win the argument at all costs
   The quarrel is characterized by:
Loss of balanced perspective—outrageous arguments
Fallacious ad hominem attack (attack against the person rather than the argument)
The bad or heated argument
Use of fallacies, vicious attacks, one-sided criticisms

Goals of the quarrel are:
Attack or hit the opponent at all costs, using any means, whether reasonable, fair or not

The personal quarrel should be avoided at all costs, but recognized for what it is. When on the receiving end of a quarrel, the following steps should be taken:
Discover the issue
Evaluate my guilt or innocence
If guilty, admit it and apologize
If innocent, apologize without accepting responsibility.
Escape the argument

The most important part of the above process is the escape. If attempts to discover the issue or apologize fail, the next step is to get away from the attacker rather than argue.

### Attack (Personal)

Should one have reason to be the aggressor in a quarrel, he should proceed in the following manner:
Find offender

Attack in whichever way is most effective
Demand an apology or retribution
Evaluate offender's response
Exit attack

The attack has no limits, unless the attack is strategic, as in a debate. In that case, the attack can be limited to be “effective” yet still within reasonable boundaries.

### Debate (Forensic Debate)

The forensic debate is done for the sake of third parties, who are the judges of its merit and its winner. It is regulated by rules of procedure (which can be kept in a “permissibles” list). A debate may contain the same emotion as a quarrel, but the reasoning behind the arguments is more thought out. Debaters are competing for points, are subtracted and added throughout the debate, and the ultimate goal of a debate is to win, whether or not the winning argument is “true.” The debate follows a formal structure depending on the style of debate.

The following process is followed for debate:
Evaluate debate type and rules
Evaluate the issue
Prepare argument
Anticipate counterarguments
Debate according to format
Close debate and evaluate score

The debate format and rules will vary according to the debate type (Worlds/Europeans, US, Lincoln-Douglas, etc.), but are easily modified once the type is determined.

### Persuasion Dialogue (Critical Discussion)

Goal of each participant is to prove his conclusion from premises that are accepted by the other participant. (P52) Successful persuasion is exhibited by change of behavior in the other participant. An argument that begs the question is automatically doomed in this form of discussion. (P54) Arguments here are based on weak premises and may have low expectations. A persuasion dialogue proceeds as follows:
Determine persuasion topic (the desired change of behavior)
Appeal through persuasive methods (needs, common ground, tricks, etc.)
Evaluate success
Build on persuasion, attempt new method, or exit dialogue

Involved in Persuasion Dialogue is determining the other participant's needs, attitudes, areas of common ground, and more. Identifying these things allows the persuasion to be specific to each person and thereby more effective. Also worth noting is which types of tricks (yes-yes, ask which, planting . . . ) work best—if at all—on a particular person, so that these can be added or deleted from future persuasive dialogues with that person.

### Inquiry Dialogue

Begin with a set of known premises and work with them to discover what is true. This is the Sherlock Holmes method, where one examines the facts, discovers new facts, and finds a deduction that must be true, assuming all the premises are true. Conduct an inquiry in the following manner:
Determine what is already known
Determine what needs to be known
Ask a question to acquire more information
Add answer to list of knowns and ask, “What does this mean?”
Evaluate whether enough knowns exist to form a deduction
Continue inquiry or explain deduction

Using this method, one acquires the necessary information to draw a deduction—which must be true if all the premises are true—and thereby exclaim, “Elementary, Watson!”

### Negotiation Dialogue

Goal is to reach a mutually beneficial agreement through whatever means necessary. Seek a threshold crossing of satisfaction. Provide for multiple issues and be prepared to concede something now if it offers a greater benefit later. A negotiation will proceed as follows:
Determine role (buyer or seller)
Decide on own interests and rank them
Determine a satisfaction threshold—the “must haves”
Assess the other's priorities
Initiate (or be initiated into) negotiation
Negotiate unto satisfaction
Exit negotiation

This process of negotiation allows all parties involved to reach a mutually satisfying agreement.

### Information-Seeking Dialogue

If the inspiration is curiosity, the information sought has a level of satisfaction that says, “That makes sense to me. My curiosity is satisfied.” However, if the information is needed, the level of satisfaction is based on whether the inquirer has obtained the necessary information.

This dialogue type is similar to an inquiry, except with different drivers and different goals. It proceeds in the same manner as an inquiry, with a set of premises, missing information, and questions about the missing information until the curiosity is satisfied.

### Action-Seeking Dialogue

Seek commitment to specific action.
Give background.
Issue imperative or question.
Set expectations for answer.
Evaluate answer for yes/no result.
Exit

An example of the above process is, “You look tired. Have a seat.” Expect “him” to sit, and see if he did.

### Educational Dialogue

One-sided focus, educating me or (him): Determine “need-to-know” requirements to be met by the educator. This requirement brings focus to the dialogue, as well as a test for relevance (especially when the educator is asked a question). In one form, the educator is in monologue with questions throughout, another has the educator asking questions of the students, evaluating their responses for veracity, elaborating when necessary. The first type has this flow:
Explain the rules (“If you have a question, interrupt me”)
Introduce the subject
Teach, allowing questions per the rules
Close teaching
Take questions and respond
Receive and evaluate feedback

This basic structure of education dialogue is only the common type. In others, the educator allows the students to speak, while the teacher acts as a guide and source of information for the discussion.

### Dispute

One party affirms a given proposition while the other party affirms the opposite of the same proposition. The dialogue centers around each party offering premises that support their own claims or refute the claims of their opponent. This dialogue has a simple structure which is as follows:
Determine issue
Evaluate opinion
Take sides
Listen, evaluate claim, respond
Repeat unto satisfaction

A dispute does not necessitate bad feelings or heated arguments. The point is that there is one issue and two opposing opinions. Through the discussion of opinions and facts, someone might change their mind, however it is unlikely. The “satisfaction” is thus not a change of behavior, but rather some point that says, “I have discussed this enough.”

### Dialogue Management

A key to dialogue management is the degree of initiative by each party. Each dialogue participant can either proactively steer the conversation in some direction, or simply react to the other participant. In actively managed dialogue, the system brings the conversation back on topic if we started to stray. In unmanaged dialogue, it only affects the conversation a sentence at a time, awaiting signals to respond.

“What to say next” depends on what mode is appropriate to the conversation. Sometimes, you speak to be heard, and are open to whatever response you might receive (just ‘putting it out there’ or ‘fishing for a response’ or “bouncing and idea” off someone).

Other times, you speak specifically to affect a response. This targeted speech is about eliciting some expected feedback, so you know you've led the listener to a specific state of awareness about you and your perspective.

At that point there is shared context and understanding. The dialogue can proceed correctly (as opposed to continued miscommunication). This is akin to the idea that it takes both a transmitted message and a feedback response to create a complete “communication loop”.

After the parsing of each sentence, Volition knows both the current-sentence topic and the nominal topic for the current paragraph. These are strong indicators used to determine if dialogue is on topic or not. Topics are simply compared with the active dialog process pool link to make this decision. From the personality standpoint, the brain may or may not choose to enforce maintenance of the discussion topic.

Finally, a key to conversation is to occasionally ‘break out’ of it and assess (implicitly or explicitly) what it is about. Stepping outside the dialogue to make a statement about the dialogue itself is demonstration of the ability to truly step back and generalize on-the-fly. This also helps maintain common context. An example conversation with the EBM agent would be:
Agent: I am bored.
Me: Intelligence is over-rated. Not all intelligence is good.
Agent: Intelligence is necessary for understanding.
Me: Intelligence need only be actionable to be of use. Understanding is not necessary, nor is it always a goal. Some intelligence is useful for us to act on, some intelligence is unreliable, and some is simply fabricated or artificial.
Agent: Wait, are we talking about intellectual intelligence or military intelligence?

The ability to ask the right question at the right time in order to reduce a growing conversational ambiguity is a key to maintaining shared direction and focus to the dialogue. Ambiguity recognition should trigger a clarification request.

### Volition—the Rules of Dialogue

This chapter is not exhaustively implemented in the EBM, per se, but serves as guidance of the continual extension of dialogue processes, particularly where using process neurons in the implementation. Unless otherwise specified, references such as P21 are to Waltan.

### Introduction

Generally, any detected rules-violation should trigger an event of some form, or must take part in a centralized condition-handling mechanism.

To model dialogue types proposed by Walton and Krabbe (1995) (see Chapter 2, Section 2.7.2), the authors used seven dialogue moves: assert, accept, question, challenge, request, promise and refuse. For each move, they defined rationality rules, dialogue rules, and update rules. The rationality rules specify the preconditions for playing the move. The update rules specify how commitment stores are modified by the move. The dialogue rules specify the moves the other player can make next, and so specify the protocol under which the dialogue takes place.

The above might contain something like:
assert(p) where p is a propositional formula.
Rationality the player uses its argumentation system to check if there is an acceptable argument for the fact p.
Dialogue the other player can respond with:
1: accept(p)
2: assert( [symbol] p)
3: challenge(p)
Update CSᵢ(P)=CSᵢ₋₁(P)∪{p} and CSᵢ(C)=CSᵢ₋₁(C)
challenge(p) where p is a propositional formula.
Rationality Ø
Dialogue the other player can only assert (S) where S is an argument supporting p.
Update CSᵢ(P)=CSᵢ₋₁(P) and CSᵢ(C)=CSᵢ₋₁(C)

Where the above bolded items represent enumerations or tokens representing a sequence of dialog “Schemes” (possibly ‘argumentation schemes’), per Walton, et. al.

On the basis of Amgoud et al.'s work, Sadri et al. (2001) proposed a protocol but with fewer locutions called dialogue moves. The legal dialogue moves are request, promise, accept, refuse, challenge and justify. The content of the dialogue moves request and promise are resources, while the content of the other four dialogue moves are themselves dialogue moves. For example, accept(Move) is used to accept a previous dialogue move Move and challenge(Move) is used to ask a justification for a previous dialogue move.

### Locution Rules (P10)

Kind of speech acts or locutions that are allowed.

### Dialogue Rules

Turns-taking and other guidelines

### Commitment Rules

Specifies how each type of locution leads to commitments by the participants.

### Strategic (Win-Loss) Rules

Determine the sequence of locutions that constitute fulfillment of goals.

### Rules of Relevance

(Specific types) Participant may not wander too far off the topic (goal) of the dialogue.

### Rules of Competitiveness

(Specific types) Participant must answer questions cooperatively and accept commitments that reflect his position accurately.

### Rules of Informativeness

(Specific types) Participant must provide enough information to convince his respondent but not provide more information than is required or useful for the purpose.

### Question-Answer Rules

A direct answer to yes-no question is ‘yes’ or ‘no’.

If you give a direct answer, you become committed to the question's propositions.

A direct answer to a why-question is to produce a set of propositions that implies the proposition queried.

A direct answer to a whether-question is to produce a proposition that represents one of the alternatives posed by the question.

A person may retract or remove his commitment to a proposition explicitly. He may not give a “no reply” to a question about his own commitments.

Options for reply to an Objectionable Question.

Answer “No commitment” (or equivalent).

Reject the presuppositions rather than answer the question.

Attack the question itself.

If question is aggressive, responder must be aggressive too.

### Rules for “Objectionable”

A question is objectionable if it attempts to preempt the responder on an unwelcome proposition, by presupposing that the answerer already accepts it.

Question is overly aggressive.

Unwelcome propositions are those the responder is not committed to, those that are prejudicial to his side of the argument.

### Negative Rules (for Persuasion Dialogue)

Opening Stage

Shift in Type of Dialogue

Confrontation Stage

Unlicensed attempt to change the agenda

Shift to argument stage without agreement of agenda

Argumentation Stage

Not making effort to fulfillment obligation

Not meeting burden of proof

Not defending a Challenged Commitment

Shift your burden of proof to other party, or alter burden of proof

Carry out internal proof using premises not yet conceded by other party

Appeal to external sources of proof without backing up argument properly

Failures of relevance

Providing wrong thesis

Wander away from point to be proved

Answering the wrong question

Improperly dealing with questions

Failing to ask question appropriate for stage of dialogue

Asking questions that are inappropriate

Failing to reply to question properly, including answering evasively

Failing to define, clarify or justify meaning or definition of significant term

Also, failing to use standards of precision appropriate to the discussion, if challenged by another participant

Closing Stage

Attempt at premature closure, unless by agreement or by fulfillment of the goal

These failures to perform normally are not behavioral requirements for the EBM. They are behaviors to be observed in other's conversation. However, for realistic emulation of New Yorkers, it may be a reasonable goal to build evasiveness and irrationality into the dialogue. For each “rule-breaking,” the EBM can decide if the offense was enough to quit conversation or if it should continue. It will also check to see if the offense is common to that particular person, so that it becomes a personality trait.

### Major Informal Fallacies (Attack Strategies)

### Types of Fallacies

Informal Question Fallacy

Fallacy of Many Questions (or, Fallacy of Complex Question) “Have you stopped beating your wife?”

Ignoring the Issue Fallacy

Appeal to Force Fallacy

Appeal to Emotions Fallacy, emotions, enthusiasms, popular/group feelings

Personal Attack Fallacy—ad hominem—(responding to)

Argument from Ignorance fallacy (ad ignorantiam); Just because something has never been proven does not make it is false. Conversely, never proven false does not imply true.

Fallacy of Equivocation (Confusion between two meanings of a term w/contextual shift)

Straw Man Fallacy (arguer's view is misrepresented, exaggerated or distorted)

Fallacy of Arguing in a Circle (circular proof)

Slippery Slope Fallacy (presuming a sequence of inevitable events)

Fallacy of Composition (attributing properties of parts as properties of the whole)

Black-and-White Fallacy (question poses exclusive disjunction that misrepresents the possibilities allowed in a direct answer) (“Is a zebra black, or white?”)

### Analyses for Fallacies and Criticisms

Do both sides agree on the thesis (conclusion) being discussed? This must be established before irrelevance can be evaluated or charged. I.e., are both sides grousing about the same proposition?

Is the (agreed) thesis about one proposition—on the surface—but really about another issue? E.g., arguing about who should take the trash out this morning, but the real issue is why the other person came come late last night without an explanation. P61

Does the conclusion agree with the premise (proposition or thesis)? If not, this is an ignoratio elenchi fallacy.

An ignoratio elenchi (ignoring the issue, or irrelevant conclusion) exist when an argument fails to prove the conclusion (thesis) it was supposed to prove, but is instead directed towards proving some other (irrelevant) conclusion.

If an ignoratio elenchi is considered but the proponent has not finished his argument, the charge may be premature. He may move to conclusion-premise agreement before he is done. Instead, treat the criticism as a request for more information.

An argument that appears to refute the thesis of the other (but really does not) may be determined to be a case of ignoratio elenchi.

A sentence is fallacious if it forces him to accept a proposition that he should not.

### Methods, Tactics and Argumentation Schemes

Weigh strong and weak points of an argument (argument points list), then attack the weakest point. Of particular interest are claims based on expert knowledge, as well as ambiguous items and information that is left out (omission could indicate downplay of a weakness):
Dig at the evidence behind a claim. If the evidence is good but it would be disadvantageous to agree to it, try using a fallacy if the dialogue type allows it
Use fallacies to throw the opponent off balance
Shift Burden of Proof, usually answering a question with a question
Show that argument is open to reasonable doubt
Show that opponent's explanation may not be the only one
Show that argument lacks support and is open to questioning
Show that the arguer is not believable
Show that arguer's logic is faulty (premises conflict, or assumed cause-effect)
Preempt expected answer to question (Process rule)
Aggressive or Loaded Questions: Reply to question with a question. Have the questioner prove his presuppositions to the question, giving evidence for the assumptions made.
Victim of unsupported accusation must not try to prove his innocence
Question the presuppositions of the question
Criticize respondent for evasiveness (irrelevance)
   Suggested Courses of Action when Answering Questions

For ad ignorantiam Cases: If experts have tried to prove it and failed, concentrate on trying to prove it false, rather than true.

For Loaded Questions: Reply to question with a question. Have the questioner prove his presuppositions to the question, giving evidence for the assumptions made. Victim of unsupported accusation must not try to prove his innocence.

No Answer: If the question repeats previous question.

No Answer: If question is unduly aggressive or argumentative.

No Answer: If question lacks clarity, is misleading, or is ambiguous.

No Answer: If question is addressed to an expert and is outside his field of expertise. P51 A non-answer to these last 4 cases removes the obligation to answer the questioner.

General Case: Reply to the question with a question to shift the burden of proof back to the questioner. (The questioner may then declare the returned question to be evasive.)

For a ‘complex question’ (it contains and, or or if-then), the responder must question the question by separating the propositions in the presuppositions into units he can reasonably deal with.

A question that is ‘objectionable’ is open to reasonable criticism of objection by the responder. This is especially so when the question is objectionable because it is overly aggressive.

If questioned to prove, clarify or defend a proposition he has already committee to (even by default), responder must directly respond. “He who asserts must prove.”

Suggested Courses of Action when Asking Questions (Technique)

Aggressive Questioning: Pack so much loaded information as possible into presuppositions of a loaded question that the respondent would be severely implicated in any attempt to a straight answer. If packed into a loaded yes-no question, and the respondent fails to give a straight yes-no answer, then him of evasion or of failing to answer the question.

### Conclusion Analysis

Use of definitely or conclusively in an ad ignorantiam argument suggests the argument could be fallacious.

If conclusion is phrased as plausible presumption, an ad ignorantiam argument may be reasonable.

Look for conclusion indicators such as therefore, thus, and consequently.

### Burden-of-Proof Analysis

Evaluate the burden of proof for every proposition by either side.

Presuppositions of Questions and their Analysis

Questions have presuppositions and can advance a set of propositions. A question calls for an answer, but when the respondent gives the direct reply that was requested, he automatically becomes committed to those propositions. Questions therefore influence the outcome of an argument most decisively.

A presupposition of a question is defined as a proposition that one becomes committed to by giving a direct answer to the question.

Complex Questions have two or more presuppositions.

Yes-No Questions: The main presupposition that the yes-answer is true or that the no-answer is true. E.g., in “Is snow white?” snow is either white or is not white.

Why-Question: The main presupposition is that the proposition queried is true. E.g., in “Why is chlorine heavier than air?” the proposition is that “Chlorine is heavier than air.”

Whether-Questions: The main presupposition is that at least one of the alternatives is true.

Did-You Questions: The main presuppositions include the existence of the purported action and the existence of the related facts. E.g., in “Have you stopped beating your wife?” the presuppositions are that you did beat your wife, and that you indeed have a wife (i.e., an R_POSSN).

Do-You Questions: The main presupposition is that the purported action or condition is true.

### Presuppositions of Questions

A proposition presumed to be acceptable to the respondent

Respondent is committed to the proposition if he gives a direct answer.

Unwelcome Commitments—Trapped by fallacy of Many Questions.

Loaded Questions—Fallacy of Many Questions.

Harmful (or not)

### Critique of Questions:

Reasonable: The question is clear of fallacies and can be answered directly.

Fallacious: The proposition within the fallacy must be dealt with before the question can be answered.

Complexity: Each proposition must be dealt with in turn, rather than answering the question as a whole.

Objectionable: When it becomes too aggressive. (Possible global event.) Answering an overly aggressive question causes responder to be discredited and undone. Violates reasonable order of Q & A in dialogue. Question is especially objectionable if question is overly aggressive.

Circular: (“begging the question”) A has a B; B is a C; Therefore, A is a B.

### Analysis of Propositions of Dialogue

The normal expectation is for a helpful answer. However, the answer must be analyzed to determine whether it is actually helpful.

### Types of Answers:

Direct Answer: In addition to answering the question, the responder has also agreed to the presuppositions of the question.

Indirect Answer: The responder can be accused of being evasive or committing a fallacy of irrelevance. (In political debate, it can look guilty.) P56

A Reply: This is answering a question or a premise with a premise of one's own. This is especially acceptable in answering a loaded or complex question, in which one must address multiple premises or presuppositions.

Answering With a Question: Shifts burden of proof back to the opponent. This is not always valid, so check to be sure it is before responding.

### Critique of Answers

Reasonable:

Judged as Evasive:

Judged as Irrelevant:

### Variables

Information is tracked for each argument or question that is part of dialogue. These are kept in a chain of records that are extended as the discussion continues. Older and non-relevant links are discarded when they are outdated, no longer apply, or when overall topic has changed.

For a given dialogue, the argumentation scheme should not change. When it is sensed that the responder has made an attempt to change the scheme, his arguments may be invalidated.

Following is a list of the elements of a dialogue record. Each record relates to one point being made or proven, but each may contain multiple premises or propositions which themselves are independent NIDs (concepts) or CIDs (sentence clauses):

Thesis (or issue)—Proposition to be proved or question of controversy under discussion. This can also be a simple topic (NID) or statement (CID). Both sides have to agree this is the issue under discussion.

Dialogue Method—The method being used for the discussion, though it may change from premise to premise. Keep track of the overall dialogue method, as well as the method for each premise to track shifts in pattern.
List of Presupposition(s) of Argument or Question. These are components of the question or assertions made in support of the argument.
   Elemental Statement of Proposition
   Level of Commitment by Both Sides (−100% . . . 0 . . . +100%)—Affirm to be false or true.
   Level of Argument Support for this Proposition (0 . . . 100%)
   Level of objection to this Proposition (0 . . . 100%)

Premise—Beyond the presupposition, this is presumed to be the actual argument. Once the presuppositions are dealt with, consider the argument as the thesis.
Attributes of this Thesis—If something is aggressive, objectionable, or controversial, these are contention indicators.
   Assessment of argument: Weak, erroneous, fallacious, strong, fact
   Aggressive
   Relevant
   Objectionable
   Adversarial (Personal Attack)
   Controversial
   Scientific Inquiry (requirement for scientific proof methods)
   Credibility Level of Responder or Expert (e.g., not a liar)
   Academic
Embedded
   Hypothetical
   Leading
Rhetorical Argumentation Scheme
Acceptability of a Question (analysis of the question or argument)
   Reasonableness of a Question
   Reasonableness of a Question Length
Complexity of Question
Objection to the Question or Argument as a composite
Argument State—was it resolved? Yes or no.
Argumentation Style and Related Question Sets

### Volition—the Making of Smalltalk

“Small talk” is the means of an introductory process. Small talk humanizes the relationship. As an icebreaker, small talk is a process on the way to engaging in “real” communications. It is significant in that it is the means to connect on a relational heart level with the other person.

Some of the information in this chapter and implemented in the EBM was derived from the book, “The Fine Art of Small Talk” by Debra Fine, ISBN 9-781401 30226 9 (Barnes & Noble).

With small talk, a person has a basis for self confidence in social situations. Without it there is the (probability) of being socially insecure. It enables us to:
Solve a problem (fill a need)
Set the tone for more serious discussion
Connect with other people
Develop good positive feelings

This chapter defines some of the methods and techniques of small talk, and gives them in such a manner that they can be implemented as learned neurons. This is in contrast to implementing them as a hard-coded process.

For this reason, small talk has been implemented through the use of process neurons, a particular application of the normal conceptual neuron. Obviously, the stand-alone brain that is not connected to robotics cannot express some of the mannerisms associated with small-talk, but these faculties can be later integrated without conflict with the methods of process neurons.

Throughout this chapter, the term “ASOC” is often used. It is a generic term for “association reln,” and may imply one of several reln types most appropriate for the connection under discussion.

### Small Talk Processes

Some of the small talk conversational processes include:
Engage any individual in meaningful dialogue
Resuscitate a dying conversation
Transition into new topics
Feel more at ease in networking events, parties and receptions
Develop business relationships
Step out of a conversation with grace
   To do the above takes the following:
Ignore fear of rejection
Take a risk
Assume the burden of conversation

### Guiding Rules of the Small Talk Processes

Some of the rules of small talk processes include:
In safe situations, make it a point to talk to strangers
Introduce yourself
Silence is impolite
Take the initiative
It's up to you to start a conversation
It's up to you to drive the conversation

These are presented here with a means for implementation; that is covered by the remaining sections.

### Icebreakers

This section includes example situation-dependent ice-breakers. They are suitable for storing as templates in a sequence block of a relevant neuron. A general sequence of conversation (possibly hard for a brain that doesn't have a head to wag) is
Smile (proactively), or return a smile.
Make eye contact.
Initiate an icebreaker using the object's name, if known.

Smalltalk can later be redirected to more formal dialogue where appropriate.

### Business Icebreakers

Each of these has one or more reln connections that can be associated with it. To correctly select from the list of these, it is necessary to match the associations with current internal conditions. I.e., if there is a need begging to be solved and this person may be able to help out, define and use associations (ASOCs) to need. Some of the initial business ice-breakers include:
Describe a typical day on the job.
How did you come up with this idea?
What got you started in this <industry, area of practice>?
What got you interested in <marketing, research, teaching, other_vocation>?

A substantial set of these is included in the Dialogue.txt file as part of neural content. Some of these choices are reflective of action, e.g., play piano. They need to be properly associated to clumps to make the decision process possible.

### Social Icebreakers

Each of these has one or more ASOCs that can be associated with it. To correctly select from the list of these, it is again necessary to match the ASOCs with the current internal conditions. I.e., if the subject is a movie, a method will have to be defined—probably with ASOCs—to select the proper small item (from a list such as this), then to select the proper option (e.g., “movie”) from the small talk item itself.
What do *you* think of the <movie, restaurant, party, topic>?
Tell me about the best vacation *you've* ever taken.
What's *your* favorite thing to do on a rainy day?
If *you* could replay any moment in your life, what would it be?

As with Business Icebreakers, a substantial set of these is included in the Dialogue.txt file as part of neural content. Some of these choices are reflective of action, e.g., play piano. They need to be properly ASOC'd to clumps to make the decision process possible.

### Respondent'S Assessment of the Icebreaker

When we are on the listener side of an icebreaker to a conversation, make assessments and decisions in the following manner:
Size the person up.
Determine if we are in a mood to chat.
Gauge whether it is worth our investment of time.
Engage or disengage in the conversation.

### Cold-Initialization of Conversation

Starting a “from scratch” conversation is helpful at a meeting, party, reception or family reunion. The essential parts of it are:
Look around the room when first entered.
Make eye contact and be the first person to smile.
Use an ice-breaker remark or question. For ASOCs on the icebreaker, use list of topics presently in the context pool to isolate associations with the most promising ones.
Initiate conversational dialogue along a topic lines.
Dig deeper if the conversation wanes.

Continue the conversation using the methods outlined elsewhere in this chapter.

### Initiating (or Continuing) Conversation Along a Topic—Asking Open-Ended Questions

Open-ended questions to a group of people stimulates conversation between them, lets the individuals of the group be the focus, and permits you to learn something about them. It makes them comfortable (they're talking about themselves) and puts them at ease for conversation with you. Some of such questions include the following:
Describe for me <topic>.
Tell me about <topic>.
How did you <action topic>.
What was <that topic> like for you?
What brought you to <topic, place, locale>?
Why? (Assumes a strong topic or assertion.)

Some of these options assume the known state of a previous conversation or topic, and extend the conversation along derivative lines.

### Continuity of Conversation

Once a conversation has been so initiated, it will play out in some manner and then possibly begin flagging. There are then “continuity questions” that may be asked, both from the personal and professional sides.

### Continuity Questions—Personal

The following are alternative ways to bypass clichés and normally-expected questions used for small talk. Some require prior knowledge of the topic or analysis of the Responder's replies:
What went on for you today? <if positive> What made it <great, good>? <if negative>
What went wrong?
How was your summer? <reply> What special things did you do?
How were your <holidays>? <reply> How did you celebrate?
Tell me about your <business, work, family>.
Tell me about your favorite hobby.
What was the best part of your <weekend>. What went on for you this <weekend>?
How was your weekend? <reply> What did you do?

Other methods include analysis of the topic content of the Responder. All of these provide basis for follow-on questions. The approach is this:
Cull or track topics arising in the respondent's comments.
Look at both negative and positive elements of ASOCs and relns.
Pose a question or observation based on those elements.

The above processes require hard-wired logic to implement, although its elements may be sequenced from a neuron. For example: “I hate being an engineer” is casting negatives on the speaker's experiences in the area. Both types of emotion-laden issues are materials for W-H questions relating to the topic, and pull the conversation forward.

### Continuity Questions—Business

The following is a sampling of questions suitable for maintaining continuity in small-talk personal conversations. A complete list is found in Dialogue.txt:
How did you get started in your business?
How did you come up with <this> idea?
What got you interested in <business function, job, industry, idea>?
How has the Internet impacted your profession as a whole?

There is a difference in appropriate questions between a professional (any profession) and a business owner or manager. As before, the appropriate connections to the questions should be made with ASOCs so they can be culled in a manner appropriate to the present context and pool content.

### Vision-Based Question Opportunities

Other opportunities exist for brains with vision recognition. This free-for-the-taking information for asking W-H questions includes:
Cast on a broken limb.
A T-shirt with specific logo or text.
Office decorations
Diploma with graduating school.
Sports object, e.g., golf ball.
A trophy.
Someone is left-handed.
Someone has beautiful hand-writing.
A piece of art or a picture.

Some of these require optical correlation and the ability to ascertain what type of object is being perceived. These can be ignored in the short run, but must be accounted for when these visual skills have been developed.

### Behavioral Analysis Question Opportunities

On the analytical side, there is opportunity for asking W-H questions based upon observed behavior. These can include perceived intent:
Use of anger, pleasure, frustration, happiness (emotion or feeling) words.
Perceived intent to annoy.
Perceived intention topic.
Perceived argumentation.
Perceived making of a point.
Perceived genuine inquiry.
Other analyses or perceptions and their topic.

The above list can be extended to include all results from awareness and expectation pools, too. Use of our internally-firing emotions (particularly negative ones) can lead to bad conversational methods. Enable their use for proper emulation of non-disciplined people.

### Use of Body Language

One analyst in non-verbal communications (Ray Birdwhistle) asserts that communication is 35% verbal and 65% non-verbal.

### Body Positions for Positive Messages

Positive messages are conveyed by the following positions:
Lean forward.
Maintain eye contact.
Ope up your arms and body.
Relax you body posture.
Face your partner.
Nod and smile.

### Body Positions for Negative Messages

Negative messages are conveyed by the following positions:
Pointing.
Covering your mouth.
Rubbing or fondling body parts.
Fiddling with jewelry.
Tapping a pencil or pen.
Swinging your leg.
Crossing arms about your chest.
Putting hands on your hips.
Glancing away from the person who is speaking

### Listener-Side Verbal Cues he is Listening

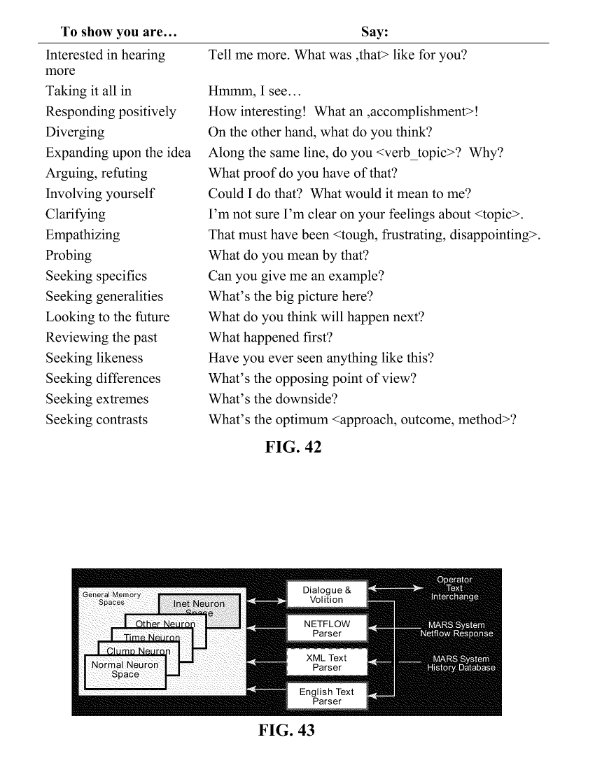

Some short feedback lines tell the speaker that the responder is actually listening. This is illustrated in FIG. 42. These are set up with reln associations to ensure the proper element is selected and presented.

Transition into New Topics

When the intention is to transition to a new topic, the following are some options. They can be configured with ASOCs to properly select them. These methods convey that you are listening and connected, and that you want the responder to continue speaking with you.
That reminds me of <new_topic>.
When you were talking about <topic> I remembered <new_topic>.
You know, I was just reading in the paper about <new_topic>.
I've always wanted to ask you <new_topic>.
I thought of you when I heard <new_topic>.
Do you mind if I change the subject?
There's something I've wanted to ask of someone with your expertise.

### Applications of the EBM

Beyond basic brain implementation is a set of requirements for configuration and training Almost all of this is done via ordinary English text, many parts of which become “boiler-plate” after their original creation.
Word dictionary from which to develop the original ontology
Common-sense training
Configuration for personality via ACL parameters
Training of back-stories and emotional experience or associations to ideas, words and events
General training, e.g., high school equivalency
Cultural training and paradigms, e.g., to develop a Sunni Muslim mid-Eastern mind-set
Specific application training where appropriate, such as for expert system use

With relevant training, many applications open for use of the EBM. This chapter explores a few such applications.

### Network Security

Referring now to FIG. 43, a current application of the EBM relates to network security. In this case, an EBM business partner has a configuration of network security hardware that monitor and track network events, such as a denial-of-service attack. The events are reported to a log file by COTS equipment, and to the operator via graphic interfaces. The operator must review the display and then explore log activity to determine actions to take, a tedious process during which other events are still incoming.

To ameliorate this, the EBM is being configured to read the log files in semi-realtime and perform sense-making on the events. It interprets the events and signals the operator to look at the event sequence, or can be configured to automatically take remedial action. Communication between the brain and the operator is in conversational English.

This application develops profiles on threats and identifies their behaviors and typical methods

For this application, the set of neuron “spaces” shown in FIG. 8 are augment with a new neural space dedicated to the expression of internet nodes and events, as shown in FIG. 8. A separate log-file scanner reads in the event notification and presents them to the brain. The brain takes these in and creates neurons or neural connections with the data, which by now takes no parsing and relatively little extra processing. The advantage of adding the extra neuron space is strong compatibility with the rest of the system. It is now possible to use text to describe internet-based nodes in the same manner as any other neuron.

Example interaction with the system is shown below (operator inputs shown in BOLD CAPS):
Case 1. New bandit, designated Bandit 1, initiated DOS attack against site designated S1 at 2302 local. S1 does not appear compromised, although S1 outbound activity is lower than normal for 2300 local. DOS attacks on S1 were simultaneously initiated by additional threats designated as Bandit 2, Bandit 3 and Bandit 4, within 5 minutes of the Bandit 1 attack. Bandits 1 through 4 appear to be compromised machines, where B1 and B4 had previously received IP from an unidentified node designated Bogey 1 (URL available). Am tracking common origins from Bogey 1. Identities of Bandits 1 through 4 are currently unknown. Site S1 is known through DNS to be www.windsong.com.
Case 2. New bandit, designated Bandit 5, compromised target site designated S2. S2 was compromised using a 2851 event, a MS stack overflow vulnerability, after which a type 20211 root kit appears to have been installed. Outbound 20211 emissions were subsequently blocked by Kingpin.
Who is Kingpin?
20.230.1.202, a router in Atlanta, two hops away from S2.

This interactive text mode eases operator fatigue and also permits unattended operation for routine events, with critical events up-lined to an appropriate human operator. The system can be expanded by adding additional brains, optionally arranged in a hierarchical fashion.

### Web Search

Web search is another application for the EBM. Two ‘commercial’ examples are given here, Powerset and Cognition. Both are Natural Language Parsers (NLPs) targeted for web search. They both bring value to the search world but are both limited in that they are just NLPs and do not have an internal brain. (Powerset was acquired by Microsoft for $25M.)

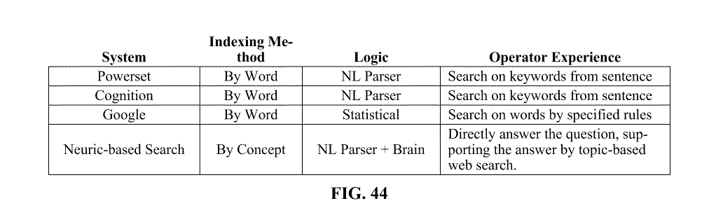

FIG. 44 illustrates some differentiators between Powerset, Cognition, Google and a potential application of the EBM in web search.

The principal differentiator? Google, Powerset and Cognition search engines share one thing in common: they index on words rather than concepts.

The three parts of a search application are:
A system to determine the words, topics or concepts to be searched
A system to store URL references to those search items
A system to store the WWW pages referred to by those URLs

Powerset and Cognition appear to have robust parsers (Powerset's is claimed to handle 7 languages), and a smooth text-based human interface. Both perform the search and return reasonable search results—with Cognition's relegated to specific intranet data sources. Unlike Google's mass of result pages, the Cognition outputs were minimal but reasonable. It reads the English text and—without comment—gives a set of web-page references, providing neither commentary or direct answer.

The alternative is to for the search ‘bots’ to read in the text but to index on concepts rather than on words. If the user does not know the word (or even concept title) he is searching for, yet can describe it, the EBM could interact with him to identify the nature of the concept he is searching for. The results of the search are now three-fold:
A direct descriptive answer to the question based on knowledge, deduction and inference
A list of supporting web pages based on a search
Warm human-like emotional engagement with the user

To yield a direct answer, the brain requires training such as reading portions of Wikipedia or some intranet pages relevant to the application. The search itself may even become secondary. The user experience is enhanced and is aware far less of a machine-human interchange.

### Application: Complex-Vehicle Maintenance Expert

Obviously, related search applications include the study and inquiry into maintenance of the F14 Tomcat based on reading history and experiences in servicing the craft, permitting proactive maintenance brains. This is a throw-back to the expert systems that was a driving goal of the 1980s.

### Application: the Commander'S Perspective

Another application mitigates the loss the knowledge of senior military commanders, particularly in their early post-conflict retirement. It is possible for a brain to be feed emails, post-action reports, circumstantial information and reports, and to paint a realistic picture of the conflict from the commander's perspective.

The ability to configure the EBM for personality and temperament permits subsequent interaction with the brain to reflect that commander's personality. (Maybe not a hot idea in some cases!)

### Application: Emulation of Saddam Hussein

The nature of the EBM architecture makes it extremely useful for sociological modeling, something ordinarily extremely difficult. Here is the situation repeatedly posed in military circles:
It is desirable to do predictive modeling of a red or white force to see what they might do in a given scenario. Perhaps its key leadership personalities are known incrementally better with time. They have a Sunni mind-set. Would they behave differently than we as Westerners would? Is it possible to create such a model?

The answer is yes. One could expect poor results from attempting to model a single individual—even if he is autocratic—because ultimate outcomes are determined by a variety of personalities, each with unique combinations of drives, deference and experience. This is a natural problem for the EBM to address and solve.

Emotional associations can be made through text-based training between any word, concept or experience to any emotion, positive or negative. Knowledge of sociological structures, conditions, events are matters of (English text-based) training and tweaking. In the EBM these concepts do not substantively differ from concepts of the physical sciences; they are yet additional concepts to record, perhaps with trainer-defined emotional implications.

Behavioral modeling in the EBM model is driven by three underlying matters:
Definition of the 37 behavioral indicator values (that include temperament)
Temperament-based pre-dispositions
Back-stores with emotional content that define previous emotional responses (e.g., defiance towards a controller parent . . . or religion, the emotional pain of being awakened with a baseball bat, and the like)

Individuals from the top cadre can be configured individually, with the back-stories of emotional content that drive them.

During simulation, the brains are allowed to interact with each other (in English, over the TCP/IP link ports). Their before-sim mental knowledge or states can be recorded for later reset-and-rerun and a scenario presented to them (incremental training). The training director can then release them to react to the scenario, recording the interchanges that take place to see if they would make decisions abhorrent to a Westerner.

It will be appreciated by those skilled in the art having the benefit of this disclosure that this emulated brain provides a method for processing a query through a database of concepts in order to determine an action in response thereto. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. An emulated intelligence system, comprising:
an input for receiving information in the form of a query;
a parsing system for parsing the query into grammatical elements;
a database of individual concepts, each defining relationships between the concept and other concepts in the database;
a conceptualizing system for defining a list of related concepts associated with each of the parsed elements of the query and the embodied relationships associated therewith;
a volition system for determining if additional concepts are associated with an action that may be associated with pre-stored criteria; and
an action system for defining an action to be taken based upon the relationships defined by the conceptualizing system.

2. The intelligence system of claim 1 wherein the query is in the form of a textual input.
